(19) United States
(12) Patent Application Publication
(10) Pub. No.: US 2022/0046925 A1
(43) Pub. Date: Feb. 17, 2022

(54) METHOD OF CONTROLLING PESTS BY SEED TREATMENT APPLICATION OF A MESOIONIC COMPOUND OR MIXTURE THEREOF

(71) Applicant: BASF SE, Ludwigshafen (DE)

(72) Inventors: Huazhang Huang, Durham, NC (US); Anil Menon, Durham, NC (US)

(21) Appl. No.: 17/275,225

(22) PCT Filed: Sep. 19, 2019
(86) PCT No.: PCT/EP2019/075129

§ 371 Date: Mar. 11, 2021

(30) Foreign Application Priority Data
Sep. 28, 2018 (EP) 18197450.2

(51) Int. Cl. A01N 43/90

(52) U.S. Cl. CPC A01N 43/90

(57) ABSTRACT

A method of controlling or combating soybean, corn, canola, cereals, sugarbeet, cotton, peanut, or potato pest invertebrates, infestation, or infection by pest invertebrates, comprises applying said pest or its food supply, habitat or breeding grounds the compound of formula (I) or a mixture comprising the compound of formula (I), by seed treatment method.

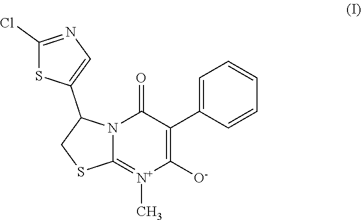 [SMILES: C[n+]1c([O-])c(-c2ccccc2)c(=O)n2c1SCC2c1cnc(Cl)s1]

The present invention relates to the use of the compound of formula I for controlling invertebrate pests, arthropods, especially insects and arachnids, (spider) mites and/or nematodes.

The present invention relates to a method of controlling crop pests by seed treatment application of the compound of formula I or mixture thereof.

The present invention relates to the use of the compound of formula I for controlling crop pests by seed treatment methods.

The present invention relates to the use of the compound of formula I for controlling soil living crop pests by seed treatment method.

The present invention also relates to the use of the compound of formula I in seed treatment for protecting seeds from the attack of storage pests.

Invertebrate pests, arthropods and nematodes, and in particular insects and arachnids, destroy growing and harvested crops and attack wooden dwelling and commercial structures, thereby causing large economic loss to the food supply and to property. While a large number of pesticidal agents are known, due to the ability of target pests to develop resistance to said agents, there is an ongoing need for new agents for combating invertebrate pests such as insects, arachnids and nematodes.

Invertebrate pests, including insects and arachnids, and especially spider mites, and nematodes, are often controlled and combated by applying an effective amount of a suitable pesticide compound, e.g. by drenching, drip application, foliar application, dip application or soil injection. The pesticidal compounds may further be applied as a solid or liquid composition, e.g. such as a dust or granule formulation comprising an inert carrier, e.g. such as clay. Methods of soil application can suffer from several problems as the pesticidal compounds are not always especially suitable for being applied by different soil application methods such as by drenching, drip application, dip application or soil injection. Their pesticidal activity may be affected in some cases.

It is therefore an object of the present invention to provide compounds having a good pesticidal activity and a good applicability in techniques of seed treatment against a large number of different invertebrate pests, which are difficult to control.

Some pesticide compositions may also have potential for leaching. Therefore, care must be taken to minimize both surface and ground water contamination. Moreover, the effectiveness of the pesticide may vary depending on environmental conditions—e.g. properly timed rain is needed for the successful functioning of the chemistry in the soil, but too much rain may reduce the effectiveness and may cause leaching.

It is therefore also an object of the present invention to provide compositions which are suitable for combating pests and which overcome the problems associated with the known techniques. In particular the compositions should be applicable easily and provide a long-lasting action on pests.

Another of the problems the farmer is faced with in this context is, that attack of storage pests on seeds while seeds are stored. Many times seeds including treated seeds are stored before sowing and such seeds are susceptible to attack by pests called storage pests.

It is therefore a further object of the present invention to provide compounds which solve the problems of protection of the protection of seeds from the storage pests.

Another of the problems the farmer is faced with in this context is, that seeds and plant roots and shoots are constantly threatened by foliar and soil insects and other pests.

Thus a further difficulty in relation to the use of such seed protection pesticides is that the repeated and exclusive application of an individual pesticidal compound leads also here in many cases to a rapid selection of soil pests, which have developed natural or adapted resistance against the active compound in question. Therefore, there is a need for seed protection agents that help prevent or overcome resistance.

It is therefore a further object of the present invention to provide compounds which solve the problems of protection of the seeds and growing plants, reducing the dosage rate, enhancing the spectrum of activity and/or to manage pest resistance.

The present invention therefore also provides methods for the protection of plant proparagation material, especially seeds, from soil insects and of the resulting plant's roots and shoots from soil and foliar insects.

The invention also relates to plant proparagation material, especially seeds, which are protected from soil and foliar insects.

It is therefore especially an object of the present invention to provide methods of application, which are suitable for combating soil-living pests

The present invention is further also based on the surprising finding that the compound of formula I or the compound of formula I with enantiomeric excess of compound I-R-1 or the compound I-R-1 (as defined hereinbelow), or mixtures thereof, can be successfully used to control populations of arthropods, in particular insects, and more particular insects from the order Hemiptera, Lepidoptera, Coleoptera or Diptera, and also insects from the order Thysanoptera or Homoptera, by seed treatment method.

The present invention is further also based on the surprising finding that the compound of formula I or the compound of formula I with enantiomeric excess of compound I-R-1 or the compound I-R-1 (as defined hereinbelow), or mixtures thereof, can be successfully used to control pests of Soybean, Corn, Canola, Cereals, Sugarbeet, Cotton, Peanut, and Potato, by seed treatment method.

Surprisingly, it has now been found that the compound of formula (I) of the present invention

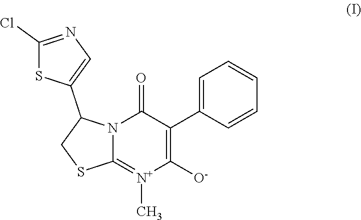 [SMILES: C[n+]1c([O-])c(-c2ccccc2)c(=O)n2c1SCC2c1cnc(Cl)s1]

or the tautomers, enantiomers, diastereomers or salts thereof, is highly suitable for methods for controlling and/or combating insects, acarids and/or nematodes, and especially spider mites, by seed treatment methods.

It has further been found, that mixtures of the compound of formula (I) with other agriculturally active ingredients, such as insecticides or fungicides, are especially suitable for the purpose of seed treatment.

The compound of formula (I) are present in two enantiomeric forms I-R-1 and I-S-1 as shown below

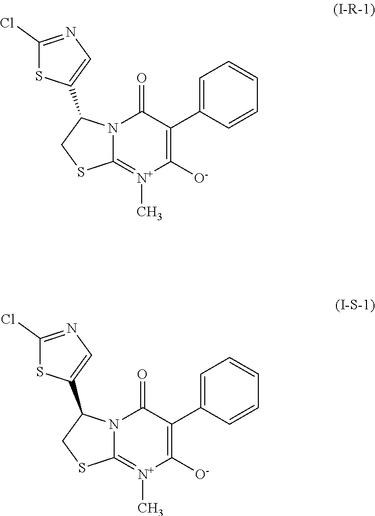 [SMILES: C[n+]1c([O-])c(-c2ccccc2)c(=O)n2c1SC[C@@H]2c1cnc(Cl)s1 ; C[n+]1c([O-])c(-c2ccccc2)c(=O)n2c1SC[C@H]2c1cnc(Cl)s1]

The compound of formula (I), is present in mesoionic forms. These forms may be expressed in different isoelectronic formulae, each having the formal positive and negative charges on different atoms (as shown below). The present invention extends to all representative isoelectronic structures of compounds of formula I.

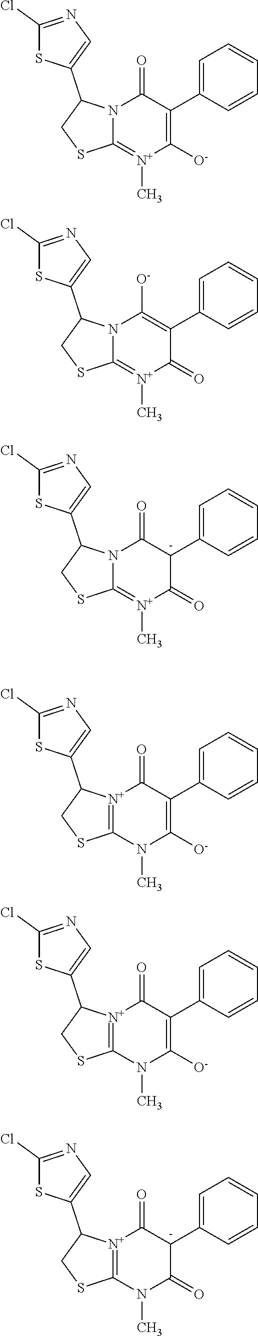 [SMILES: C[n+]1c([O-])c(-c2ccccc2)c(=O)n2c1SCC2c1cnc(Cl)s1 ; C[n+]1c2n(c([O-])c(-c3ccccc3)c1=O)C(c1cnc(Cl)s1)CS2 ; C[n+]1c2n(c(=O)[c-](-c3ccccc3)c1=O)C(c1cnc(Cl)s1)CS2 ; Cn1c([O-])c(-c2ccccc2)c(=O)[n+]2c1SCC2c1cnc(Cl)s1 ; Cn1c([O-])c(-c2ccccc2)c(=O)[n+]2c1SCC2c1cnc(Cl)s1 ; Cn1c2[n+](c(=O)[c-](-c3ccccc3)c1=O)C(c1cnc(Cl)s1)CS2]

The compounds of the formula I-R-1 and I-S-1 are also present in mesoionic forms analogus to the compound of formula I as shown above.

The invention relates to a method, in which the compound of formula (I) itself and its stereoisomers, salts, enantiomers or N-oxides, especially its enantiomers, and it mixtures.

The term “non-racemic compound of formula (I)” refers to the compound of formula (I) wherein its R- and S-enantiomers are not present in equal amount.

The term “racemic compound of formula (I)” refers to the compound of formula (I) wherein its R- and S-enantiomers are present in equal amount.

The term “Enantiomeric excess” indicates the excess of an enantiomer in a mixture of enantiomers, and is calculated according to the following formula:

ee=[|m₁−m₂|/(m₁+m₂)]×100%

ee: enantiomeric excess
m₁: fraction of enantiomer 1
m₂: fraction of enantiomer 2

As used herein and unless otherwise stated, the term “enantiomer” means each individual optically active form of a compound of the invention.

The term “with enantiomeric excess” as used herein refers to a mixture of enantiomers wherein the enantiomer with respect to which the term with “enantiomeric excess” used is present in enantiomeric excess compared to other enantiomer, preferably in an amount of at least 60%, preferably at least 80%, more preferably at least 95%, most preferably at least 98% of the mixture of enantiomers. For example the term “compound of formula I with enantiomeric excess of compound I-R-1” refers to compound of formula I wherein the compound I-R-1 is present in enantiomeric excess amount compared to the compound I-S-1, preferably in an amount of at least 60%, preferably at least 80%, more preferably at least 95%, most preferably at least 98%.

Mesoionic compounds of formula I showing generally pesticidal activity have been described previously. WO2014167084 describes compounds of formula I, their preparation and their use as pest control agents.

However, their surprisingly excellent applicability in seed treatment methods, especially in combination with other agricultural active ingredients have not been described previously.

The compound of formula I according to the invention can be prepared as described in WO2014/167084. The preparation of the compounds of formula (I) above may lead to them being obtained as isomer mixtures. If desired, these can be resolved by the methods customary for this purpose, such as crystallization or chromatography, also on optically active adsorbate, to give the pure isomers.

Agronomically acceptable salts of the compounds I can be formed in a customary manner, e.g. by reaction with an acid of the anion in question.

Moreover, the present invention relates to and includes the following embodiments:
use of the compound of formula (I) or the compound of formula I with enantiomeric excess of compound I-R-1 or the compound I-R-1, for protecting a plant selected from soybean, corn, canola, cereals, sugarbeet, cotton, peanut, and potato, the plant propagation material thereof, against the attack or infestation by invertebrate pests and phytopathogens, by seed treatment method
compositions comprising the compound of formula (I) or the compound of formula I with enantiomeric excess of compound I-R-1 or the compound I-R-1, for use in controlling crop pests, especially soybean, corn, canola, cereals, sugarbeet, cotton, peanut, or potato pest invertebrates, by seed treatment method;
a method for controlling or combating soybean, corn, canola, cereals, sugarbeet, cotton, peanut, or potato pest invertebrates, infestation, or infection by pest invertebrates, which method comprises applying said pest or its food supply, habitat or breeding grounds with a pesticidally effective amount of compound of formula (I) or the compound of formula I with enantiomeric excess of compound I-R-1 or the compound I-R-1, as defined above or a composition thereof, by seed treatment method;
a method for protecting plant or plant propagation material of soybean, corn, canola, cereals, sugarbeet, cotton, peanut, and potato, from attack or infestation by insects, comprising contacting the seed of the plant, with compound of formula (I) as defined above or a composition comprising compound of formula (I) or the compound of formula I with enantiomeric excess of compound I-R-1 or the compound I-R-1, as defined above or a composition thereof;
seed of soybean, corn, canola, cereals, sugarbeet, cotton, peanut, or potato plant treated with the compound of formula (I) or the compound of formula I with enantiomeric excess of compound I-R-1 or the compound I-R-1, as defined above or a composition thereof;
seed of soybean, corn, canola, cereals, sugarbeet, cotton, peanut, or potato plant comprising the compound of formula (I) or the compound of formula I with enantiomeric excess of compound I-R-1 or the compound I-R-1, as defined above or a composition thereof;
a composition comprising seed of soybean, corn, canola, cereals, sugarbeet, cotton, peanut, or potato plant, and the compound of formula (I) or the compound of formula I with enantiomeric excess of compound I-R-1 or the compound I-R-1;
a method for protecting seeds from the attack of storage pest invertebrates, which method comprises applying the seeds with a pesticidally effective amount of compound of formula (I) or the compound of formula I with enantiomeric excess of compound I-R-1 or the compound I-R-1, as defined above, or a composition thereof;
A method of treating seeds of soybean, corn, canola, cereals, sugarbeet, cotton, peanut, or potato plants, to protect them from pests, which comprises applying seeds a pesticidally effective amount of compound of formula (I) or the compound of formula I with enantiomeric excess of compound I-R-1 or the compound I-R-1, as defined above, or a composition thereof.

In one embodiment of the invention, the compound of formula I is non-racemic;

In one embodiment of the invention, the compound of formula I is the compound I-R-1;

In one embodiment of the invention, the compounds of formula (I) refer to the compound of formula (I) with enantiomeric excess of the compound I-R-1;

In one embodiment of the invention, the compounds of formula (I) refer to the compound of formula (I) with enantiomeric excess of at least 55% of the compound I-R-1;

In another embodiment of the invention, the compounds of formula (I) refer to the compound of formula (I) with enantiomeric excess of at least 60% of the compound I-R-1;

In another embodiment of the invention, the compounds of formula (I) refer to the compound of formula (I) with enantiomeric excess of at least 65% of the compound I-R-1;

In another embodiment of the invention, the compounds of formula (I) refer to the compound of formula (I) with enantiomeric excess of at least 70% of the compound I-R-1;

In another embodiment of the invention, the compounds of formula (I) refer to the compound of formula (I) with enantiomeric excess of at least 75% of the compound I-R-1;

In another embodiment of the invention, the compounds of formula (I) refer to the compound of formula (I) with enantiomeric excess of at least 80% of the compound I-R-1;

In another embodiment of the invention, the compounds of formula (I) refer to the compound of formula (I) with enantiomeric excess of at least 85% of the compound I-R-1;

In a preferred embodiment of the invention, the compounds of formula (I) refer to the compound of formula (I) with enantiomeric excess of at least 90% of the compound I-R-1;

In another preferred embodiment of the invention, the compounds of formula (I) refer to the compound of formula (I) with enantiomeric excess of at least 95% of the compound I-R-1;

In another preferred embodiment of the invention, the compounds of formula (I) refer to the compound of formula (I) with enantiomeric excess of at least 98% of the compound I-R-1;

In another preferred embodiment of the invention, the compounds of formula (I) refer to the compound of formula (I) with enantiomeric excess of at least 99% of the compound I-R-1;

In one embodiment of the invention, the compounds of formula (I) refer to the compound of formula (I) with enantiomeric excess of the compound I-R-1, wherein the compound I-R-1 is present in an amount from ≥55% to ≤100% and the compound I-S-1 is present in an amount from ≤45% to ≥0%;

In another embodiment of the invention, the compounds of formula (I) refer to the compound of formula (I) with enantiomeric excess of the compound I-R-1, wherein the compound I-R-1 is present in an amount from ≥60% to ≤100% and the compound I-S-1 is present in an amount from ≤40% to ≥0%;

In another embodiment of the invention, the compounds of formula (I) refer to the compound of formula (I) with enantiomeric excess of the compound I-R-1, wherein the compound I-R-1 is present in an amount from ≥65% to ≤100% and the compound I-S-1 is present in an amount from ≤35% to ≥0%;

In another embodiment of the invention, the compounds of formula (I) refer to the compound of formula (I) with enantiomeric excess of the compound I-R-1, wherein the compound I-R-1 is present in an amount from ≥70% to ≤100% and the compound I-S-1 is present in an amount from ≤30% to ≥0%;

In another embodiment of the invention, the compounds of formula (I) refer to the compound of formula (I) with enantiomeric excess of the compound I-R-1, wherein the compound I-R-1 is present in an amount from ≥75% to 100% and the compound I-S-1 is present in an amount from ≤25% to ≥0%;

In another embodiment of the invention, the compounds of formula (I) refer to the compound of formula (I) with enantiomeric excess of the compound I-R-1, wherein the compound I-R-1 is present in an amount from ≥80% to ≤100% and the compound I-S-1 is present in an amount from ≤20% to ≥0%;

In another embodiment of the invention, the compounds of formula (I) refer to the compound of formula (I) with enantiomeric excess of the compound I-R-1, wherein the compound I-R-1 is present in an amount from ≥85% to ≤100% and the compound I-S-1 is present in an amount from ≤15% to ≥0%;

In another embodiment of the invention, the compounds of formula (I) refer to the compound of formula (I) with enantiomeric excess of the compound I-R-1, wherein the compound I-R-1 is present in an amount from ≥90% to 100% and the compound I-S-1 is present in an amount from ≤10% to ≥0%;

In another embodiment of the invention, the compounds of formula (I) refer to the compound of formula (I) with enantiomeric excess of the compound I-R-1, wherein the compound I-R-1 is present in an amount from ≥95% to 100% and the compound I-S-1 is present in an amount from ≤5% to 0%;

In another embodiment of the invention, the compounds of formula (I) refer to the compound of formula (I) with enantiomeric excess of the compound I-R-1, wherein the compound I-R-1 is present in an amount from ≤98% to 100%, preferably ≥99% to 100%, and the compound I-S-1 is present in an amount from ≤2% to 0%, preferably 1% to 0%;

The “compound of formula I”, “compound I”, “compound of formula I-R-1”, or “compound of formula I with enantiomeric excess of compound I-R-1”, and the terms “compound(s) for methods according to the (present) invention”, “compound(s) according to the (present) invention” or which all compound(s) are applied in methods and uses according to the present invention comprise any of the compound(s) as defined herein as well as a known stereoisomer, salt, tautomer or N-oxide thereof (including a polymorphic crystalline form, a co-crystal or a solvate of a compound or a stereoisomer, salt, tautomer or N-oxide thereof).

Preferred embodiments of the present invention are described below,

In one preferred embodiment of the invention, the plants/crops are selected from soybean, corn, canola, cereals, sugarbeet, cotton, peanut, and potato;

In another preferred embodiment of the invention, the seeds are of soybean, corn, canola, cereals, sugarbeet, cotton, peanut, or potato, plants;

In another preferred embodiment of the invention, the plant or seeds are of corn, canola, cereals, sugarbeet, cotton, peanut, or potato;

In another preferred embodiment of the invention, the plant or seeds are of soybean, canola, cereals, sugarbeet, cotton, peanut, or potato;

In another preferred embodiment of the invention, the plant or seeds are of soybean, corn, cereals, sugarbeet, cotton, peanut, or potato;

In another preferred embodiment of the invention, the plant or seeds are of soybean, corn, canola, sugarbeet, cotton, peanut, or potato;

In another preferred embodiment of the invention, the plant or seeds are of soybean, corn, canola, cereals, cotton, peanut, or potato;

In another preferred embodiment of the invention, the plant or seeds are of soybean, corn, canola, cereals, sugarbeet, peanut, or potato;

In another preferred embodiment of the invention, the plant or seeds are of soybean, corn, canola, cereals, sugarbeet, cotton, or potato;

In another preferred embodiment of the invention, the plant or seeds are of soybean, corn, canola, cereals, sugarbeet, cotton, or peanut;

In another preferred embodiment of the invention, the plant or seed is of soybean;

In another preferred embodiment of the invention, the plant or seed is of corn;

In another preferred embodiment of the invention, the plant or seed is of canola;

In another preferred embodiment of the invention, the plant or seed is of cereals;

In one preferred embodiment of the invention, the cereal is wheat or barley;

In another preferred embodiment of the invention, the plant or seed is of sugarbeet;

In another preferred embodiment of the invention, the plant or seed is of cotton;

In another preferred embodiment of the invention, the plant or seed is of peanut;

In another preferred embodiment of the invention, the plant or seed is of potato;

In the context of this invention, pest invertebrates are the pests which occur in soybean, corn, canola, cereals, sugarbeet, cotton, peanut, or potato. The pest invertebrates include insects, acarids and nematodes, preferably insects. Pest invertebrates, which are well-known in soybean, corn, canola, cereals, sugarbeet, cotton, peanut, and potato, include but are not limited to the following species:

Athalia rosae, Autographia californica, Brevicoryne brassicae, Ceutorhynchus sp such as Ceutorhynchus assimilis, Ceutorhynchus napi, Ceutorhynchus obstrictus, Ceutorhynchus pallidactylus, Ceutorhynchus picitarsis, Ceutorhynchus quadridens, Contarinia nasturtii, Dasineura brassicae, Della brassicae, Dicestra trifoli, Entomoscelis americana, Lygus spp., Lygus hesperus, Lygus lineolaris, Mamestra sp such as Mamestra configurata, Mamestra oleracea; Meligethes sp such as Meligethes aeneus, Meligethes viridescens; Phyllotreta sp such as Phyllotreta cruciferae, Phyllotreta memorum, Phyllotreta undulata, Phyllotreta diademata, Phyllotreta spp., Phyilotreta striolata; Phytomyza rufipes, Pieris sp., Plutella xylostella, Psylliodes sp such as Psylliodes chrysocephala, Psylliodes punctulate; Agromyza parvicornis, Agrotis sp such as Agrotis ipsilon, Agrotis orthogonia, Agrotis segetum, Agrotis munda, Agrotis subterranean; Agrius convolvuli, Anaphothrips obscrurus, Anuraphis maidiradicis, Athetis spp., Blissus leucopterus, Carposina niponensis, Carposina sasakii, Chaetocnema pulicaria, Chilo suppressalis, Conoderus, Aeolus spp., Contarinia sorghicola, Coleophora spp, Cyclocephala borealis, Cyclocephala immaculata, Diabrotica sp such as Diabrotica longicornis barberi, Diabrotica undecimpunctata howardi, Diabrotica virgifera, Diabrotica undecimpunctata, Diabrotica speciosa; Diatraea grandiosella, Diatraea saccharalis, Elasmopalpus sp such as Elasmopalpus lignosellus; Feltia subterranea, Helicoverpa sp such as Helicoverpa armigera, Helicoverpa zea, Helicoverpa punctigera; Hylemya platura, Melanoplus femurrubrum, Melanoplus sanguinipes, Melanotus s pp., Mythimna separata, Ostrinia sp such as Ostrinia furnacalis, Ostrinia nubilalis; Oulema sp such as Oulema melanopus; Pectinophora spp, Phyllophaga crinita, Eleodes, Popillia japonica, Porthesia scintillans, Rhopalosiphum sp such as Rhopalosiphum maidis, Rhopalosiphum rufabdominale, Rhopalosiphum padi, Rhopalosiphum rufiabdominalis; Pseudaletia spp, Pseudaletia unipuncta, Sesamia nonagrioides, Sipha flava, Solenopsis milesta, Chilo partellus, Sphenophorus maidis, Spodoptera sp such as Spodoptera frugiperda, Spodoptera exigua, Spodoptera litura, Spodoptera praefica, Spodoptera ornithogalli, Spodoptera eridania; Tetranychus sp such as Tetranychus cinnabarinus, Tetranychus urticae, Tetranychus turkestani, Tetranychus pacificus; Tryporyza incertulas, Aceria tulipae, Acrosternum hilare, Anchastus spp., Bothyrus gibbosus, Cephus cinctus, Cylindrocupturus adspersus, Diuraphis sp, Diuraphis noxia, Euschistus servus, Euschistus spp., Frankliniella sp such as Frankliniella fusca, Frankliniella occidentalis, Frankliniella bispinosa; Heterodera avenae, Homoeosoma electellum, Hylemya coarctata, Hypera punctata, Irbisia spp., Jylemya platura, Limonius spp. such as Limonius canus, Limonius californicus, Macrosiphum sp such as Macrosiphum avenae, Macrosiphum euphorbiae; Mayetiola sp such as Mayetiola destructor; Melanoplus differentialis, Melanoplus feurrubrum, Melanoplus spp., Meromyza americana, Metopolophium dirhodum, Mythimna unipuncta, Neolasioptera murtfeldtiana, Oligonychus pratensis, Penthaleus major, Petrobia latens, Schizaphis sp, Schizaphis graminum, Sitobion avenae, Sitodiplosis mosellana, Smicronyx fulus, Smicronyx sordidus, Suleima helianthana, Tipula spp., Zygogramma exclamationis, Adelphocoris lineolatus, Adelphocoris suturalis, Alabama argilacea, Alcidodes affaber, Amrasca sp such as Amrasca biguttula, Amrasca devastans, Anomis flava, Anthonomus sp such as Anthonomus grandis; Aphis sp such as Aphis gossypii, Aphis glycines, Aphis craccivora, Aphis fabae, Aphis frangulae, Aphis nasturtii, Aphis spiraecola; Apolygus lucorum, Atactogaster finitimus, Autographa californica, Blapstinus spp., Bucculatrik loxoptera, Bucculatrik thurberiella, Caliothrps fasciatus, Chlorochroa sayi. Chrysodeikis so such as Chrysodeikis includens, Chrysodeikis erisoma; Compylomma livida, Creontiacies spp., Delia platura, Dysdercus sp such as Dysdercus koenigii, Dysdercus spp.; Earias sp such as Earias insulana; Empoasca spp, Empoasca fabae, Empoasca solana, Empoasca devastans, Estigmene acrea, EuschiStus conspersus, EuschiStus impictiventris, Franklinkiella fusca, Franklinkiella occidentalis, Gryllus spp., Heliothis virescens, Hoplolaimus columbus, Liriomyza spp., Meloidogyne spp., Microtermes obesi, Nysius raphanus, Odontotermes obesus, Onycarenus laetus, Pectinophora gossypiella, Pempherulus affinis, Periciroma saucia, Phenacoccus solenopsis, Platynota stultana, Pseuciatomosceks seriatus, Rotylenchulus reniformis, Scirtothros dorsalis, Spllosoma obliqua, Sylepta derogata, Tarache otabilis, Thrips sp, Thrips tabaci, Trachea notabllis, Trialeurodes abutllonea, Trichoplusia ni, Udea profundalis, Anticarsia sp such as Anticarsia gemmatalis, Anstotelia reseosuffusella, Calomycterus setarius, Cerotoma trifurcate, ColaspiS brunnea, Colaspis, crinnicormS, ColaspiS flavicia, Collas eurytheme, Cyclocephala lurida, Dectes texanus, Diabratica balteata, Diabratica undecim punctata howardi, Diabratica undecimpunctata, Epargyreus clarus, Epicauta funebris, Epicauta pennsylvanica, Epicauta vittata, Epllachna varivestis, EuschiStus heros, Halticus bractatus, Halyomorpha sp such as Halyomorpha halys; Helocoverpa zea, Heterodera glycines, Heterodera spp., Hypena scabra, Myzus sp such as Myzus persicae, Myzus ascalonicus, Myzus ornatus; Naupactus (=Graphognathus) spp, Odontota horni, Papaipema nebris, Phyllophaga rugosa, Piezodiorus sp such as Piezodiorus guildinii; Plathypena scabra, POCASLIS maculoventris, Pseudoplusia includens, Rivellia quadrifasciata, SericothrOs variabllis, Spllosoma virginica, SpissIStllus festinus, Spp of Alydidae, Strigoderma arboricola, Thyanta custator, Vanessa careful, ORT: Gryllidae, ORT: Acrididae, ORT: Gryllotalpidae, Austroasca alfalfa, Austroasca viridignSea, Bemisia sp such as Bemisia tabaci, Bemisia argentifolii; Conoderus scissus, Etiella behrg Heteronyx piceus, Lepidiota spp, Leucania stenographia, Mythimna spp., Meloidogyne arenaria, Naupactus leucoloma, Pangaeus bilineatus (Say), Paraplonobia spp., COL: Tenebrioniciae, COL: Elatericiae, COL: Scarabeiciae, HET: Myridae, Acizzia solanicola, Agriotes spp., Agriotes lineatus, Agriotes obscurus, Amphimallon solstitialls, Aulacorthum circumflexum, Aulacorthum solani, Bactericerasp such as Bactericera nigricornis, Bactericera cockerelli; Circulifer tennelus, Epitrix sp such as Epitrix hirtipennis, Epitrix fuscula; Nezara sp such as Nezara viridula, Diaphorina citrii, Liriomyza sp such as Liriomyza trifolg Liriomyza sativae Heliothis zea, Henosepilachna vigintioctomaculata, Holotrichia sp such as Holotrichia oblita, Holotrichia consangulnea; Leptinotarsa sp such as Leptinotarsa decemlineata; Ctenicera pruinina, Macrosteles fascifrons, Meloidogyne hapla, Meloidogyne chitwoodi, Meloidogyne incognita, Monomorium pharaonic, Pemphigus sp., Phthorimaea spp, Phthorimaea operculella, Pratylenchus penetrans, Pratylenchus neglectus, Paratrichodorus sp., Rhopalosiphoninus latysiphon, Russelliana solanicola Tuthill, Smynthurodes betae, Trialeurodes vaporariorum, Achyra rantalis, Atomaria linearis, Autographa gamma, Blaniulus guttulatus, Cassicia nebulosa L., Cassicia nobiliS (L.) (Col., Chrysomelidae), Chaetocnema tibialis, Circulifer tenellus, Disonycha triangularis, Epitrix cucumeris, Epitrix tuberis, Euxoa auxiliaris, Euxoa nigricans, Heterodera schachtll, Loxostege cereraks, Loxostege sticticallS, Meloidogyne javanica, Meloidogyne arenaria, Meloidogyne hapla, Meloidogyne chitwoodi, Onychiurus spp, Pegomyia betae, Pemphigus populivenae (betae), Piesma quadratum, Aproaerema modicella, Dalbulus sp such as Dalbulus maidis; Dichelops sp. Such as Dichelops melacanthus, Dichelops furcatus; Systena blanda, COL: Bruchidae, COL: Dermesticiae, Acanthoscelicies obtectus, Acarus siro, Bruchidius atrolineatus, Bruchus atoma-Bruchus dentipes, Bruchus lentis Frol, Bruchus pisorum, Bruchus rufipes, Callosobruchus chinensis, Callosobruchus maculatus (Fabricius), Callosobruchus subinnotatus, Callosobruchus theobromae, Cryptolestes ferrugineus, Ephestia elutella, Ephestia kuehniella, Oryzaephilus Mercator, Oryzaephilus surinamensis, Palorus depressus, Plodia interpunctella, Prostephanus truncatus (Horn), Rhizopertha dominica, Sitophilus granarius (L.), Sitophilus oryzae (L.) (=Calandra oryzae L.), Sitophilus spp., Sitophilus zeamais Motsch. (=Calandra zeamais Motsch.), Sitotroga cerealella, Tribolium destructor, Tribolium madens, Tenebrio molitor L, and Tribolium confusum;

In one embodiment, the pest invertebrate is a biting/chewing insect.

In another embodiment, the pest invertebrate is a piercing/sucking insect.

In another embodiment, the pest invertebrate is a rasping insect.

In another embodiment, the pest invertebrate is a siphoning insect.

In another embodiment, the pest invertebrate is a sponging insect.

In another embodiment of the invention, the pests are Athalia rosae, Autographia californica, Brevicoryne brassicae, Ceutorhynchus sp such as Ceutorhynchus assimilis, Ceutorhynchus napi, Ceutorhynchus obstrictus, Ceutorhynchus pallidactylus, Ceutorhynchus picitarsis, Ceutorhynchus quadridens, Contarinia nasturtii, Dasineura brassicae, Delia brassicae, Dicestra trifoli, Entomoscelis americana, Lygus spp., Lygus hesperus, Lygus lineolaris, Mamestra sp such as Mamestra configurata, Mamestra oleracea; Meligethes sp such as Meligethes aeneus, Meligethes viridescens; Phyllotreta sp such as Phyllotreta cruciferae, Phyllotreta memorum, Phyllotreta undulata, Phyllotreta diademata, Phyllotreta spp., Phyllotreta striolata; Phytomyza rufipes, Pieris sp., Plutella xylostella, Psylliodes sp such as Psylliodes chrysocephala, Psylliodes punctulate; Agromyza parvicornis, Agrotis sp such as Agrotis ipsilon, Agrotis orthogonia, Agrotis segetum, Agrotis munda, Agrotis subterranean; Agrius convolvuli, Anaphothrips obscrurus, Anuraphis maidiradicis, Athetis spp., Blissus leucopterus, Carposina niponensis, Carposina sasakii, Chaetocnema pulicarna, Chilo suppressalis, Conoderus, Aeolus spp., Contarinia sorghicola, Coleophora spp, Cyclocephala borealis, Cyclocephala immaculata, Diabrotica sp such as Diabrotica longicornis barberi, Diabrotica undecimpunctata howardi, Diabrotica virgifera, Diabrotica undecimpunctata, Diabrotica speciosa; Diatraea grandiosella, Diatraea saccharalis, Dichelops melacanthus, Elasmopalpus sp such as Elasmopalpus lignosellus; Feltia subterranea, Helicoverpa sp such as Helicoverpa armigera, Helicoverpa zea, Helicoverpa punctigera; Hylemya platura, Melanoplus femurrubrum, Melanoplus sanguinipes, Melanotus spp., Mythimna separata, Ostrinia sp such as Ostrinia furnacalis, Ostrinia nubilalis; Oulema sp such as Oulema melanopus; Pectinophora spp, Phyllophaga crinita, Eleodes, Popillia japonica, Porthesia scintillans, Rhopalosiphum sp such as Rhopalosiphum maidis, Rhopalosiphum rufabdominale, Rhopalosiphum padi, Rhopalosiphum rufiabdominalis; Pseudaletia spp, Pseudaletia unipuncta, Sesamia nonagrioides, Sipha flava, Solenopsis milesta, Chilo partellus, Sphenophorus maidis, Spodoptera sp such as Spodoptera frugiperda, Spodoptera exigua, Spodoptera litura, Spodoptera praefica, Spodoptera ornithogalli, Spodoptera eridania; Tetranychus sp such as Tetranychus cinnabarinus, Tetranychus urticae, Tetranychus turkestani, Tetranychus pacificus; Tryporyza incertulas, Aceria tulipae, Acrosternum hilare, Anchastus spp., Bothyrus gibbosus, Cephus cinctus, Cylindrocupturus adspersus, Diuraphis sp, Diuraphis noxia, Euschistus servus, Euschistus spp., Frankliniella so such as Frankliniella fusca, Frankliniella occidentalis, Frankliniella bispinosa: Heterodera avenae, Homoeosoma electellum, Hylemya coarctata, Hypera punctata, Irbisia spp., Jylemya platura, Limonius spp. such as Limonius canus, Limonius californicus, Macrosiphum sp such as Macrosiphum avenae, Macrosiphum euphorbiae; Mayetiola sp such as Mayetiola destructor; Melanoplus differentialis, Melanoplus feurrubrum, Melanoplus spp., Meromyza americana, Metopolophium dirhodum, Mythimna unipuncta, Neolasioptera murtfeldtiana, Oligonychus pratensis, Penthaleus major, Petrobia latens, Schizaphis sp, Schizaphis graminum, Sitobion avenae, Sitodiplosis mosellana, Smicronyx fulus, Smicronyx sordidus, Suleima helianthana, Tipula spp., Zygogramma exclamationis, Adelphocoris lineolatus, Adelphocoris suturalis, Alabama argilacea, Alcidodes affaber, Amrasca sp such as Amrasca biguttula, Amrasca devastans, Anomis flava, Anthonomus sp such as Anthonomus grandis; Aphis sp such as Aphis gossypii, Aphis glycines, Aphis craccivora, Aphis fabae, Aphis frangulae, Aphis nasturtii, Aphis spiraecola; Apolygus lucorum, Atactogaster finitimus, Autographa californica, Blapstinus spp., Bucculatrik loxoptera, Bucculatrik thurberiella, Caliothrips fasciatus, Chlorochroa sayi, Chrysodeikis sp such as Chrysodeikis includens, Chrysodeixis erisoma, Compylomma livida, Creontiades spp., Delia platura, Dysdercus sp such as Dysdercus koenigii, Dysdercus spp.; Earias sp such as Earias insulana; Empoasca spp, Empoasca fabae, Empoasca solana, Empoasca devastans, Estigmene acrea, Euschistus conspersus, Euschistus impictiventris, Franklinkiella fusca, Franklinkiella occidentalis, Gryllus spp., Heliothis virescens, Hoplolaimus columbus, Liriomyza spp., Meloidogyne spp., Microtermes obesi, Nysius raphanus, Odontotermes obesus, Onycarenus laetus, Pectinophora gossypiella, Pempherulus affinis, Peridroma saucia, Phenacoccus solenopsis, Platynota stultana, Pseudatomoscelis seriatus, Rotylenchulus reniformis, Scirtothrps dorsalis, Spilosoma obliqua, Sylepta derogata, Tarache otabilis, Thraps sp, Thraps tabaci, Trachea notabilis, Trialeurodes abutilonea, Trichoplusia ni, Udea profundalis, Anticarsia sp such as Anticarsia gemmatalis, Aristotelia reseosuffusella, Calomycterus setarius, Cerotoma trifurcate, Colaspis brunnea, Colaspis crinnicornis, Colaspis flavida, Colias eurytheme, Cyclocephala lurida, Dectes texanus, Diabratica balteata, Diabratica undecimpunctata howardi, Diabratica undecimpunctata, Epargyreus clarus, Epicauta funebris, Epicauta pennsylvanica, Epicauta vittata, Epilachna varivestis, Euschistus heros, Halticus bractatus, Halyomorpha sp such as Halyomorpha halys; Helocoverpa zea, Heterodera glycines, Heterodera spp., Hypena scabra, Myzus sp such as Myzus persicae, Myzus ascalonicus, Myzus ornatus; Naupactus (=Graphognathus) spp, Odontota horni, Papaipema nebris, Phyllophaga rugosa, Piezodorus sp such as Piezodorus guildinil Plathypena scabra, Podisus maculoventris, Pseudoplusia includens, Rivellia quadrifasciata, Sericothrips variabilis, Spilosoma virginica, Spissistilus festinus, Spp of Alydidae, Strigoderma arboricola, Thyanta custator, Vanessa cardui, ORT: Gryllidae, ORT: Acrididae, ORT: Gryllotalpidae, Austroasca alfalfa, Austroasca viridigrisea, Bemisia sp such as Bemisia tabaci, Bemisia argentifolii; Conoderus scissus, Etiella behri, Heteronyx piceus, L epidiota spp, Leucania stenographia, Mythimna spp., Meloidogyne arenaria, Naupactus leucoloma, Pangaeus bilineatus (Say), Paraplonobia spp., COL: Tenebrionidae, COL. Elateridae, COL. Scarabeidae, HET: Myridae, Acizzia solanicola, Agriotes spp., Agriotes lineatus, Agriotes obscurus, Amphimallon solstitialis, Aulacorthum circumflexum, Aulacorthum solani, Bactericerasp such as Bactericera nigricornis, Bactericera cockerellt, Circulifer tennelus, Epitrix sp such as Epitrik hirtipennis, Epitrik fuscula; Nezara sp such as Nezara viridula, Diaphorina citrii. Liriomyza sp such as Liriomyza trifolii. Liriomyza sativae, Heliothis zea, Henosepilachna vigintioctomaculata, Holotrichia sp such as Holotrichia oblita, Holotrichia consanguinea; Leptinotarsa sp such as Leptinotarsa decemlineata; Ctenicera pruinina, Macrosteles fascifrons, Meloidogyne hapla, Meloidogyne chitwoodi, Meloidogyne incognita, Monomorium pharaonic, Pemphigus sp., Phthorimaea spp, Phthorimaea operculella, Pratylenchus penetrans, Pratylenchus neglectus, Paratrichodorus sp., Rhopalosiphoninus latysiphon, Russelliana solanicola Tuthill, Smynthurodes betae, Trialeurodes vaporariorum, Achyra rantalis, Atomaria linearis, Autographa gamma, Blaniulus guttulatus, Cassida nebulosa L., Cassida nobilis (L.) (Col., Chrysomelidae), Chaetocnema tibialis, Circulifer tenellus, Disonycha triangularis, Epitrik cucumeris, Epitrix tuberis, Euxoa auxiliaris, Euxoa nigricans, Heterodera schachtii, Loxostege cereralis, Loxostege sticticalis, Meloidogyne javanica, Meloidogyne arenaria, Meloidogyne hapla, Meloidogyne chitwoodi, Onychiurus spp, Pegomyia betae, Pemphigus populivenae (betae), Piesma quadratum, Aproaerema modicella, Dalbulus sp such as Dalbulus maidis; Dichelops sp. Such as Dichelops melacanthus, Dichelops furcatus, and Systena blanda.

In another embodiment of the invention, the pests are selected from Phyllotreta sp, Psylliodes sp, Meligethes sp, Ceutorhynchus sp, Mamestra sp., Diabrotica sp, Ostrinia sp, Elasmopalpus sp, Dalbulus maidis, Spodoptera sp, Agrotis sp, Tetranychus sp, Limonius sp, Agriotes sp, Melanotus sp, Mayetiola sp, Rhopalosiphum sp, Schizaphis sp, Diuraphis sp, Oulema sp, Pseudaletia sp, Anthonomus sp, Pectinophora sp, Helicoverpa sp, Earias sp, Aphis gossypi, Bemisia sp, Dysdercus sp, Amrasca sp, Lygus sp, Thrips sp, Frankliniella sp, Halyomorpha sp, Piezodorus sp, Nezara sp, Dichelops melacanthus, Dichelops furcatus, Anticarsia sp, Chrysodeikis includens, Chrysodeixis eriosoma, Leptinotarsa sp, Empoasca sp, Pysllids, Bactericera sp, Myzus sp, Macrosiphum sp, Aphis sp, Phthorimaea sp, Liriomyza trifolii, Liriomyza sativae, Aproaerema modicella, and Holotrichia consanguinea,

In another embodiment of the invention, the pests are selected from COL: Bruchidae, COL: Dermestidae, Acanthoscelides obtectus, Acarus siro, Bruchidius atrolineatus, Bruchus atomarius, Bruchus dentipes, Bruchus lentis Frol, Bruchus pisorum, Bruchus rufipes, Callosobruchus chinensis, Callosobruchus maculatus (Fabricius), Callosobruchus subinnotatus, Callosobruchus theobromae, Cryptolestes ferrugineus, Ephestia elutella, Ephestia kuehniella, Oryzaephilus Mercator, Oryzaephilus surinamensis, Palorus depressus, Phthorimaea operculella, Plodia interpunctella, Prostephanus truncatus (Horn), Rhizopertha dominica, Sitophilus granarius (L.), Sitophilus oryzae (L.) (=Calandra oryzae L.), Sitophilus spp., Sitophilus zeamais Motsch. (=Calandra zeamais Motsch.), Sitotroga cerealella, Tribolium destructor, Tribolium madens, Tenebrio molitor L, and Tribolium confusum;

In another preferred embodiment of the invention the pests are selected from Bruchus sp, Callosobruchus sp, Ephestia sp, Plodia sp, Sitophilus sp, Rhizopertha sp, and Tribolium sp;

In one embodiment of the invention, the plant or seed is of corn and the pests are selected from Agromyza parvicornis, Agrotis ipsilon, Agrius convolvuli, Anaphothrips obscrurus, Anuraphis maidiradicis, Athetis spp., Blissus leucopterus, Carposina niponensis, Carposina sasakii, Chaetocnema pulicaria, Chilo suppressalis, Conoderus, Aeolus spp., Contarinia sorghicola, Coleophora spp, Cyclocephala borealis, Cyclocephala immaculata, Dalbulus sp, Diabrotica longicornis barberi, Diabrotica undecimpunctata howardi, Diabrotica virgifera, Diatraea grandiosella, Diatraea saccharalis, Dichelops melacanthus, Elasmopalpus lignosellus, Feltia subterranea, Helicoverpa armigera, Helicoverpa zea, Hylemya platura, Melanoplus femurrubrum, Melanoplus sanguinipes, Melanotus spp., Mythimna separata, Ostrinia furnacalis, Ostrinia nubilalis, Oulema melanopus, Pectinophora spp, Phyllophaga crinita, Eleodes, Popillia japonica, Porthesia scintillans, Rhopalosiphum maidis, Rhopalosiphum maidis, Pseudaletia unipuncta, Sesamia nonagrioides, Sipha flava, Solenopsis milesta, Chilo partellus, Sphenophorus maidis, Spodoptera frugiperda, Spodoptera exigua, Spodoptera litura, Tetranychus cinnabarinus, Tetranychus urticae, and Tryporyza incertulas; preferrably the pest is Dichelops melacanthus;

In another preferred embodiment of the invention, the plant or seed is of corn and the pest are selected from Diabrotica sp, Ostrinia sp, Elasmopalpus sp, corn Dalbulus sp, Spodoptera sp, Agrotis sp, Tetranychus sp, and Dichelops melacanthus; more preferrably the pest is Dichelops melacanthus;

In another embodiment of the invention, the plant or seed is of cereal and the pests are selected from Aceria tulipae, Acrosternum hilare, Aeolus sp., Agrotis ipsilon, Agrotis orthogonia, Anchastus spp., Blissus leucopterus, Bothyrus gibbosus, Cephus cinctus, Cylindrocupturus adspersus, Diabrotica undecimpunctata howardi, Diuraphis noxia, Elasmopalpus lignosellus, Euschistus servus, Euschistus spp., Frankliniella fusca, Heterodera avenae, Homoeosoma electellum, Hylemya coarctata, Hypera punctata, Irbisia spp., Jylemya platura, Limonius spp., Macrosiphum avenae, Mayetiola destructor, Melanoplus differentialis, Melanoplus feurrubrum, Melanoplus sanguinipes, Melanoplus spp., Melanotus spp., Meromyza americana, Metopolophium dirhodum, Mythimna unipuncta, Neolasioptera murtfeldtiana, Oligonychus pratensis, Ostrinia nubilalis, Oulema melanopus, Penthaleus major, Petrobia latens, Pseudaletia spp, Pseudaletia unipunctata, Rhopalosiphum maidis, Rhopalosiphum rufabdominale, Schizaphis graminum, Sitobion avenae, Sitodiplosis mosellana, Smicronyx fulus, Smicronyx sordidus, Spodoptera frugiperda, Spodoptera praefica, Suleima helianthana, Tipula spp., or Zygogramma exclamation is Aceria tulipae, Acrosternum hilare, Aeolus sp., Agrotis ipsilon, Agrotis orthogonia, Anchastus spp., Blissus leucopterus, Bothyrus gibbosus, Cephus cinctus, Cylindrocupturus adspersus, Diabrotica undecimpunctata howardi, Diuraphis noxia, Elasmopalpus lignosellus, Euschistus servus, Euschistus spp., Frankliniella fusca, Heterodera avenae, Homoeosoma electellum, Hylemya coarctata, Hypera punctata, Irbisia spp., Jylemya platura, Limonius spp., Macrosiphum avenae, Mayetiola destructor, Melanoplus differentialis, Melanoplus feurrubrum, Melanoplus sanguinipes, Melanoplus spp., Melanotus spp., Meromyza americana, Metopolophium dirhodum, Mythimna unipuncta, Neolasioptera murtfeldtiana, Oligonychus pratensis, Ostrinia nubilalis, Oulema melanopus, Penthaleus major, Petrobia latens, Pseudaletia spp, Pseudaletia unipunctata, Rhopalosiphum maidis, Rhopalosiphum rufabdominale, Schizaphis graminum, Sitobion avenae, Sitodiplosis mosellana, Smicronyx fulus, Smicronyx sordidus, Spodoptera frugiperda, Spodoptera praefica, and Suleima helianthana; preferrably the pest is Frankliniella fusca or Rhopalosiphum padi;

In another preferred embodiment of the invention, the plant or seed is of cereal and the pest are selected from Limonius sp, Frankliniella fusca, Agriotes sp, Melanotus sp, Mayetiola sp, Rhophalosiphum sp, Schizaphis sp, Diuraphis sp, Oulema sp, Pseudaletia sp, Limonius sp, Agriotes sp, Melanotus sp, Mayetiola sp, Rhophalosiphum sp, Schizaphis sp, Diuraphis sp, Oulema sp and Pseudaletia sp; more preferrably the pest is Frankliniella fusca or Rhopalosiphum padi:

In another embodiment of the invention, the plant or seed is of wheat and the pests are selected from Aceria tulipae, Acrosternum hilare, Aeolus sp., Agrotis ipsilon, Agrotis orthogonia, Anchastus spp., Blissus leucopterus, Bothyrus gibbosus, Cephus cinctus, Cylindrocupturus adspersus, Diabrotica undecimpunctata howardi, Diuraphis noxia, Elasmopalpus lignosellus, Euschistus servus, Euschistus spp., Frankliniella fusca, Heterodera avenae, Homoeosoma electellum, Hylemya coarctata, Hypera punctata, Irbisia spp., Jylemya platura, Limonius spp., Macrosiphum avenae, Mayetiola destructor, Melanoplus differentialis, Melanoplus feurrubrum, Melanoplus sanguinipes, Melanoplus spp., Melanotus spp., Meromyza americana, Metopolophium dirhodum, Mythimna unipuncta, Neolasioptera murtfeldtiana, Oligonychus pratensis, Ostrinia nubilalis, Oulema melanopus, Penthaleus major, Petrobia latens, Pseudaletia spp, Pseudaletia unipunctata, Rhopalosiphum maidis, Rhopalosiphum rufabdominale, Schizaphis graminum, Sitobion avenae, Sitodiplosis mosellana, Smicronyx fulus, Smicronyx sordidus, Spodoptera frugiperda, Spodoptera praefica, Suleima helianthana, Tipula spp., and Zygogramma exclamationis; preferrably the pest is Frankliniella fusca

In another preferred embodiment of the invention, the plant or seed is of wheat and the pest are selected from Limonius sp, Frankliniella fusca, Agriotes sp, Melanotus sp, Mayetiola sp, Rhophalosiphum sp, Schizaphis sp, Diuraphis sp, Oulema sp and Pseudaletia sp; more preferrably the pest is Frankliniella fusca;

In another embodiment of the invention, the plant or seed is of barely and the pests are selected from Acrosternum hilare, Aeolus sp., Agrotis ipsilon, Anchastus spp., Blissus leucopterus leucopterus, Diuraphis noxia, Euschistus servus, Euschistus spp., Heterodera avenae, Irbisia spp., Jylemya platura, Limonius spp., Mayetiola destructor, Melanoplus spp., Melanotus spp., Meromyza Americana, Metopolophium dirhodum, Mythimna unipuncta, Oligonychus pratensis, Ostrinia nubilalis, Penthaleus major, Petrobia latens, Pseudaletia spp, Rhopalosiphum maidis, Rhopalosiphum rufabdominale, Rhopalosiphum padi, Schizaphis graminum, Sitobion avenae, Spodoptera praefica, and Tipula spp.; preferrably the pest is Rhopalosiphum padi;

In another preferred embodiment of the invention, the plant or seed is of barley and the pest are selected from Limonius sp, Agriotes sp, Melanotus sp, Mayetiola sp, Rhophalosiphum sp, Schizaphis sp, Diuraphis sp, Oulema sp, and Pseudaletia sp; more preferrably the pest is Rhopalosiphum padi;

In another embodiment of the invention, the plant or seed is of canola and the pests are selected from Agrotis ipsilon, Athalia rosae, Autographia californica, Brevicoryne brassicae, Ceutorhynchus assimilis, Ceutorhynchus napi, Ceutorhynchus obstrictus, Ceutorhynchus pallidactylus, Ceutorhynchus picitarsis, Ceutorhynchus quadridens, Contarinia nasturtii, Dasineura brassicae, Delia brassicae, Dicestra trifoli, Entomoscelis americana, Lygus spp., Mamestra configurata, Meligethes aeneus, Meligethes viridescens, Myzus persicae, Phyllotreta cruciferae, Phyllotreta memorum, Phyllotreta undulata, Phyllotreta diademata, Phyllotreta spp, Phyllotreta striolata, Phytomyza rufipes, Pieris sp., Plutella xylostella, Psylliodes chrysocephala, Psylliodes punctulata, and Vanessa cardui; preferrably the pest is Phyllotreta striolata;

In another preferred embodiment of the invention, the plant or seed is of canola and the pest are selected from Phyllotreta sp, Psylloides sp, Meligethes sp, Ceutorhynchus sp and Mamestra sp.: more preferrably the pest is Phyllotreta striolata:

In another embodiment of the invention, the plant or seed is of cotton and the pests are selected from Adelphoconis lineolatus, Adelphocoris suturalis, Agrotis ipsilon, Agrotis segetum, Alabama argilacea, Alcidodes affaber, Amrasca biguttula, Anomis flava, Anthonomus grandis, Aphis gossypii, Apolygus lucorum, Atactogaster finitimus; Autographa californica, Blapstinus spp., Bucculatrix loxoptera, Bucculatrix thurberiella, Caliothrips fasciatus, Chlorochroa sayi, Chrysodeixis includens, Compylomma livida Creontiades spp., Delia platura, Dysdercus koenigii, Dysdercus spp., Earias insulana, Elasmopalpus lignosellus, Empoasca fabae, Empoasca solana, Estigmene acrea, Euschistus conspersus, Euschistus impictiventris, Euschistus servus, Feltia subterranean, Franklinkiella fusca, Franklinkiella occidentalis, Gryllus spp., Helicoverpa armigera, Helicoverpa zea, Heliothis virescens, Hoplolaimus columbus, Limonius spp., Liriomyza spp., Lygus hesperus, Lygus lineolaris, Melanoplus differentialis, Melanoplus femurrubrum, Meloidogyne spp., Microtermes obesi, Nysius raphanus, Odontotermes obesus, Onycarenus laetus, Pectinophora gossypiella, Pempherulus affinis, Peridroma saucia, Phenacoccus solenopsis, Platynota stultana, Pseudatomoscelis seriatus, Rotylenchulus reniformis, Scirtothrips dorsalis; Spilosoma obliqua, Spodoptera exigua, Spodoptera frugiperda, Spodoptera litura, Spodoptera praefica, Sylepta derogata, Tarache otabilis, Tetranychus cinnabarinus, Tetranychus turkestani, Tetranychus pacificus, Tetranychus urticae, Thrips tabaci, Trachea notabilis, Trialeurodes abutilonea, Trichoplusia ni, and Udea profundalis; preferrably the pest is Frankliniella fusca or Frankliniella occidentalis;

In another preferred embodiment of the invention, the plant or seed is of cotton and the pest are selected from Anthonomus sp, Pectinophora sp, Helicoverpa sp, Earias sp, Aphis gossypi, Bemisia sp, Dysdercus sp, Amrasca sp, Lygus sp, Thrips sp, Frankliniella sp, and Agrotis sp; more preferrably the pest is Frankliniella fusca or Frankliniella occidentalis;

In another embodiment of the invention, the plant or seed is of soybean and the pests are selected from Acrosternum hilare, Agrotis ipsilon, Anticarsia gemmatalis, Aphis glycines, Aristotelia reseosuffusella, Calomycterus setarius, Cerotoma trifurcate, Colaspis brunnea, Chrysodeixis includens, Chrysodeixis eriosoma, Colaspis crinnicornis, Colaspis flavida, Collas eurytheme, Cyclocephala lurida, Dichelops melacanthus, Dichelops furcatus Dectes texanus texanus, Diabratica balteata, Diabratica undecimpunctata howardi, Diabratica undecimpunctata, Elasmopalpus lignosellus, Empoasca fabae, Epargyreus clarus, Epicauta funebris, Epicauta pennsylvanica, Epicauta vittata, Epilachna varivestis, Estigmene acrea, Euschistus heros, Euschistus servus, Halticus bractatus, Halyomorpha halys, Helicoverpa zea, Heliothis virescens, Helocoverpa zea, Heterodera glycines, Heterodera spp., Hylemya platura, Hypena scabra, Melanoplus differentialis, Melanoplus femurrubrum, Myzus persicae, Naupactus (=Graphognathus) spp, Odontota horni, Ostrinia nubilalis, Papaipema nebris, Peridroma saucia, Phyllophaga rugosa, Piezodorus guildinii Plathypena scabra, Podisus maculoventris, Popillia japonica, Pseudoplusia includens, Rivellia quadrifasciata, Sericothrips variabilis, Spilosoma virginica, Spissistilus festinus, Spodoptera exigua, Spodoptera frugiperda, Spodoptera ornithogalli, Spodoptera ornithogalli, Spp of Alydidae, Strigoderma arboricola, Tetranychus turkestani, Tetranychus urticae, Thrips tabaci, Thyanta custator, Trialeurodes abutilonea, Vanessa cardui, ORT: Gryllidae, ORT: Acrididae, and ORT: Gryllotalpidae; preferrably the pest is Elasmopalpus lignosellus;

In another preferred embodiment of the invention, the plant or seed is of soybean and the pest are selected from Halyomorpha sp, Piezodorus sp, Nezara sp, Dichelops sp, Bemisia sp, Elasmopalpus sp, Anticarsia sp, Spodoptera sp, Helicoverpa sp, and Chrysodeixis sp; more preferrably the pest is Elasmopalpus lignosellus;

In another embodiment of the invention, the plant or seed is of peanut and the pests are selected from Agrotis munda, Agrotis ipsilon, Anticarsia gemmatalis, Austroasca alfalfa, Austroasca viridigrisea, Aphis craccivora, Aproaerema modicella, Bemisia tabaci, Chrysodeikis includens, Conoderus scissus, Creontiades spp., Diabrotica undecimpunctata, Elasmopalpus lignosellus, Empoasca spp, Empoasca fabae, Etiella behri, Feltia subterranean, Frankliniella occidentalis, Frankliniella bispinosa, Frankliniella fusca, Helicoverpa armigera, Helicoverpa punctigera, Heteronyx piceus, Holotrichia consanguinea, L epidiota spp, Leucania stenographia, Liriomyza sp such as Liriomyza trifolii, Liriomyza sativae, Mythimna spp., Meloidogyne arenaria, Meloidogyne spp., Naupactus leucoloma, Pangaeus bilineatus (Say), Paraplonobia spp, Spissistilus festinus, Spodoptera exigua, Spodoptera frugiperda, Spodoptera litura, Spodoptera ornithogalli, Tetranychus urticae, COL: Tenebrionidae, COL: Elateridae, COL: Scarabeidae, ORT: Gryllotalpidae, and HET: Myridae; preferrably the pest is Frankliniella occidentalis, Frankliniella bispinosa, and Frankliniella fusca; more preferrably the pest is Frankliniella fusca;

In another preferred embodiment of the invention, the plant or seed is of peanut and the pest are selected from Frankliniella sp, Helicoverpa sp, Spodoptera sp, Liriomyza trifolii, Liriomyza sativae, Aproaerema modicella, Aphis sp, Holotrichia consanguinea, and Empoasca sp; more preferrably the pest is Frankliniella fusca;

In another embodiment of the invention, the plant or seed is of potato and the pests are selected from COL: Elateridae, Amrasca biguttula biguttula, Acizzia solanicola, Agriotes lineatus, Agriotes obscurus, Agrotis ipsilon, Amphimallon solstitialis, Amrasca devastans, Aphis fabae, Aphis frangulae, Aphis gossypii, Aphis nasturtii, Aphis spiraecola, Aulacorthum circumflexum, Aulacorthum solani, Autographa californica, Bactericera nigricornis, Bactericera cockerelli, Bemisia argentifolii, Circulifer tennelus, Diabrotica speciosa, Empoasca devastans, Empoasca fabae, Epitrix spp., Heliothis zea, Henosepilachna vigintioctomaculata, Heterodera spp., Holotrichia oblita, Leptinotarsa decemlineata, Limonius canus, Limonius californicus, Ctenicera pruinina, Liriomyza spp, Macrosiphum euphorbiae, Macrosteles fascifrons, Meloidogyne hapla, Meloidogyne chitwoodi, M. incognita, Monomorium pharaonic, Myzus ascalonicus, Myzus ornatus, Myzus persicae, Pemphigus sp., Peridroma saucia, Phthorimaea operculella, Phthorimaea spp, Pratylenchus penetrans, P. neglectus, Paratrichodorus sp., Pseudoplusia includens, Rhopalosiphoninus latysiphon, Rhopalosiphum rufiabdominalis, Russelliana solanicola Tuthill, Smynthurodes betae, Spodoptera eridania, Spodoptera frugiperda, Spodoptera litura, and Trialeurodes vaporariorum; preferrably the pest is Leptinotarsa decemlineata;

In another preferred embodiment of the invention, the plant or seed is of potato and the pest are selected from Leptinotarsa sp, Limonius sp, Agriotes sp, Empoasca sp, pysllids, Bactericera sp, Myzus sp, Macrosiphum sp, Aphis sp, and Phthorimaea sp; more preferrably the pest is Leptinotarsa decemlineata;

In another embodiment of the invention, the plant or seed is of sugarbeet and the pests are selected from Achyra rantalis, Agriotes spp., Limonius spp., Agrotis ipsilon, Agrotis ipsilon, Agrotis orthogonia, Agrotis segetum, Agrotis subterranean, Aphis craccivora, Aphis fabae, Aphis gossypii, Atomaria linearis, Autographa gamma, Bemisia argentifolii, Bemisia tabaci, Blaniulus guttulatus, Cassida nebulosa L., Cassida nobilis (L.) (Col., Chrysomelidae), Chaetocnema tibialis, Circulifer tenellus, Delia platura, Disonycha triangularis, Empoasca fabae, Empoasca Solana, Epitrix cucumeris, Epitrix tuberis, Estigmene acrea, Euxoa auxiliaris, Euxoa nigricans, Heterodera schachtii, Liriomyza spp., Loxostege cereralis, Loxostege sticticalis, Macrosiphum euphorbiae, Mamestra oleracea, Melanoplus spp., Meloidogyne incognita, M. javanica, M. arenaria M. hapla, and M. chitwoodi, Myzus persicae, Onychiurus spp, Pegomyia betae, Pemphigus populivenae (betae), Peridroma saucia, Piesma quadratum, Spodoptera exigua, Spodoptera praefica, Systena blanda, Tetranychus cinnabarinus, and Tetranychus urticae; preferrably the pest is Aphis craccivora, Aphis fabae, Myzus persicae, or Aphis gossypii;

In another preferred embodiment of the invention, the plant or seed is of sugarbeet and the pest are selected from Leptinotarsa sp, Limonius sp, Agriotes sp, Empoasca sp, pysllids, Bactericera sp, Myzus sp, Macrosiphum sp, Aphis sp, and Phthorimaea sp; more preferrably the pest is Aphis craccivora, Aphis fabae, Myzus persicae, or Aphis gossypii;

In more preferred embodiment of the invention, the pests are selected from Phyllotreta sp, Rhophalosiphum sp, Myzus sp, Elasmopalpus sp, Dichelops sp, Frankliniella sp, and Leptinotarsa sp.

In another preferred embodiment of the invention, the plant or seed is selected from soybean, corn, canola, cereals, sugarbeet, cotton, peanut, and potato, the pests are selected from Phyllotreta sp, Rhophalosiphum sp, Myzus sp, Elasmopalpus sp, Dichelops sp, Frankliniella sp, and Leptinotarsa sp.

In another preferred embodiment of the invention, the plant or seed is selected from soybean, corn, canola, cereals, sugarbeet, cotton, peanut, and potato, the pests are selected from Dichelops melacanthus, Frankliniella fusca, Frankliniella occidentalis, Rhopalosiphum padi, Phyllotreta striolata, Elasmopalpus lignosellus, Leptinotarsa decemlineata, and Myzus persicae;

In more preferred embodiment of the invention, the pests are selected from Dichelops melacanthus, Frankliniella fusca, Frankliniella occidentalis, Rhopalosiphum padi, Phyllotreta striolata, Elasmopalpus lignosellus, Leptinotarsa decemlineata, and Myzus persicae;

In one embodiment of the invention, the seeds are of soybean, corn, canola, cereals, sugarbeet, cotton, peanut, or potato and the pests are storage pests selected from COL: Bruchidae, COL: Dermestidae, Acanthoscelides obtectus, Acarus siro, Bruchidius atrolineatus, Bruchus atomarius, Bruchus dentipes, Bruchus lentis Frol, Bruchus pisorum, Bruchus rufipes, Callosobruchus chinensis, Callosobruchus maculatus (Fabricius), Callosobruchus subinnotatus, Callosobruchus theobromae, Cryptolestes ferrugineus, Ephestia elutella, Ephestia kuehniella, Oryzaephilus Mercator, Oryzaephilus surinamensis, Palorus depressus, Phthorimaea operculella, Plodia interpunctella, Prostephanus truncatus (Horn), Rhizopertha dominica, Sitophilus granarius (L.), Sitophilus oryzae (L.) (=Calandra oryzae L.), Sitophilus spp., Sitophilus zeamais Motsch. (=Calandra zeamais Motsch.), Sitotroga cerealella, Tribolium destructor, Tribolium madens, Tenebrio molitor L, and Tribolium confusum;

Particularly preferred combinations of seed/plant and the pests according to the present invention are disclosed in below table Z

TABLE Z

| Sr | | |
|---|---|---|
| No | plant/seed | pest |
| 1. | corn | Diabrotica sp |
| 2. | corn | Ostrinia sp |
| 3. | corn | Elasmopalpus sp |
| 4. | corn | Dalbulus |
| 5. | corn | Spodoptera sp |
| 6. | corn | Agrotis sp |
| 7. | corn | Tetranychus sp |
| 8. | corn | Dichelops melacanthus |
| 9. | wheat | Limonius sp |
| 10. | wheat | Frankliniella fusca |
| 11. | wheat | Agriotes sp |
| 12. | wheat | Melanotus sp |
| 13. | wheat | Mayetiola asp |
| 14. | wheat | Rhophalosiphum sp |
| 15. | wheat | Schizaphis sp |
| 16. | wheat | Diuraphis sp |
| 17. | wheat | Oulema sp |
| 18. | wheat | Pseudaletia sp |
| 19. | barley | Limonius sp |
| 20. | barley | Agriotes sp |
| 21. | barley | Melanotus sp |
| 22. | barley | Mayetiola sp |
| 23. | barley | Rhophalosiphum sp |
| 24. | barley | Schizaphis sp |
| 25. | barley | Diuraphis sp |
| 26. | barley | Oulema sp |
| 27. | barley | Pseudaletia sp |
| 28. | canola | Phyllotreta sp |
| 29. | canola | Psylloides sp |
| 30. | canola | Meligethes sp |
| 31. | canola | Ceutorhynchus sp |
| 32. | canola | Mamestra sp. |
| 33. | cotton | Anthonomus sp |
| 34. | cotton | Pectinophora sp |
| 35. | cotton | Helicoverpa sp |
| 36. | cotton | Earias sp |
| 37. | cotton | Aphis gossypi |
| 38. | cotton | Bemisia sp |
| 39. | cotton | Dysdercus sp |
| 40. | cotton | Amrasca sp |
| 41. | cotton | Lygus sp |
| 42. | cotton | Thrips sp |
| 43. | cotton | Frankliniella sp |
| 44. | cotton | Agrotis sp |
| 45. | soybean | Halyomorpha sp |
| 46. | soybean | Piezodorus sp |
| 47. | soybean | Nezara sp |
| 48. | soybean | Dichelops sp |
| 49. | soybean | Bemisia sp |
| 50. | soybean | Elasmopalpus sp |
| 51. | soybean | Anticarsia sp |
| 52. | soybean | Spodoptera sp |
| 53. | soybean | Helicoverpa sp |
| 54. | soybean | Chrysodeixis sp |
| 55. | peanut | Frankliniella sp |
| 56. | peanut | Helicoverpa sp |
| 57. | peanut | Spodoptera sp |
| 58. | peanut | Liriomyza sp |
| 59. | peanut | Aproaerema modicella |
| 60. | peanut | Aphis sp |
| 61. | peanut | Holotrichia sp |
| 62. | peanut | Empoasca sp |
| 63. | potato | Leptinotarsa sp |
| 64. | potato | Limonius sp |
| 65. | potato | Agriotes sp |
| 66. | potato | Empoasca sp |
| 67. | potato | pysllids |
| 68. | potato | Bactericera sp |
| 69. | potato | Myzus sp |
| 70. | potato | Macrosiphum sp |
| 71. | potato | Aphis sp |
| 72. | potato | Phthorimaea sp |
| 73. | sugarbeet | Leptinotarsa sp |
| 74. | sugarbeet | Limonius sp |
| 75. | sugarbeet | Agriotes sp |
| 76. | sugarbeet | Empoasca sp |
| 77. | sugarbeet | pysllids |
| 78. | sugarbeet | Bactericera sp |
| 79. | sugarbeet | Myzus s |
| 80. | sugarbeet | Macrosiphum sp |
| 81. | sugarbeet | Aphias sp |
| 82. | sugarbeet | Phthorimaea sp |
| 83. | corn | Bruchus sp |
| 84. | corn | Callosobruchus sp |
| 85. | corn | Ephestia sp |
| 86. | corn | Plodia sp |
| 87. | corn | Sitophllus sp |
| 88. | corn | Rhizopertha sp |
| 89. | corn | Tribolium sp |
| 90. | wheat | Bruchus sp |
| 91. | wheat | Callosobruchus sp |
| 92. | wheat | Ephestia sp |
| 93. | wheat | Plodia sp |
| 94. | wheat | Sitophilus sp |
| 95. | wheat | Rhizopertha sp |
| 96. | wheat | Tribolium sp |
| 97. | barely | Bruchus sp |
| 98. | barely | Callosobruchus sp |
| 99. | barely | Ephestia sp |
| 100. | barely | Plodia sp |
| 101. | barely | Sitophilus sp |
| 102. | barely | Rhizopertha sp |
| 103. | barely | Tribolium sp |
| 104. | cotton | Bruchus sp |
| 105. | cotton | Callosobruchus sp |
| 106. | cotton | Ephestia sp |
| 107. | cotton | Plodia sp |
| 108. | cotton | Sitophilus sp |
| 109. | cotton | Rhizopertha sp |
| 110. | cotton | Tribolium sp |
| 111. | canola | Bruchus sp |
| 112. | canola | Callosobruchus sp |
| 113. | canola | Ephestia sp |
| 114. | canola | Plodia sp |
| 115. | canola | Sitophilus sp |
| 116. | canola | Rhizopertha sp |
| 117. | canola | Tribolium sp |
| 118. | soybean | Bruchus sp |
| 119. | soybean | Callosobruchus sp |
| 120. | soybean | Ephestia sp |
| 121. | soybean | Plodia sp |
| 122. | soybean | Sitophilus sp |
| 123. | soybean | Rhizopertha sp |
| 124. | soybean | Tribolium sp |
| 125. | peanut | Bruchus sp |
| 126. | peanut | Callosobruchus sp |
| 127. | peanut | Ephestia sp |
| 128. | peanut | Plodia sp |
| 129. | peanut | Sitophilus sp |
| 130. | peanut | Rhizopertha sp |
| 131. | peanut | Tribolium sp |
| 132. | potato | Bruchus sp |
| 133. | potato | Callosobruchus sp |
| 134. | potato | Ephestia sp |
| 135. | potato | Plodia sp |
| 136. | potato | Sitophilus sp |
| 137. | potato | Rhizopertha sp |
| 138. | potato | Tribolium sp |
| 139. | sugarbeet | Bruchus sp |
| 140. | sugarbeet | Callosobruchus sp |
| 141. | sugarbeet | Ephestia sp |
| 142. | sugarbeet | Plodia sp |
| 143. | sugarbeet | Sitophilus sp |
| 144. | sugarbeet | Rhizopertha sp |

As mentioned further above, in one embodiment of the invention, the pesticidal compound of formula (I) can be combined and used in mixture with at least one another active compound II applied in agriculture, such as another insecticidal active, a fungicidal active. In another embodiment of the invention, the pesticidal compound of formula (I) can be combined and used in mixture with more than one other active compound applied in agriculture. Thus the pesticidal compound of formula (I) can be combined and used in mixture with more than one other insecticide and/or with more than one fungicide.

For example the pesticidal compound of formula (I) can be combined and used in mixture with one, two, three or four other agriculturally active compound selected from pesticides.

Preferably such other compounds are active against invertebrate pests; a skilled person is familiar with such compounds and knows which compounds are active against a specific target organism.

The following lists M of pesticides/pesticidally active compounds together with which the compounds according to the invention can be used and with which also potential synergistic effects might be produced, are intended to illustrate the possible combinations, but not to impose any limitation:

M.1 Acetylcholine esterase (AChE) inhibitors: M.1A carbamates, e.g. aldicarb, alanycarb, bendiocarb, benfuracarb, butocarboxim, butoxycarboxim, carbaryl, carbofuran, carbosulfan, ethiofencarb, fenobucarb, formetanate, furathiocarb, isoprocarb, methiocarb, methomyl, metolcarb, oxamyl, pirimicarb, propoxur, thiodicarb, thiofanox, trimethacarb, XMC, xylylcarb and triazamate; or M.1B organophosphates, e.g. acephate, azamethiphos, azinphos-ethyl, azinphosmethyl, cadusafos, chlorethoxyfos, chlorfenvinphos, chlormephos, chlorpyrifos, chlorpyrifos-methyl, coumaphos, cyanophos, demeton-S-methyl, diazinon, dichlorvos/DDVP, dicrotophos, dimethoate, dimethylvinphos, disulfoton, EPN, ethion, ethoprophos, famphur, fenamiphos, fenitrothion, fenthion, fosthiazate, heptenophos, imicyafos, isofenphos, isopropyl O(methoxyaminothio-phosphoryl) salicylate, isoxathion, malathion, mecarbam, methamidophos, methidathion, mevinphos, monocrotophos, naled, omethoate, oxydemeton-methyl, parathion, parathion-methyl, phenthoate, phorate, phosalone, phosmet, phosphamidon, phoxim, pirimiphos-methyl, profenofos, propetamphos, prothiofos, pyraclofos, pyridaphenthion, quinalphos, sulfotep, tebupirimfos, temephos, terbufos, tetrachlorvinphos, thiometon, triazophos, trichlorfon, and vamidothion;

M.2. GABA-gated chloride channel antagonists: M.2A cyclodiene organochlorine compounds, e.g. endosulfan or chlordane; or M.2B fiproles (phenylpyrazoles), e.g. ethiprole, fipronil, flufiprole, pyrafluprole, and pyriprole;

M.3 Sodium channel modulators from the class of M.3A pyrethroids, e.g. acrinathrin, allethrin, d-cis-trans allethrin, d-trans allethrin, bifenthrin (in particular kappa-bifenthrin), bioallethrin, bioallethrin S-cylclopentenyl, bioresmethrin, cycloprothrin, cyfluthrin, beta-cyfluthrin, cyhalothrin, lambda-cyhalothrin, gamma-cyhalothrin, cypermethrin, alpha-cypermethrin, beta-cypermethrin, theta-cypermethrin, zeta-cypermethrin, cyphenothrin, deltamethrin, empenthrin, esfenvalerate, etofenprox, fenpropathrin, fenvalerate, flucythrinate, flumethrin, tau-fluvalinate, halfenprox, heptafluthrin, imiprothrin, meperfluthrin, metofluthrin, momfluorothrin (in particular epsilon-momfluorothrin), permethrin, phenothrin, prallethrin, profluthrin, pyrethrin (pyrethrum), resmethrin, silafluofen, tefluthrin (in particular kappa-tefluthrin), tetramethylfluthrin, tetramethrin, tralomethrin, and transfluthrin; or M.3B sodium channel modulators such as DDT or methoxychlor;

M.4 Nicotinic acetylcholine receptor agonists (nAChR): M.4A neonicotinoids, e.g. acetamiprid, clothianidin, cycloxaprid, dinotefuran, imidacloprid, nitenpyram, thiacloprid and thiamethoxam; or the compounds M.4A.1 4,5-Dihydro-N-nitro-1-(2-oxiranylmethyl)-1H-imidazol-2-amine, M.4A.2: (2E-)-1-[(6-Chloropyridin-3-yl)methyl]-N′-nitro-2-pentylidenehydrazinecarboximidamide; or M4.A.3: 1-[(6-Chloropyridin-3-yl)methyl]-7-methyl-8-nitro-5-propoxy-1,2,3,5,6,7-hexahydroimidazo[1,2-a]pyridine; or M.4B nicotine; M.4C sulfoxaflor; M.4D flupyradifurone; M.4E triflumezopyrim;

M.5 Nicotinic acetylcholine receptor allosteric activators: spinosyns, e.g. spinosad or spinetoram;

M.6 Chloride channel activators from the class of avermectins and milbemycins, e.g. abamectin, emamectin benzoate, ivermectin, lepimectin, or milbemectin;

M.7 Juvenile hormone mimics, such as M.7A juvenile hormone analogues hydroprene, kinoprene, and methoprene; or M.7B fenoxycarb, or M.7C pyriproxyfen;

M.8 miscellaneous non-specific (multi-site) inhibitors, e.g. M.8A alkyl halides as methyl bromide and other alkyl halides, M.8B chloropicrin, M.8C sulfuryl fluoride, M.8D borax, or M.8E tartar emetic;

M.9 Chordotonal organ TRPV channel modulators, e.g. M.9B pymetrozine; pyrifluquinazon;

M.10 Mite growth inhibitors, e.g. M.10A clofentezine, hexythiazox, and diflovidazin, or M.10B etoxazole;

M.12 Inhibitors of mitochondrial ATP synthase, e.g. M.12A diafenthiuron, or M.12B organotin miticides such as azocyclotin, cyhexatin, or fenbutatin oxide, M.12C propargite, or M.12D tetradifon;

M.13 Uncouplers of oxidative phosphorylation via disruption of the proton gradient, e.g. chlorfenapyr, DNOC, or sulfluramid;

M.14 Nicotinic acetylcholine receptor (nAChR) channel blockers, e.g. nereistoxin analogues bensultap, cartap hydrochloride, thiocyclam, or thiosultap sodium;

M.15 Inhibitors of the chitin biosynthesis type 0, such as benzoylureas e.g. bistrifluron, chlorfluazuron, diflubenzuron, flucycloxuron, flufenoxuron, hexaflumuron, lufenuron, novaluron, noviflumuron, teflubenzuron, or triflumuron;

M.16 Inhibitors of the chitin biosynthesis type 1, e.g. buprofezin;

M.17 Moulting disruptors, Dipteran, e.g. cyromazine;

M.18 Ecdyson receptor agonists such as diacylhydrazines, e.g. methoxyfenozide, tebufenozide, halofenozide, fufenozide, or chromafenozide;

M.19 Octopamin receptor agonists, e.g. amitraz;

M.20 Mitochondrial complex Ill electron transport inhibitors, e.g. M.20A hydramethylnon, M.20B acequinocyl, M.20C fluacrypyrim; or M.20D bifenazate;

M.21 Mitochondrial complex I electron transport inhibitors, e.g. M.21A METI acaricides and insecticides such as fenazaquin, fenpyroximate, pyrimidifen, pyridaben, tebufenpyrad or tolfenpyrad, or M.21B rotenone;

M.22 Voltage-dependent sodium channel blockers, e.g. M.22A indoxacarb, M.22B metaflumizone, or M.22B.1: 2-[2-(4-Cyanophenyl)-1-[3-(trifluoromethyl)phenyl]ethylidene]-N-[4-(difluoromethoxy)phenyl]-hydrazinecarboxamide or M.22B.2: N-(3-Chloro-2-methylphenyl)-2-[(4-chlorophenyl)[4-[methyl(methylsulfonyl)amino]phenyl]methylene]-hydrazinecarboxamide;

M.23 Inhibitors of the of acetyl CoA carboxylase, such as Tetronic and Tetramic acid derivatives, e.g. spirodiclofen, spiromesifen, or spirotetramat; M.23.1 spiropidion

M.24 Mitochondrial complex IV electron transport inhibitors, e.g. M.24A phosphine such as aluminium phosphide, calcium phosphide, phosphine or zinc phosphide, or M.24B cyanide;

M.25 Mitochondrial complex II electron transport inhibitors, such as beta-ketonitrile derivatives, e.g. cyenopyrafen or cyflumetofen;

M.28 Ryanodine receptor-modulators from the class of diamides, e.g. flubendiamide, chlorantraniliprole, cyantraniliprole, tetraniliprole, M.28.1: (R)-3-Chlor-N1-{2-methyl-4-[1,2,2,2-tetrafluoro-1-(trifluoromethyl)ethyl]phenyl}-N2-(1-methyl-2-methylsulfonylethyl)phthalamid, M.28.2: (S)-3-Chloro-N1-{2-methyl-4-[1,2,2,2-tetrafluoro-1-(trifluoromethyl)ethyl]phenyl}-N2-(1-methyl-2-methylsulfonylethyl)phthalamid, M.28.3: cyclaniliprole, or M.28.4: methyl-2-[3,5-dibromo-2-({[3-bromo-1-(3-chlorpyridin-2-yl)-1H-pyrazol-5-yl]carbonyl}amino)benzoyl]-1,2-dimethylhydrazinecarboxylate; or M.28.5a) N-[4,6-dichloro-2-[(diethyl-lambda-4-sulfanylidene)carbamoyl]-phenyl]-2-(3-chloro-2-pyridyl)-5-(trifluoromethyl)pyrazole-3-carboxamide; M.28.5b) N-[4-chloro-2-[(diethyl-lambda-4-sulfanylidene)carbamoyl]-6-methyl-phenyl]-2-(3-chloro-2-pyridyl)-5-(trifluoromethyl)pyrazole-3-carboxamide; M.28.5c) N-[4-chloro-2-[(di-2-propyl-lambda-4-sulfanylidene)carbamoyl]-6-methyl-phenyl]-2-(3-chloro-2-pyridyl)-5-(trifluoromethyl)pyrazole-3-carboxamide; M.28.5d) N-[4,6-dichloro-2-[(di-2-propyl-lambda-4-sulfanylidene)carbamoyl]-phenyl]-2-(3-chloro-2-pyridyl)-5-(trifluoromethyl)pyrazole-3-carboxamide; M.28.5h) N-[4,6-dibromo-2-[(diethyl-lambda-4-sulfanylidene)carbamoyl]-phenyl]-2-(3-chloro-2-pyridyl)-5-(trifluoromethyl)pyrazole-3-carboxamide; M.28.5i) N-[2-(5-Amino-1,3,4-thiadiazol-2-yl)-4-chloro-6-methylphenyl]-3-bromo-1-(3-chloro-2-pyridinyl)-1H-pyrazole-5-carboxamide; M.28.5j) 3-Chloro-1-(3-chloro-2-pyridinyl)-N-[2,4-dichloro-6-[[(1-cyano-1-methylethyl)amino]carbonyl]phenyl]-1H-pyrazole-5-carboxamide; M.28.5k) 3-Bromo-N-[2,4-dichloro-6-(methylcarbamoyl)phenyl]-1-(3,5-dichloro-2-pyridyl)-1H-pyrazole-5-carboxamide; M.28.5l) N-[4-Chloro-2-[[(1,1-dimethylethyl)amino]carbonyl]-6-methylphenyl]-1-(3-chloro-2-pyridinyl)-3-(fluoromethoxy)-1H-pyrazole-5-carboxamide; or

M.28.6: cyhalodiamide; or

M.29: Chordotonal organ Modulators—undefined target site, e.g. flonicamid; M.UN. insecticidal active compounds of unknown or uncertain mode of action, e.g. afidopyropen, afoxolaner, azadirachtin, amidoflumet, benzoximate, broflanilide, bromopropylate, chinomethionat, cryolite, dicloromezotiaz, dicofol, flufenerim, flometoquin, fluensulfone, fluhexafon, fluopyram, fluralaner, metoxadiazone, piperonyl butoxide, pyflubumide, pyridalyl, tioxazafen, M.UN.3: 11-(4-chloro-2,6-dimethylphenyl)-12-hydroxy-1,4-dioxa-9-azadispiro[4.2.4.2]-tetradec-11-en-10-one,

M.UN.4: 3-(4′-fluoro-2,4-dimethylbiphenyl-3-yl)-4-hydroxy-8-oxa-1-azaspiro[4.5]dec-3-en-2-one,

M.UN.5: 1-[2-fluoro-4-methyl-5-[(2,2,2-trifluoroethyl)sulfinyl]phenyl]-3-(trifluoromethyl)-1H-1,2,4-triazole-5-amine, or actives on basis of Bacillus firmus (Votivo, 1-1582);

M.UN.6: flupyrimin;

M.UN.8: fluazaindolizine; M.UN.9.a): 4-[5-(3,5-dichlorophenyl)-5-(trifluoromethyl)-4H-isoxazol-3-yl]-2-methyl-N-(1-oxothietan-3-yl)benzamide; M.UN.9.b): fluxametamide; M.UN.10: 5-[3-[2,6-dichloro-4-(3,3-dichloroallyloxy)phenoxy]propoxy]-1H-pyrazole;

M.UN.11.b) 3-(benzoylmethylamino)-N-[2-bromo-4-[1,2,2,3,3,3-hexafluoro-1-(trifluoromethyl)propyl]-6-(trifluoromethyl)phenyl]-2-fluoro-benzamide; M.UN.11.c) 3-(benzoylmethylamino)-2-fluoro-N-[2-iodo-4-[1,2,2,2-tetrafluoro-1-(trifluoromethyl)ethyl]-6-(trifluoromethyl)phenyl]-benzamide; M.UN.11.d) N-[3-[[[2-iodo-4-[1,2,2,2-tetrafluoro-1-(trifluoromethyl)ethyl]-6-(trifluoromethyl)phenyl]amino]carbonyl]phenyl]-N-methyl-benzamide; M.UN.11.e) N-[3-[[[2-bromo-4-[1,2,2,2-tetrafluoro-1-(trifluoromethyl)ethyl]-6-(trifluoromethyl) phenyl]amino]carbonyl]-2-fluorophenyl]-4-fluoro-N-methyl-benzamide; M.UN.11.f) 4-fluoro-N-[2-fluoro-3-[[[2-iodo-4-[1,2,2,2-tetrafluoro-1-(trifluoromethyl)ethyl]-6-(trifluoromethyl)phenyl]amino]carbonyl]phenyl]-N-methyl-benzamide; M.UN.11.g) 3-fluoro-N-[2-fluoro-3-[[[2-iodo-4-[1,2,2,2-tetrafluoro-1-(trifluoromethyl)ethyl]-6-(trifluoromethyl)phenyl]amino]carbonyl]phenyl]-N-methyl-benzamide; M.UN.11.h) 2-chloro-N-[3-[[[2-iodo-4-[1,2,2,2-tetrafluoro-1-(trifluoromethyl)ethyl]-6-(trifluoromethyl)phenyl]amino]carbonyl]phenyl]-3-pyridinecarboxamide; M.UN.11.i) 4-cyano-N-[2-cyano-5-[[2,6-dibromo-4-[1,2,2,3,3,3-hexafluoro-1-(trifluoromethyl)propyl]phenyl]carbamoyl]phenyl]-2-methyl-benzamide; M.UN.11.j) 4-cyano-3-[(4-cyano-2-methyl-benzoyl)amino]-N-[2,6-dichloro-4-[1,2,2,3,3,3-hexafluoro-1-(trifluoromethyl)propyl]phenyl]-2-fluoro-benzamide; M.UN.11.k) N-[5-[[2-chloro-6-cyano-4-[1,2,2,3,3,3-hexafluoro-1-(trifluoromethyl)propyl]phenyl]carbamoyl]-2-cyano-phenyl]-4-cyano-2-methyl-benzamide; M.UN.11.1) N-[5-[[2-bromo-6-chloro-4-[2,2,2-trifluoro-1-hydroxy-1-(trifluoromethyl)ethyl]phenyl]carbamoyl]-2-cyano-phenyl]-4-cyano-2-methyl-benzamide; M.UN.11.m) N-[5-[[2-bromo-6-chloro-4-[1,2,2,3,3,3-hexafluoro-1-(trifluoromethyl)propyl]phenyl]carbamoyl]-2-cyano-phenyl]-4-cyano-2-methyl-benzamide; M.UN.11.n) 4-cyano-N-[2-cyano-5-[[2,6-dichloro-4-[1,2,2,3,3,3-hexafluoro-1-(trifluoromethyl)propyl]phenyl]carbamoyl]phenyl]-2-methyl-benzamide; M.UN.11.o) 4-cyano-N-[2-cyano-5-[[2,6-dichloro-4-[1,2,2,2-tetrafluoro-1-(trifluoromethyl)ethyl]phenyl]carbamoyl]phenyl]-2-methyl-benzamide; M.UN.11.p) N-[5-[[2-bromo-6-chloro-4-[1,2,2,2-tetrafluoro-1-(trifluoromethyl)ethyl]phenyl]carbamoyl]-2-cyano-phenyl]-4-cyano-2-methyl-benzamide; or

M.UN.12.a) 2-(1,3-Dioxan-2-yl)-6-[2-(3-pyridinyl)-5-thiazolyl]-pyridine; M.UN.12.b) 2-[6-[2-(5-Fluoro-3-pyridinyl)-5-thiazolyl]-2-pyridinyl]-pyrimidine; M.UN.12.c) 2-[6-[2-(3-Pyridinyl)-5-thiazolyl]-2-pyridinyl]-pyrimidine; M.UN.12.d) N-Methylsulfonyl-6-[2-(3-pyridyl)thiazol-5-yl]pyridine-2-carboxamide; M.UN.12.e) N-Methylsulfonyl-6-[2-(3-pyridyl)thiazol-5-yl]pyridine-2-carboxamide; M.UN.12.f) N-Ethyl-N-[4-methyl-2-(3-pyridyl)thiazol-5-yl]-3-methylthio-propanamide; M.UN.12.g) N-Methyl-N-[4-methyl-2-(3-pyridyl)thiazol-5-yl]-3-methylthio-propanamide; M.UN.12.h) N,2-Dimethyl-N-[4-methyl-2-(3-pyridyl)thiazol-5-yl]-3-methylthio-propanamide; M.UN.12.i) N-Ethyl-2-methyl-N-[4-methyl-2-(3-pyridyl)thiazol-5-yl]-3-methylthio-propanamide; M.UN.12.j) N-[4-Chloro-2-(3-pyridyl)thiazol-5-yl]-N-ethyl-2-methyl-3-methylthio-propanamide; M.UN.12.k) N-[4-Chloro-2-(3-pyridyl)thiazol-5-yl]-N,2-dimethyl-3-methylthio-propanamide; M.UN.12.1) N-[4-Chloro-2-(3-pyridyl)thiazol-5-yl]-N-methyl-3-methylthio-propanamide; M.UN.12.m) N-[4-Chloro-2-(3-pyridyl)thiazol-5-yl]-N-ethyl-3-methylthio-propanamide;

M.UN.14a) 1-[(6-Chloro-3-pyridinyl)methyl]-1,2,3,5,6,7-hexahydro-5-methoxy-7-methyl-8-nitro-imidazo[1,2-a]pyridine; or M.UN.14b) 1-[(6-Chloropyridin-3-yl)methyl]-7-methyl-8-nitro-1,2,3,5,6,7-hexahydroimidazo[1,2-a]pyridin-5-ol;

M.UN.16a) 1-isopropyl-N,5-dimethyl-N-pyridazin-4-yl-pyrazole-4-carboxamide; or M.UN.16b) 1-(1,2-dimethylpropyl)-N-ethyl-5-methyl-N-pyridazin-4-yl-pyrazole-4-carboxamide; M.UN.16c) N,5-dimethyl-N-pyridazin-4-yl-1-(2,2,2-trifluoro-1-methyl-ethyl)pyrazole-4-carboxamide; M.UN.16d) 1-[1-(1-cyanocyclopropyl)ethyl]-N-ethyl-5-methyl-N-pyridazin-4-yl-pyrazole-4-carboxamide; M.UN.16e) N-ethyl-1-(2-fluoro-1-methyl-propyl)-5-methyl-N-pyridazin-4-yl-pyrazole-4-carboxamide; M.UN.16f) 1-(1,2-dimethylpropyl)-N,5-dimethyl-N-pyridazin-4-yl-pyrazole-4-carboxamide; M.UN.16g) 1-[1-(1-cyanocyclopropyl)ethyl]-N,5-dimethyl-N-pyridazin-4-yl-pyrazole-4-carboxamide; M.UN.16h) N-methyl-1-(2-fluoro-1-methyl-propyl]-5-methyl-N-pyridazin-4-yl-pyrazole-4-carboxamide; M.UN.16i) 1-(4,4-difluorocyclohexyl)-N-ethyl-5-methyl-N-pyridazin-4-yl-pyrazole-4-carboxamide; or M.UN.16j) 1-(4,4-difluorocyclohexyl)-N,5-dimethyl-N-pyridazin-4-yl-pyrazole-4-carboxamide,

M.UN.17a) N-(1-methylethyl)-2-(3-pyridinyl)-2H-indazole-4-carboxamide; M.UN.17b) N-cyclopropyl-2-(3-pyridinyl)-2H-indazole-4-carboxamide; M.UN.17c) N-cyclohexyl-2-(3-pyridinyl)-2H-indazole-4-carboxamide; M.UN.17d) 2-(3-pyridinyl)-N-(2,2,2-trifluoroethyl)-2H-indazole-4-carboxamide; M.UN.17e) 2-(3-pyridinyl)-N-[(tetrahydro-2-furanyl)methyl]-2H-indazole-5-carboxamide; M.UN.17f) methyl 2-[[2-(3-pyridinyl)-2H-indazol-5-yl]carbonyl]hydrazinecarboxylate; M.UN.17g) N-[(2,2-difluorocyclopropyl)methyl]-2-(3-pyridinyl)-2H-indazole-5-carboxamide; M.UN.17h) N-(2,2-difluoropropyl)-2-(3-pyridinyl)-2H-indazole-5-carboxamide; M.UN.17i) 2-(3-pyridinyl)-N-(2-pyrimidinylmethyl)-2H-indazole-5-carboxamide; M.UN.17j) N-[(5-methyl-2-pyrazinyl)methyl]-2-(3-pyridinyl)-2H-indazole-5-carboxamide,

M.UN.18a) N-[3-chloro-1-(3-pyridyl)pyrazol-4-yl]-N-ethyl-3-(3,3,3-trifluoropropylsulfanyl)propanamide; M.UN.18b) N-[3-chloro-1-(3-pyridyl)pyrazol-4-yl]-N-ethyl-3-(3,3,3-trifluoropropylsulfinyl)propanamide; M.UN.18c) N-[3-chloro-1-(3-pyridyl)pyrazol-4-yl]-3-[(2,2-difluorocyclopropyl)methylsulfanyl]-N-ethyl-propanamide; M.UN.18d) N-[3-chloro-1-(3-pyridyl)pyrazol-4-yl]-3-[(2,2-difluorocyclopropyl)methylsulfinyl]-N-ethyl-propanamide;

M.UN.19 sarolaner, M.UN.20 lotilaner;

M.UN.21 N-[4-Chloro-3-[[(phenylmethyl)amino]carbonyl]phenyl]-1-methyl-3-(1,1,2,2,2-pentafluoroethyl)-4-(trifluoromethyl)-1H-pyrazole-5-carboxamide; M.UN.22a 2-(3-ethylsulfonyl-2-pyridyl)-3-methyl-6-(trifluoromethyl)imidazo[4,5-b]pyridine, or M.UN.22b 2-[3-ethylsulfonyl-5-(trifluoromethyl)-2-pyridyl]-3-methyl-6-(trifluoromethyl)imidazo[4,5-b]pyridine;

M.UN.23a 4-[5-(3,5-dichlorophenyl)-5-(trifluoromethyl)-4H-isoxazol-3-yl]-N-[(4R)-2-ethyl-3-oxoisoxazolidin-4-yl]-2-methyl-benzamide, or M.UN.23b 4-[5-(3,5-dichloro-4-fluoro-phenyl)-5-(trifluoromethyl)-4H-isoxazol-3-yl]-N-[(4R)-2-ethyl-3-oxo-isoxazolidin-4-yl]-2-methyl-benzamide;

M.UN.24a) N-[4-chloro-3-(cyclopropylcarbamoyl)phenyl]-2-methyl-5-(1,1,2,2,2-pentafluoroethyl)-4-(trifluoromethyl)pyrazole-3-carboxamide or M.UN.24b) N-[4-chloro-3-[(1-cyanocyclopropyl)carbamoyl]phenyl]-2-methyl-5-(1,1,2,2,2-pentafluoroethyl)-4-(trifluoromethyl)pyrazole-3-carboxamide; M.UN.25 acynonapyr; M.UN.26 benzpyrimoxan; M.UN.272-chloro-N-(1-cyanocyclopropyl)-5-[1-[2-methyl-5-(1,1,2,2,2-pentafluoroethyl)-4-(trifluoromethyl)pyrazol-3-yl]pyrazol-4-yl]benzamide; M.UN.28 oxazosulfyl (2-(3-ethylsulfonyl-2-pyridyl)-5-(trifluoromethylsulfonyl)-1,3-benzoxazole); M.UN.29 Tetrachlorantraniliprole; M.UN.30 Tyclopyrazoflor;

A) Respiration Inhibitors
Inhibitors of complex Ill at Qo site: azoxystrobin (A.1.1), coumethoxystrobin (A.1.2), coumoxystrobin (A.1.3), dimoxystrobin (A.1.4), enestroburin (A.1.5), fenaminstrobin (A.1.6), fenoxystrobin/flufenoxystrobin (A.1.7), fluoxastrobin (A.1.8), kresoxim-methyl (A.1.9), mandestrobin (A.1.10), metominostrobin (A.1.11), orysastrobin (A.1.12), picoxystrobin (A.1.13), pyraclostrobin (A.1.14), pyrametostrobin (A.1.15), pyraoxystrobin (A.1.16), trifloxystrobin (A.1.17), 2 (2-(3-(2,6-dichlorophenyl)-1-methyl-allylideneaminooxymethyl)-phenyl)-2 methoxyimino-N methyl-acetamide (A.1.18), pyribencarb (A.1.19), triclopyricarb/chlorodincarb (A.1.20), famoxadone (A.1.21), fenamidone (A.1.21), methyl-N-[2-[(1,4-dimethyl-5 phenyl-pyrazol-3-yl)oxylmethyl]phenyl]-N-methoxy-carbamate (A.1.22), 1-[3-chloro-2 [[1 (4-chlorophenyl)-1H-pyrazol-3-yl]oxymethyl]phenyl]-4-methyl-tetrazol-5-one (A.1.23), 1-[3-bromo-2-[[1-(4-chlorophenyl)pyrazol-3-yl]oxymethyl]phenyl]-4-methyl-tetrazol-5-one (A.1.24), 1-[2-[[1-(4-chlorophenyl)pyrazol-3-yl]oxymethyl]-3-methyl-phenyl]-4-methyl-tetrazol-5-one (A.1.25), 1-[2-[[1-(4-chlorophenyl)pyrazol-3-yl]oxymethyl]-3-fluoro-phenyl]-4-methyl-tetrazol-5-one (A.1.26), 1-[2-[[1-(2,4-dichlorophenyl)pyrazol-3-yl]oxymethyl]-3-fluoro-phenyl]-4-methyl-tetrazol-5-one (A.1.27), 1-[3-cyclopropyl-2-[[2-methyl-4 (1 methylpyrazol-3-yl)phenoxy]methyl]phenyl]-4 methyltetrazol-5-one (A.1.30), 1 [3 (difluoromethoxy)-2-[[2-methyl-4-(1 methylpyrazol-3 yl)phenoxy]methyl]phenyl]-4 methyl-tetrazol-5-one (A.1.31), 1-methyl-4-[3-methyl-2 [[2 methyl-4-(1-methylpyrazol-3 yl)phenoxy]methyl]phenyl]tetrazol-5-one (A.1.32), (Z,2E)-5-[1-(2,4-dichlorophenyl)pyrazol-3-yl]-oxy-2-methoxyimino-N,3-dimethyl-pent-3-enamide (A.1.34), (Z,2E) 5 [1 (4-chlorophenyl)pyrazol-3-yl]oxy-2-methoxyimino-N,3-dimethyl-pent-3-enamide (A.1.35), pyriminostrobin (A.1.36), bifujunzhi (A.1.37), 2-(ortho-((2,5-dimethylphenyl-oxymethylen)phenyl)-3-methoxy-acrylic acid methylester (A.1.38);
inhibitors of complex Ill at Qi site: cyazofamid (A.2.1), amisulbrom (A.2.2), [(6S,7R,8R) 8 benzyl-3-[(3-hydroxy-4-methoxy-pyridine-2-carbonyl)amino]-6-methyl-4,9-dioxo-1,5-dioxonan-7-yl] 2-methylpropanoate (A.2.3), fenpicoxamid (A.2.4);
inhibitors of complex II: benodanil (A.3.1), benzovindiflupyr (A.3.2), bixafen (A.3.3), boscalid (A.3.4), carboxin (A.3.5), fenfuram (A.3.6), fluopyram (A.3.7), flutolanil (A.3.8), fluxapyroxad (A.3.9), furametpyr (A.3.10), isofetamid (A.3.11), isopyrazam (A.3.12), mepronil (A.3.13), oxycarboxin (A.3.14), penflufen (A.3.15), penthiopyrad (A.3.16), pydiflumetofen (A.3.17), pyraziflumid (A.3.18), sedaxane (A.3.19), tecloftalam (A.3.20), thifluzamide (A.3.21), 3 (difluoromethyl)-1-methyl-N-(1,1,3-trimethylindan-4-yl)pyrazole-4 carboxamide (A.3.22), 3 (trifluoromethyl)-1-methyl-N-(1,1,3-trimethylindan-4-yl)pyrazole-4 carboxamide (A.3.23), 1,3-dimethyl-N-(1,1,3-trimethylindan-4-yl)pyrazole-4-carboxamide (A.3.24), 3-(trifluoromethyl)-1,5 dimethyl-N-(1,1,3-trimethylindan-4-yl)pyrazole-4-carboxamide (A.3.25), 1,3,5-trimethyl-N-(1,1,3-trimethylindan-4-yl)pyrazole-4-carboxamide (A.3.26), 3-(difluoromethyl)-1,5 dimethyl-N-(1,1,3-trimethylindan-4-yl)pyrazole-4-carboxamide (A.3.27), 3-(difluoromethyl)-N (7 fluoro-1,1,3-trimethyl-indan-4-yl)-1-methyl-pyrazole-4-carboxamide (A.3.28), N-[(5-chloro-2-isopropyl-phenyl)methyl]-N-cyclopropyl-5-fluoro-1,3-dimethyl-pyrazole-4-carboxamide (A.3.29), methyl (E)-2-[2-[(5-cyano-2-methylphenoxy)methyl]phenyl]-3-methoxy-prop-2 enoate (A.3.30), N-[(5-chloro-2-isopropylphenyl)methyl]-N-cyclopropyl-3-(difluoromethyl)-5 fluoro-1-methyl-pyrazole-4-carboxamide (A.3.31), 2-(difluoromethyl)-N-(1,1,3-trimethyl-indan-4-yl)pyridine-3-carboxamide (A.3.32), 2-(difluoromethyl)-N-[(3R)-1,1,3-trimethylindan-4-yl]pyridine-3-carboxamide (A.3.33), 2-(difluoromethyl)-N-(3-ethyl-1,1-dimethyl-indan-4-yl)pyridine-3-carboxamide (A.3.34), 2-(difluoromethyl)-N-[(3R)-3-ethyl-1,1-dimethyl-indan-4-yl]pyridine-3-carboxamide (A.3.35), 2-(difluoromethyl)-N-(1,1-dimethyl-3-propyl-indan-4-yl)pyridine-3-carboxamide (A.3.36), 2-(difluoromethyl)-N-[(3R)-1,1-dimethyl-3-propyl-indan-4-yl]pyridine-3-carboxamide (A.3.37), 2-(difluoromethyl)-N-(3-isobutyl-1,1-dimethyl-indan-4-yl)pyridine-3-carboxamide (A.3.38), 2-(difluoromethyl)-N-[(3R)-3-isobutyl-1,1-dimethyl-indan-4 yl]pyridine-3-carboxamide (A.3.39);
other respiration inhibitors: diflumetorim (A.4.1); nitrophenyl derivates: binapacryl (A.4.2), dinobuton (A.4.3), dinocap (A.4.4), fluazinam (A.4.5), meptyldinocap (A.4.6), ferimzone (A.4.7); organometal compounds: fentin salts, e. g. fentin-acetate (A.4.8), fentin chloride (A.4.9) or fentin hydroxide (A.4.10); ametoctradin (A.4.11); silthiofam (A.4.12);

B) Sterol Biosynthesis Inhibitors (SBI Fungicides)
C14 demethylase inhibitors: triazoles: azaconazole (B.1.1), bitertanol (B.1.2), bromuconazole (B.1.3), cyproconazole (B.1.4), difenoconazole (B.1.5), diniconazole (B.1.6), diniconazole-M (B.1.7), epoxiconazole (B.1.8), fenbuconazole (B.1.9), fluquinconazole (B.1.10), flusilazole (B.1.11), flutriafol (B.1.12), hexaconazole (B.1.13), imibenconazole (B.1.14), ipconazole (B.1.15), metconazole (B.1.17), myclobutanil (B.1.18), oxpoconazole (B.1.19), paclobutrazole (B.1.20), penconazole (B.1.21), propiconazole (B.1.22), prothioconazole (B.1.23), simeconazole (B.1.24), tebuconazole (B.1.25), tetraconazole (B.1.26), triadimefon (B.1.27), triadimenol (B.1.28), triticonazole (B.1.29), uniconazole (B.1.30), ipfentrifluconazole, (B.1.37), mefentrifluconazole (B.1.38), 2-(chloromethyl)-2-methyl-5-(p-tolylmethyl)-1 (1,2,4-triazol-1-ylmethyl)cyclopentanol (B.1.43); imidazoles: imazalil (B.1.44), pefurazoate (B.1.45), prochloraz (B.1.46), triflumizol (B.1.47); pyrimidines, pyridines and piperazines: fenarimol (B.1.49), pyrifenox (B.1.50), triforine (B.1.51), [3-(4-chloro-2-fluoro-phenyl)-5-(2,4-difluorophenyl)isoxazol-4-yl]-(3-pyridyl)methanol (B.1.52);
Delta14-reductase inhibitors: aldimorph (B.2.1), dodemorph (B.2.2), dodemorph-acetate (B.2.3), fenpropimorph (B.2.4), tridemorph (B.2.5), fenpropidin (B.2.6), piperalin (B.2.7), spiroxamine (B.2.8);
Inhibitors of 3-keto reductase: fenhexamid (B.3.1);
Other Sterol biosynthesis inhibitors: chlorphenomizole (B.4.1);

C) Nucleic Acid Synthesis Inhibitors
phenylamides or acyl amino acid fungicides: benalaxyl (C.1.1), benalaxyl-M (C.1.2), kiralaxyl (C.1.3), metalaxyl (C.1.4), metalaxyl-M (C.1.5), ofurace (C.1.6), oxadixyl (C.1.7);
other nucleic acid synthesis inhibitors: hymexazole (C.2.1), octhilinone (C.2.2), oxolinic acid (C.2.3), bupirimate (C.2.4), 5-fluorocytosine (C.2.5), 5-fluoro-2-(p-tolylmethoxy)pyrimidin-4 amine (C.2.6), 5-fluoro-2-(4-fluorophenylmethoxy)pyrimidin-4 amine (C.2.7), 5-fluoro-2 (4 chlorophenylmethoxy)pyrimidin-4 amine (C.2.8);

D) Inhibitors of Cell Division and Cytoskeleton
tubulin inhibitors: benomyl (D.1.1), carbendazim (D.1.2), fuberidazole (D1.3), thiabendazole (D.1.4), thiophanate-methyl (D.1.5), 3-chloro-4-(2,6-difluorophenyl)-6-methyl-5-phenylpyridazine (D.1.6), 3-chloro-6-methyl-5-phenyl-4-(2,4,6-trifluorophenyl)pyridazine (D.1.7), N ethyl-2-[(3-ethynyl-8-methyl-6-quinolyl)oxy]butanamide (D.1.8), N-ethyl-2-[(3-ethynyl-8 methyl-6 quinolyl)oxy]-2-methylsulfanyl-acetamide (D.1.9), 2-[(3-ethynyl-8-methyl-6-quinolyl)oxy]-N (2-fluoroethyl)butanamide (D.1.10), 2-[(3-ethynyl-8-methyl-6-quinolyl)oxy]-N-(2-fluoroethyl)-2-methoxy-acetamide (D.1.11), 2-[(3-ethynyl-8-methyl-6-quinolyl)oxy]-N-propylbutanamide (D.1.12), 2-[(3-ethynyl-8-methyl-6-quinolyl)oxy]-2-methoxy-N-propyl-acetamide (D.1.13), 2-[(3-ethynyl-8-methyl-6-quinolyl)oxy]-2-methylsulfanyl-N-propyl-acetamide (D.1.14), 2 [(3 ethynyl-8-methyl-6-quinolyl)oxy]-N-(2-fluoroethyl)-2-methylsulfanyl-acetamide (D.1.15), 4-(2-bromo-4-fluoro-phenyl)-N-(2-chloro-6-fluoro-phenyl)-2,5-dimethyl-pyrazol-3 amine (D.1.16);
other cell division inhibitors: diethofencarb (D.2.1), ethaboxam (D.2.2), pencycuron (D.2.3), fluopicolide (D.2.4), zoxamide (D.2.5), metrafenone (D.2.6), pyriofenone (D.2.7);

E) Inhibitors of Amino Acid and Protein Synthesis
methionine synthesis inhibitors: cyprodinil (E.1.1), mepanipyrim (E.1.2), pyrimethanil (E.1.3);
protein synthesis inhibitors: blasticidin-S (E.2.1), kasugamycin (E.2.2), kasugamycin hydrochloride-hydrate (E.2.3), mildiomycin (E.2.4), streptomycin (E.2.5), oxytetracyclin (E.2.6);

F) Signal Transduction Inhibitors
MAP/histidine kinase inhibitors: fluoroimid (F.1.1), iprodione (F.1.2), procymidone (F.1.3), vinclozolin (F.1.4), fludioxonil (F.1.5);
G protein inhibitors: quinoxyfen (F.2.1);

G) Lipid and Membrane Synthesis Inhibitors
Phospholipid biosynthesis inhibitors: edifenphos (G.1.1), iprobenfos (G.1.2), pyrazophos (G.1.3), isoprothiolane (G.1.4);
lipid peroxidation: dicloran (G.2.1), quintozene (G.2.2), tecnazene (G.2.3), tolclofos-methyl (G.2.4), biphenyl (G.2.5), chloroneb (G.2.6), etridiazole (G.2.7);
phospholipid biosynthesis and cell wall deposition: dimethomorph (G.3.1), flumorph (G.3.2), mandipropamid (G.3.3), pyrimorph (G.3.4), benthiavalicarb (G.3.5), iprovalicarb (G.3.6), valifenalate (G.3.7);
compounds affecting cell membrane permeability and fatty acides: propamocarb (G.4.1);
inhibitors of oxysterol binding protein: oxathiapiprolin (G.5.1), 2-{3-[2-(1-{[3,5-bis(difluoromethyl-1H-pyrazol-1-yl]acetyl}piperidin-4-yl)-1,3-thiazol-4-yl]-4,5-dihydro-1,2 oxazol-5-yl}phenyl methanesulfonate (G.5.2), 2-{3-[2-(1-{[3,5-bis(difluoromethyl)-1H-pyrazol-1-yl]acetyl}piperidin-4-yl) 1,3-thiazol-4-yl]-4,5-dihydro-1,2-oxazol-5 yl}-3-chlorophenyl methanesulfonate (G.5.3), 4-[1-[2-[3-(difluoromethyl)-5-methyl-pyrazol-1-yl]acetyl]-4-piperidyl]-N-tetralin-1-yl-pyridine-2-carboxamide (G.5.4), 4-[1-[2-[3,5-bis(difluoromethyl)pyrazol-1-yl]acetyl]-4-piperidyl]-N-tetralin-1-yl-pyridine-2-carboxamide (G.5.5), 4-[1-[2-[3-(difluoromethyl)-5-(trifluoromethyl)pyrazol-1-yl]acetyl]-4-piperidyl]-N-tetralin-1-yl-pyridine-2-carboxamide (G.5.6), 4-[1-[2-[5-cyclopropyl-3-(difluoromethyl)pyrazol-1-yl]acetyl]-4-piperidyl]-N-tetralin-1-yl-pyridine-2-carboxamide (G.5.7), 4-[1-[2-[5-methyl-3-(trifluoromethyl)pyrazol-1-yl]acetyl]-4-piperidyl]-N-tetralin-1-yl-pyridine-2-carboxamide (G.5.8), 4-[1-[2-[5-(difluoromethyl)-3-(trifluoromethyl)pyrazol-1-yl]acetyl]-4-piperidyl]-N-tetralin-1-yl-pyridine-2-carboxamide (G.5.9), 4 [1 [2-[3,5-bis(trifluoromethyl)pyrazol-1-yl]acetyl]-4-piperidyl]-N-tetralin-1-yl-pyridine-2-carboxamide (G.5.10), (4-[1-[2-[5-cyclopropyl-3-(trifluoromethyl)pyrazol-1-yl]acetyl]-4-piperidyl]-N-tetralin-1-yl-pyridine-2-carboxamide (G.5.11);

H) Inhibitors with Multi Site Action
inorganic active substances: Bordeaux mixture (H.1.1), copper (H.1.2), copper acetate (H.1.3), copper hydroxide (H.1.4), copper oxychloride (H.1.5), basic copper sulfate (H.1.6), sulfur (H.1.7);
thio- and dithiocarbamates: ferbam (H.2.1), mancozeb (H.2.2), maneb (H.2.3), metam (H.2.4), metiram (H.2.5), propineb (H.2.6), thiram (H.2.7), zineb (H.2.8), ziram (H.2.9);
organochlorine compounds: anilazine (H.3.1), chlorothalonil (H.3.2), captafol (H.3.3), captan (H.3.4), folpet (H.3.5), dichlofluanid (H.3.6), dichlorophen (H.3.7), hexachlorobenzene (H.3.8), pentachlorphenole (H.3.9) and its salts, phthalide (H.3.10), tolylfluanid (H.3.11);
guanidines and others: guanidine (H.4.1), dodine (H.4.2), dodine free base (H.4.3), guazatine (H.4.4), guazatine-acetate (H.4.5), iminoctadine (H.4.6), iminoctadine-triacetate (H.4.7), iminoctadine-tris(albesilate) (H.4.8), dithianon (H.4.9), 2,6-dimethyl-1H,5H-[1,4]dithiino[2,3-c:5,6-c′]dipyrrole-1,3,5,7(2H,6H)-tetraone (H.4.10);

I) Cell Wall Synthesis Inhibitors
inhibitors of glucan synthesis: validamycin (1.1.1), polyoxin B (1.1.2);
melanin synthesis inhibitors: pyroquilon (1.2.1), tricyclazole (1.2.2), carpropamid (1.2.3), dicyclomet (1.2.4), fenoxanil (1.2.5);

J) Plant Defense Inducers
acibenzolar-S-methyl (J.1.1), probenazole (J.1.2), isotianil (J.1.3), tiadinil (J.1.4), prohexadione-calcium (J.1.5); phosphonates: fosetyl (J.1.6), fosetyl-aluminum (J.1.7), phosphorous acid and its salts (J.1.8), calcium phosphonate (J.1.11), potassium phosphonate (J.1.12), potassium or sodium bicarbonate (J.1.9), 4 cyclopropyl-N-(2,4-dimethoxyphenyl)thiadiazole-5-carboxamide (J.1.10);

K) Unknown Mode of Action
bronopol (K.1.1), chinomethionat (K.1.2), cyflufenamid (K.1.3), cymoxanil (K.1.4), dazomet (K.1.5), debacarb (K.1.6), diclocymet (K.1.7), diclomezine (K.1.8), difenzoquat (K.1.9), difenzoquat-methylsulfate (K.1.10), diphenylamin (K.1.11), fenitropan (K.1.12), fenpyrazamine (K.1.13), flumetover (K.1.14), flusulfamide (K.1.15), flutianil (K.1.16), harpin (K.1.17), metha-sulfocarb (K.1.18), nitrapyrin (K.1.19), nitrothal-isopropyl (K.1.20), tolprocarb (K.1.21), oxin-copper (K.1.22), proquinazid (K.1.23), tebufloquin (K.1.24), tecloftalam (K.1.25), triazoxide (K.1.26), N′(4-(4-chloro-3-trifluoromethyl-phenoxy)-2,5-dimethyl-phenyl)-N-ethyl-N methyl formamidine (K.1.27), N′ (4-(4-fluoro-3-trifluoromethyl-phenoxy)-2,5-dimethyl-phenyl)-N-ethyl-N-methyl formamidine (K.1.28), N′-[4-[[3-[(4-chlorophenyl)methyl]-1,2,4-thiadiazol-5-yl]oxy]-2,5-dimethyl-phenyl]-N-ethyl-N-methyl-formamidine (K.1.29), N′-(5-bromo-6-indan-2-yloxy-2-methyl-3-pyridyl)-N-ethyl-N-methyl-formamidine (K.1.30), N′-[5-bromo-6-[1-(3,5-difluorophenyl)ethoxy]-2-methyl-3-pyridyl]-N-ethyl-N-methyl-formamidine (K.1.31), N′-[5-bromo-6-(4-isopropylcyclohexoxy)-2-methyl-3-pyridyl]-N-ethyl-N-methyl-formamidine (K.1.32), N′ [5 bromo-2-methyl-6-(1-phenylethoxy)-3-pyridyl]-N-ethyl-N-methyl-formamidine (K.1.33), N′-(2-methyl-5-trifluoromethyl-4-(3-trimethylsilanyl-propoxy)-phenyl)-N-ethyl-N-methyl formamidine (K.1.34), N′(5-difluoromethyl-2 methyl-4-(3-trimethylsilanyl-propoxy)-phenyl)-N-ethyl-N-methyl formamidine (K.1.35), 2-(4-chloro-phenyl)-N-[4-(3,4-dimethoxy-phenyl)-isoxazol-5 yl]-2-prop-2-ynyloxy-acetamide (K.1.36), 3 [5-(4-chloro-phenyl)-2,3-dimethyl-isoxazolidin-3-yl]-pyridine (pyrisoxazole) (K.1.37), 3-[5-(4-methylphenyl)-2,3-dimethyl-isoxazolidin-3 yl]-pyridine (K.1.38), 5-chloro-1 (4,6-dimethoxy-pyrimidin-2-yl)-2-methyl-1H-benzoimidazole (K.1.39), ethyl (Z) 3 amino-2-cyano-3-phenyl-prop-2-enoate (K.1.40), picarbutrazox (K.1.41), pentyl N-[6-[[(Z)-[(1-methyltetrazol-5-yl)phenyl-methylene]amino]oxymethyl]-2-pyridyl]carbamate (K.1.42), but-3-ynyl N-[6-[[(Z)-[(1-methyltetrazol-5-yl)-phenyl-methylene]amino]oxymethyl]-2-pyridyl]carbamate (K.1.43), 2-[2-[(7,8-difluoro-2-methyl-3-quinolyl)oxy]-6-fluoro-phenyl]propan-2-ol (K.1.44), 2-[2-fluoro-6-[(8-fluoro-2-methyl-3-quinolyl)oxy]phen-yl]propan-2-ol (K.1.45), quinofumelin (K.1.47), 9-fluoro-2,2-dimethyl-5-(3-quinolyl)-3H 1,4 benzoxazepine (K.1.49), 2-(6-benzyl-2-pyridyl)quinazoline (K.1.50), 2-[6-(3-fluoro-4 methoxy-phenyl)-5-methyl-2-pyridyl]quinazoline (K.1.51), dichlobentiazox (K.1.52), N′-(2,5-dimethyl-4-phenoxy-phenyl)-N-ethyl-N-methyl-formamidine (K.1.53); dipymetitrone, isoflucypram; fluindapyr, inpyrfluxam, pyrifenamine.

The commercially available compounds of the mixing partners listed above may be found in The Pesticide Manual, 17th Edition, C. MacBean, British Crop Protection Council (2015) among other publications. The online Pesticide Manual is updated regularly and is accessible through http://bcpcdata.com/pesticide-manual.html.

Another online data base for pesticides providing the ISO common names is http://www.alanwood.net/pesticides.

The M.4 cycloxaprid is known from WO2010/069266 and WO2011/069456. M.4A.1 is known from CN 103814937; CN105367557, CN 105481839. M.4A.2, guadipyr, is known from WO 102013/003977, and M.4A.3 (approved as paichongding in China) is known from WO 2007/101369. M.22B.1 is described in CN10171577 and M.22B.2 in CN102126994. Spiropidion M.23.1 is known from WO 2014/191271. M.28.1 and M.28.2 are known from WO2007/101540. M.28.3 is described in WO2005/077934. M.28.4 is described in WO2007/043677. M.28.5a) to M.28.5d) and M.28.5h) are described in WO 2007/006670, WO2013/024009 and WO 2013/024010, M.28.5i) is described in WO2011/085575, M.28.5j) in WO2008/134969, M.28.5k) in US2011/046186 and M.28.5l) in WO2012/034403. M.28.6 can be found in WO2012/034472. M.UN.3 is known from WO2006/089633 and M.UN.4 from WO2008/067911. M.UN.5 is described in WO2006/043635, and biological control agents on the basis of Bacillus firmus are described in WO2009/124707. Flupyrimin is described in WO2012/029672. M.UN.8 is known from WO2013/055584. M.UN.9.a) is described in WO2013/050317. M.UN.9.b) is described in WO2014/126208. M.UN.10 is known from WO2010/060379. Broflanilide and M.UN.11.b) to M.UN.11.h) are described in WO2010/018714, and M.UN.11i) to M.UN.11.p) in WO 2010/127926. M.UN.12.a) to M.UN.12.c) are known from WO2010/006713, M.UN.12.d) and M.UN.12.e) are known from WO2012/000896, and M.UN.12.f) to M.UN.12.m) from WO 2010/129497. M.UN.14a) and M.UN.14b) are known from WO2007/101369. M.UN.16.a) to M.UN.16h) are described in WO2010/034737, WO2012/084670, and WO2012/143317, resp., and M.UN.16i) and M.UN.16j) are described in WO2015/055497. M.UN.17a) to M.UN.17.j) are described in WO2015/038503. M.UN.18a) to M.UN.18d) are described in US2014/0213448. M.UN.19 is described in WO2014/036056. M.UN.20 is known from WO2014/090918. M.UN.21 is known from EP2910126. M.UN.22a and M.UN.22b are known from WO2015/059039 and WO2015/190316. M.UN.23a and M.UN.23b are known from WO2013/050302. M.UN.24a and M.UN.24b are known from WO2012/126766. Acynonapyr M.UN.25 is known from WO 2011/105506. Benzpyrimoxan M.UN.26 is known from WO2016/104516. M.UN.27 is known from WO2016174049. The compound M.29.28 is known from WO2017104592. The compound M.29.29 (CAS number-1104384-14-6) and its pesticidal action is known from CN101333213, WO20103350. The compound M.29.30 (CAS number-1477919-27-9) and its pesticidal action is known from WO201S/125S20.

The fungicides described by IUPAC nomenclature, their preparation and their pesticidal activity is also known (cf. Can. J. Plant Sci. 48(6), 587-94, 1968; EP-A 141317; EP-A 152031; EP-A 226917; EP-A 243970; EP-A 256503; EP-A 428941; EP-A 532022; EP-A 1028125; EP-A 1035122; EP-A 1201648; EP-A 1122244, JP 2002316902; DE 19650197; DE 10021412; DE 102005009458; U.S. Pat. Nos. 3,296,272; 3,325,503; WO 98/46608; WO 99/14187; WO 99/24413; WO 99/27783; WO 00/29404; WO 00/46148; WO 00/65913; WO 01/54501; WO 01/56358; WO 02/22583; WO 02/40431; WO 03/10149; WO 03/11853; WO 03/14103; WO 03/16286; WO 03/53145; WO 03/61388; WO 03/66609; WO 03/74491; WO 04/49804; WO 04/83193; WO 05/120234; WO 05/123689; WO 05/123690; WO 05/63721; WO 05/87772; WO 05/87773; WO 06/15866; WO 06/87325; WO 06/87343; WO 07/82098; WO 07/90624, WO 10/139271, WO 11/028657, WO2012/168188, WO 2007/006670, WO 2011/77514; WO13/047749, WO 10/069882, WO 13/047441, WO 03/16303, WO 09/90181, WO 13/007767, WO 13/010862, WO 13/127704, WO 13/024009, WO 13/024010 and WO 13/047441, WO 13/162072, WO 13/092224, WO 11/135833), CN 1907024, CN 1456054, CN 103387541, CN 1309897, WO 12/84812, CN 1907024, WO 09094442, WO 14/60177, WO 13/116251, WO 08/013622, WO 15/65922, WO 94/01546, EP 2865265, WO 07/129454, WO 12/165511, WO 11/081174, WO 13/47441).

In a further embodiment, the invention relates to mixtures comprising a compound of formula (I) as described above, in particular the compound I-R-1, and at least one compound II which is metaaldehyde, in particular granular metaaldehyde.

The present invention relates to a mixture of at least one compound I or non-racemic compound of formula (I) or compound of formula (I) with enantiomeric excess of compound I-R-1, or the compound I-R-1, of the present invention as component I with at least one mixing partner II as defined above. In one embodiment, the invention relates to binary mixtures of one components I with one mixing partner II as defined above as component II.

Preferred weight ratios for such binary mixtures are from 10000:1 to 1:10000, preferably from 7000:1 to 1:7000, also preferably from 5000:1 to 1:5000, also preferably from 1000:1 to 1:1000, more preferably from 100:1 to 1:100, also more preferably from 70:1 to 1:70, particularly preferably from 25:1 to 1:25, also particularly preferably from 10:1 to 1:10, also particularly preferably from 1:5 to 5:1. In such binary mixtures, components I and II may be used in equal amounts, or an excess of component I, or an excess of component may be used.

In the mixtures of the present invention, the ingredients may be used sequentially or in combination with each other, if appropriate also added only immediately prior to use (tank mix). For example, the plant(s) may be sprayed with compound either before or after being treated with component l.

In one embodiment of the invention, the mixtures of the present invention are mixtures of a compound of formula (I), preferably I-R-1, with a compound selected from the group of benomyl, carbendazim, epoxiconazole, fluquinconazole, flutriafol, flusilazole, metconazole, prochloraz, prothioconazole, tebuconazole, triticonazole, pyraclostrobin, trifloxystrobin, boscalid, dimethomorph, penthiopyrad, dodemorph, famoxadone, fenpropimorph, proquinazid, pyrimethanil, tridemorph, maneb, mancozeb, metiram, thiram, chlorothalonil, dithianon, flusulfamide, metrafenone, fluxapyroxad, bixafen, penflufen, sedaxane, isopyrazam, oxazosulfyl. Especially preferred is pyraclostrobin, oxazosulfyl, and fluxapyroxad.

In one embodiment of the invention, the mixtures of the present invention are mixtures of a compound of formula (I), preferably I-R-1, with a compound selected from the group of imidacloprid, clothianidin, dinotefuran, chlorantraniliprole, cyantraniliprole, spinetoram, spinosad, ethiprole, fipronil, triflumezopyrim, flonicamid, oxazosulfyl, and tetraniliprole.

In one embodiment of the invention, the mixtures of the present invention are mixtures of a compound of formula (I), preferably I-R-1, with a compound selected from the group of probenazole, isotianil, tricyclazole, pyroquilon, isoprothiolane, tolprocarb, carpropamid, diclocymet, azoxystrobin, oxazosulfyl, and orysastrobin.

In one embodiment of the invention, the mixtures of the present invention are mixtures of a compound of formula (I), preferably I-R-1, with a compound selected from the group of furametpyr, thifluzamide, simeconazole, penflufen, azoxystrobin, orysastrobin.

In one embodiment of the invention, the mixtures of the present invention are mixtures of a compound of formula (I), preferably I-R-1, with oxazosulfyl.

In one embodiment of the invention, the mixtures of the present invention are mixtures of a non-racemic compound of formula (I), preferably compound of formula (I) with enantiomeric excess of compound (I-R-1), preferably the compound I-R-1, with a compound selected from the group of M.2: GABA-gated chloride channel antagonists, M.3: Sodium channel modulators, M.4: Nicotinic acetylcholine receptor agonists, M.5: Nicotinic acetylcholine receptor allosteric activators, M.6:Chloride channel activators from the class of avermectins and milbemycins, M.9: Chordotonal organ TRPV channel modulators, M.13: Uncouplers of oxidative phosphorylation via disruption of the proton gradient, M.15: Inhibitors of the chitin biosynthesis type 0, M.16: Inhibitors of the chitin biosynthesis type, M.22: Voltage-dependent sodium channel blockers, M.23: Inhibitors of the of acetyl CoA carboxylase, M.28: Ryanodine receptor-modulators from the class of diamides, M.29:Chordotonal organ Modulators, M.UN.9.b, M.UN.16b, M.29.28, Respiration inhibitors: Inhibitors of complex Ill at Qo site, inhibitors of complex Ill at Qi site, inhibitors of complex II, Sterol biosynthesis inhibitors, Lipid and membrane synthesis inhibitors, Cell wall synthesis inhibitors preferably melanin synthesis inhibitors, Plant defense inducers, diclocymet (K.1.7), tolprocarb (K.1.21), and picarbutrazox (K.1.41).

In one embodiment of the invention, the mixtures of the present invention are mixtures of a non-racemic compound of formula (I), preferably compound of formula (I) with enantiomeric excess of compound (I-R-1), preferably the compound I-R-1, with a compound selected from the group of fipronil, alpha-cypermethrin, chlorfenapyr, metaflumizone, abamectin, pymetrozine, thiamethoxam, imidacloprid, dinotefuran, dinotefuran, clothianidin, flonicamid, spirotetramat, buprofezine, chlorantraniliprole, cyantraniliprole, tetraniliprole, sulfoxaflor, indoxacarb, triflumezopyrim, ethiprole, spinetoram, spinosad, spiropidion, fluxametamide, penflufen, tricyclazole, azoxystrobin, isoprothiolane, tolprocarb, carpropamid, diclocymet, furametpyr, simeconazole, probenazole, orysastrobin, pyroquilon, thifluzamide, picarbutrazox, oxazosulfyl, methoxyfenozid, flubendiamid, flufenoxuron, cyazofamid, metalaxyl, amisulbrom, cyclaniliprole, dicyclomet, and isotianil. Especially preferred is alpha-cypermethrin, flonicamid, fluxametamide, spinetoram, indoxacarb, oxazosulfyl, pymetrozine, triflumezopyrim, flufenoxuron, furametpyr, metalaxyl, probenazole, dicyclomet, penflufen, pyroquilon, simeconazol, buprofezin, tricyclazole, or spinosad

In one embodiment of the invention, the mixtures of the present invention are mixtures of a non-racemic compound of formula (I), preferably compound of formula (I) with enantiomeric excess of compound (I-R-1), preferably the compound I-R-1, with a compound selected from the group of fipronil, alpha-cypermethrin, chlorfenapyr, metaflumizone, abamectin, pymetrozine, thiamethoxam, imidacloprid, dinotefuran, dinotefuran, clothianidin, flonicamid, spirotetramat, buprofezine, chlorantraniliprole, cyantraniliprole, tetraniliprole, sulfoxaflor, indoxacarb, triflumezopyrim, ethiprole, spinetoram, spinosad, spiropidion, fluxametamide, oxazosulfyl, methoxyfenozid, flubendiamid, flufenoxuron, and cyclaniliprole.

In one embodiment of the invention, the mixtures of the present invention are mixtures of a non-racemic compound of formula (I), preferably compound of formula (I) with enantiomeric excess of compound (I-R-1), preferably the compound I-R-1, with a compound selected from the group of probenazole, tricyclazole, pyroquilon, isoprothiolane, tolprocarb, carpropamid, diclocymet, azoxystrobin, orysastrobin, furametpyr, thifluzamide, simeconazole, penflufen, picarbutrazox, cyazofamid, metalaxyl, amisulbrom, and isotianil.

In one embodiment of the invention, the mixtures of the present invention are mixtures of a non-racemic compound of formula (I), preferably compound of formula (I) with enantiomeric excess of compound (I-R-1), preferably the compound I-R-1, with a compound selected from the group of M.4 and M.UN.

In another embodiment of the invention, the mixtures of the present invention are mixtures of a non-racemic compound of formula (I), preferably compound of formula (I) with enantiomeric excess of compound (I-R-1), preferably the compound I-R-1, with a compound selected from the group of M.4 and M.UN.16b.

In another embodiment of the invention, the mixtures of the present invention are mixtures of a non-racemic compound of formula (I), preferably compound of formula (I) with enantiomeric excess of compound (I-R-1), preferably the compound I-R-1, with a compound selected from the group of M.4A, M.4D, and M.UN.16b.

In another embodiment of the invention, the mixtures of the present invention are mixtures of a non-racemic compound of formula (I), preferably compound of formula (I) with enantiomeric excess of compound (I-R-1), preferably the compound I-R-1, with a compound selected from the group of thiamethoxam, Flupyradifurone, and 1-(1,2-dimethylpropyl)-N-ethyl-5-methyl-N-pyridazin-4-yl-pyrazole-4-carboxamide.

In another embodiment of the present invention, the mixtures comprise the compound of formula (I) and two agriculturally active components (active compound and active compound Ill) selected from the insecticides and fungicides listed above.

In another embodiment of the present invention, the mixtures comprise the compound of formula (I) and one insecticide (active compound II) and one fungicide (active compound Ill) selected from the insecticides and fungicides listed above.

In another embodiment of the present invention, the mixtures comprise the compound of formula (I) and one insecticide (active compound II) and another insecticide (active compound Ill) selected from the insecticides listed above.

In another embodiment of the present invention, the mixtures comprise compound of formula (I) and two fungicides or two insecticides listed above.

Especially preferred mixtures according to the invention are listed in the following table M, wherein the compounds I are as defined in the description:

### Mixture Examples

Examples of some mixtures according to the present invention are described in the tables hereinbelow.

The agriculturally active component II, with which the compound of formula I can be combined, are listed in table M.

TABLE M

| Mixture | Comp. I | Compound II |
|---|---|---|
| M-1 | I | fipronil |
| M-2 | I | alpha-cypermethrin |
| M-3 | I | chlorfenapyr |
| M-4 | I | metaflumizone |
| M-5 | I | abamectin |
| M-6 | I | pymetrozine |
| M-7 | I | thiamethoxam |
| M-8 | I | imidacloprid |
| M-9 | I | dinotefuran |
| M-10 | I | clothianidin |
| M-11 | I | bifenthrin |
| M-12 | I | acetamiprid |
| M-13 | I | nitenpyram |
| M-14 | I | cypermethrin |
| M-15 | I | cyhalothrin |
| M-16 | I | lambda-cyhalothrin |
| M-17 | I | flonicamid |
| M-18 | I | spirotetramat |
| M-19 | I | buprofezine |
| M-20 | I | chlorantraniliprole |
| M-21 | I | cyantraniliprole |
| M-22 | I | tetraniliprole |
| M-23 | I | sulfoxaflor |
| M-24 | I | indoxacarb |
| M-25 | I | afidopyropen |
| M-26 | I | broflanilide |
| M-27 | I | pyriprole |
| M-28 | I | triflumezopyrim |
| M-29 | I | flupyradifurone |
| M-30 | I | dicloromezotiaz |
| M-31 | I | chlorpyrifos |
| M-32 | I | dichlorvos |
| M-33 | I | triazophos |
| M-34 | I | cartap |
| M-35 | I | acephate |
| M-36 | I | carbofuran |
| M-37 | I | carbosulfan |
| M-38 | I | emamectin |
| M-39 | I | ethiprole |
| M-40 | I | etofenprox |
| M-41 | I | spinetoram |
| M-42 | I | spinosad |
| M-43 | I | fluhexafon |
| M-44 | I | tefluthrin |
| M-45 | I | momfluorothrin |
| M-46 | I | benzpyrimoxan |
| M-47 | I | cyhalodiamide |
| M-48 | I | spiropidion |
| M-49 | I | flupyrimin |
| M-50 | I | cyclaniliprole |
| M-51 | I | fluxametamide |
| M-52 | I | tioxazafen |
| M-53 | I | fluazaindolizine |
| M-54 | I | pyrifluquinazone |
| M-55 | I | metaaldehyde (in |
| | | particular granular) |
| M-56 | I | benomyl |
| M-57 | I | epoxiconazole |
| M-58 | I | fluquinconazole |
| M-59 | I | flutriafol |
| M-60 | I | flusilazole |
| M-61 | I | metconazole |
| M-62 | I | prochloraz |
| M-63 | I | prothioconazole |
| M-64 | I | tebuconazole |
| M-65 | I | triticonazole |
| M-66 | I | pyraclostrobin |
| M-67 | I | trifloxystrobin |
| M-68 | I | boscalid |
| M-69 | I | dimethomorph |
| M-70 | I | penthiopyrad |
| M-71 | I | dodemorph |
| M-72 | I | famoxadone |
| M-73 | I | fenpropimorph |
| M-74 | I | proquinazid |
| M-75 | I | pyrimethanil |
| M-76 | I | tridemorph |
| M-77 | I | maneb |
| M-78 | I | metiram |
| M-79 | I | thiram |
| M-80 | I | chlorothalonil |
| M-81 | I | dithianon |
| M-82 | I | flusulfamide |
| M-83 | I | metrafenone |
| M-84 | I | fluxapyroxad |
| M-85 | I | bixafen |
| M-86 | I | penflufen |
| M-87 | I | sedaxane |
| M-88 | I | isopyrazam |
| M-89 | I | tricyclazole |
| M-90 | I | azoxystrobin |
| M-91 | I | difenoconazole |
| M-92 | I | kasugamycin |
| M-93 | I | isoprothiolane |
| M-94 | I | tolprocarb |
| M-95 | I | carpropamid |
| M-96 | I | diclocymet |
| M-97 | I | furametpyr |
| M-98 | I | simeconazole |
| M-99 | I | probenazole |
| M-100 | I | mancozeb |
| M-101 | I | propiconazole |
| M-102 | I | hexaconazole |
| M-103 | I | tebuconazole |
| M-104 | I | carbendazim |
| M-105 | I | flutolanil |
| M-106 | I | hymexazol |
| M-107 | I | isotianil |
| M-108 | I | orysastrobin |
| M-109 | I | pencycuron |
| M-110 | I | phthalide |
| M-111 | I | pyroquilon |
| M-112 | I | thifluzamide |
| M-113 | I | thiophanate |
| M-114 | I | thiophanate-methyl |
| M-115 | I | tiadinil |
| M-116 | I | validamycin |
| M-117 | I | tebufloquin |
| M-118 | I | benzovindiflupyr |
| M-119 | I | picarbutrazox |
| M-120 | I | pyraziflumid |
| M-121 | I | dipymetitrone |
| M-122 | I | pydiflumetofen |
| M-123 | I | quinofumelin |
| M-124 | I | ipfentrifluconazole |
| M-125 | I | dichlobentiazox |
| M-126 | I | fenpicoxamid |
| M-127 | I | isoflucypram |
| M-128 | I | fluindapyr |
| M-129 | I | inpyrfluxam |
| M-130 | I | pyrifenamine |
| M-131 | I | mefentrifluconazole |
| M-132 | I | oxazosulfyl |
| M-133 | I | methoxyfenozid |
| M-134 | I | flubendiamid |
| M-135 | I | flufenoxuron |
| M-136 | I | cyazofamid |
| M-137 | I | metalaxyl |
| M-138 | I | amisulbrom |
| M-139 | I | fluopyram |
| M-140 | I | Tetra- |
| | | chlorantraniliprole |
| M-141 | I | 1-(1,2- |
| | | dimethylpropyl)-N- |
| | | ethyl-5-methyl-N- |
| | | pyridazin-4-yl- |
| | | pyrazole-4- |
| | | carboxamide |
| M-142 | I | Tyclopyrazoflor |
| M-143 | I-R-1 | fipronil |
| M-144 | I-R-1 | alpha-cypermethrin |
| M-145 | I-R-1 | chlorfenapyr |
| M-146 | I-R-1 | metaflumizone |
| M-147 | I-R-1 | abamectin |
| M-148 | I-R-1 | pymetrozine |
| M-149 | I-R-1 | thiamethoxam |
| M-150 | I-R-1 | imidacloprid |
| M-151 | I-R-1 | dinotefuran |
| M-152 | I-R-1 | clothianidin |
| M-153 | I-R-1 | bifenthrin |
| M-154 | I-R-1 | acetamiprid |
| M-155 | I-R-1 | nitenpyram |
| M-156 | I-R-1 | cypermethrin |
| M-157 | I-R-1 | cyhalothrin |
| M-158 | I-R-1 | lambda-cyhalothrin |
| M-159 | I-R-1 | flonicamid |
| M-160 | I-R-1 | spirotetramat |
| M-161 | I-R-1 | buprofezine |
| M-162 | I-R-1 | chlorantraniliprole |
| M-163 | I-R-1 | cyantraniliprole |
| M-164 | I-R-1 | tetraniliprole |
| M-165 | I-R-1 | sulfoxaflor |
| M-166 | I-R-1 | indoxacarb |
| M-167 | I-R-1 | afidopyropen |
| M-168 | I-R-1 | broflanilide |
| M-169 | I-R-1 | pyriprole |
| M-170 | I-R-1 | triflumezopyrim |
| M-171 | I-R-1 | flupyradifurone |
| M-172 | I-R-1 | dicloromezotiaz |
| M-173 | I-R-1 | chlorpyrifos |
| M-174 | I-R-1 | dichlorvos |
| M-175 | I-R-1 | triazophos |
| M-176 | I-R-1 | cartap |
| M-177 | I-R-1 | acephate |
| M-178 | I-R-1 | carbofuran |
| M-179 | I-R-1 | carbosulfan |
| M-180 | I-R-1 | emamectin |
| M-181 | I-R-1 | ethiprole |
| M-182 | I-R-1 | etofenprox |
| M-183 | I-R-1 | spinetoram |
| M-184 | I-R-1 | spinosad |
| M-185 | I-R-1 | fluhexafon |
| M-186 | I-R-1 | tefluthrin |
| M-187 | I-R-1 | momfluorothrin |
| M-188 | I-R-1 | benzpyrimoxan |
| M-189 | I-R-1 | cyhalodiamide |
| M-190 | I-R-1 | spiropidion |
| M-191 | I-R-1 | flupyrimin |
| M-192 | I-R-1 | cyclaniliprole |
| M-193 | I-R-1 | fluxametamide |
| M-194 | I-R-1 | tioxazafen |
| M-195 | I-R-1 | fluazaindolizine |
| M-196 | I-R-1 | pyrifluquinazone |
| M-197 | I-R-1 | metaaldehyde (in |
| | | particular granular) |
| M-198 | I-R-1 | benomyl |
| M-199 | I-R-1 | epoxiconazole |
| M-200 | I-R-1 | fluquinconazole |
| M-201 | I-R-1 | flutriafol |
| M-202 | I-R-1 | flusilazole |
| M-203 | I-R-1 | metconazole |
| M-204 | I-R-1 | prochloraz |
| M-205 | I-R-1 | prothioconazole |
| M-206 | I-R-1 | tebuconazole |
| M-207 | I-R-1 | triticonazole |
| M-208 | I-R-1 | pyraclostrobin |
| M-209 | I-R-1 | trifloxystrobin |
| M-210 | I-R-1 | boscalid |
| M-211 | I-R-1 | dimethomorph |
| M-212 | I-R-1 | penthiopyrad |
| M-213 | I-R-1 | dodemorph |
| M-214 | I-R-1 | famoxadone |
| M-215 | I-R-1 | fenpropimorph |
| M-216 | I-R-1 | proquinazid |
| M-217 | I-R-1 | pyrimethanil |
| M-218 | I-R-1 | tridemorph |
| M-219 | I-R-1 | maneb |
| M-220 | I-R-1 | metiram |
| M-221 | I-R-1 | thiram |
| M-222 | I-R-1 | chlorothalonil |
| M-223 | I-R-1 | dithianon |
| M-224 | I-R-1 | flusulfamide |
| M-225 | I-R-1 | metrafenone |
| M-226 | I-R-1 | fluxapyroxad |
| M-227 | I-R-1 | bixafen |
| M-228 | I-R-1 | penflufen |
| M-229 | I-R-1 | sedaxane |
| M-230 | I-R-1 | isopyrazam |
| M-231 | I-R-1 | tricyclazole |
| M-232 | I-R-1 | azoxystrobin |
| M-233 | I-R-1 | difenoconazole |
| M-234 | I-R-1 | kasugamycin |
| M-235 | I-R-1 | isoprothiolane |
| M-236 | I-R-1 | tolprocarb |
| M-237 | I-R-1 | carpropamid |
| M-238 | I-R-1 | diclocymet |
| M-239 | I-R-1 | furametpyr |
| M-240 | I-R-1 | simeconazole |
| M-241 | I-R-1 | probenazole |
| M-242 | I-R-1 | mancozeb |
| M-243 | I-R-1 | propiconazole |
| M-244 | I-R-1 | hexaconazole |
| M-245 | I-R-1 | tebuconazole |
| M-246 | I-R-1 | carbendazim |
| M-247 | I-R-1 | flutolanil |
| M-248 | I-R-1 | hymexazol |
| M-249 | I-R-1 | isotianil |
| M-250 | I-R-1 | orysastrobin |
| M-251 | I-R-1 | pencycuron |
| M-252 | I-R-1 | phthalide |
| M-253 | I-R-1 | pyroquilon |
| M-254 | I-R-1 | thifluzamide |
| M-255 | I-R-1 | thiophanate |
| M-256 | I-R-1 | thiophanate-methyl |
| M-257 | I-R-1 | tiadinil |
| M-258 | I-R-1 | validamycin |
| M-259 | I-R-1 | tebufloquin |
| M-260 | I-R-1 | benzovindiflupyr |
| M-261 | I-R-1 | picarbutrazox |
| M-262 | I-R-1 | pyraziflumid |
| M-263 | I-R-1 | dipymetitrone |
| M-264 | I-R-1 | pydiflumetofen |
| M-265 | I-R-1 | quinofumelin |
| M-266 | I-R-1 | ipfentrifluconazole |
| M-267 | I-R-1 | dichlobentiazox |
| M-268 | I-R-1 | fenpicoxamid |
| M-269 | I-R-1 | isoflucypram |
| M-270 | I-R-1 | fluindapyr |
| M-271 | I-R-1 | inpyrfluxam |
| M-272 | I-R-1 | pyrifenamine |
| M-273 | I-R-1 | mefentrifluconazole |
| M-274 | I-R-1 | oxazosulfyl |
| M-275 | I-R-1 | methoxyfenozid |
| M-276 | I-R-1 | flubendiamid |
| M-277 | I-R-1 | flufenoxuron |
| M-278 | I-R-1 | cyazofamid |
| M-279 | I-R-1 | metalaxyl |
| M-280 | I-R-1 | amisulbrom |
| M-281 | I-R-1 | Fluopyram |
| M-282 | I-R-1 | Tetra- |
| | | chlorantraniliprole |
| M-283 | I-R-1 | Tyclopyrazoflor |
| M-284 | I-R-1 | 1-(1,2- |
| | | dimethylpropyl)-N- |
| | | ethyl-5-methyl-N- |
| | | pyridazin-4-yl- |
| | | pyrazole-4- |
| | | carboxamide |

The invention also relates to agrochemical compositions suitable for applying in seed treatment methods comprising an auxiliary and the compound of formula (I) as defined herein or a composition thereof, according to the invention.

An agrochemical composition comprises a pesticidally effective amount of a compound of formula (I). The term “effective amount” denotes an amount of the composition or of the compounds l, which is sufficient for controlling harmful pests on cultivated plants or in the protection of materials and which does not result in a substantial damage to the treated plants. Such an amount can vary in a broad range and is dependent on various factors, such as the animal pests species to be controlled, the treated cultivated plant or material, the climatic conditions and the specific compound I used.

The compounds of formula (I), their N-oxides and salts can be converted into customary types of agrochemical compositions, e. g. solutions, emulsions, suspensions, dusts, powders, pastes, granules, pressings, capsules, and mixtures thereof. Examples for composition types are suspensions (e.g. SC, OD, ES), emulsifiable concentrates (e.g. EC), emulsions (e.g. EW, EO, ES, ME), capsules (e.g. CS, ZC), pastes, pastilles, wettable powders or dusts (e.g. WP, SP, WS, DP, DS), pressings (e.g. BR, TB, DT), granules (e.g. WG, SG, GR, FG, GG, MG), insecticidal articles (e.g. LN), as well as gel formulations for the treatment of plant propagation materials such as seeds (e.g. GF). These and further compositions types are defined in the “Catalogue of pesticide formulation types and international coding system”, Technical Monograph No. 2, 6th Ed. May 2008, CropLife International.

The compositions are prepared in a known manner, such as described by Mollet and Grubemann, Formulation technology, Wiley VCH, Weinheim, 2001; or Knowles, New developments in crop protection product formulation, Agrow Reports DS243, T&F Informa, London, 2005.

Suitable auxiliaries are solvents, liquid carriers, solid carriers or fillers, surfactants, dispersants, emulsifiers, wetters, adjuvants, solubilizers, penetration enhancers, protective colloids, adhesion agents, thickeners, humectants, repellents, attractants, feeding stimulants, compatibilizers, bactericides, anti-freezing agents, anti-foaming agents, colorants, tackifiers and binders.

Suitable solvents and liquid carriers are water and organic solvents, such as mineral oil fractions of medium to high boiling point, e.g. kerosene, diesel oil; oils of vegetable or animal origin; aliphatic, cyclic and aromatic hydrocarbons, e. g. toluene, paraffin, tetrahydronaphthalene, alkylated naphthalenes; alcohols, e.g. ethanol, propanol, butanol, benzylalcohol, cyclo-hexanol; glycols; DMSO; ketones, e.g. cyclohexanone; esters, e.g. lactates, carbonates, fatty acid esters, gamma-butyrolactone; fatty acids; phosphonates; amines; amides, e.g. N-methylpyrrolidone, fatty acid dimethylamides; and mixtures thereof.

Suitable solid carriers or fillers are mineral earths, e.g. silicates, silica gels, talc, kaolins, limestone, lime, chalk, clays, dolomite, diatomaceous earth, bentonite, calcium sulfate, magnesium sulfate, magnesium oxide; polysaccharides, e.g. cellulose, starch; fertilizers, e.g. ammonium sulfate, ammonium phosphate, ammonium nitrate, ureas; products of vegetable origin, e.g. cereal meal, tree bark meal, wood meal, nutshell meal, and mixtures thereof.

Suitable surfactants are surface-active compounds, such as anionic, cationic, nonionic and am-photeric surfactants, block polymers, polyelectrolytes, and mixtures thereof. Such surfactants can be used as emusifier, dispersant, solubilizer, wetter, penetration enhancer, protective colloid, or adjuvant. Examples of surfactants are listed in McCutcheon's, Vol. 1: Emulsifiers & Detergents, McCutcheon's Directories, Glen Rock, USA, 2008 (International Ed. or North American Ed.).

Suitable anionic surfactants are alkali, alkaline earth or ammonium salts of sulfonates, sulfates, phosphates, carboxylates, and mixtures thereof. Examples of sulfonates are alkylarylsulfonates, diphenylsulfonates, alpha-olefin sulfonates, lignine sulfonates, sulfonates of fatty acids and oils, sulfonates of ethoxylated alkylphenols, sulfonates of alkoxylated arylphenols, sulfonates of con-densed naphthalenes, sulfonates of dodecyl- and tridecylbenzenes, sulfonates of naphthalenes and alkyhnaphthalenes, sulfosuccinates or sulfosuccinamates. Examples of sulfates are sulfates of fatty acids and oils, of ethoxylated alkylphenols, of alcohols, of ethoxylated alcohols, or of fatty acid esters. Examples of phosphates are phosphate esters. Examples of carboxylates are alkyl carboxylates, and carboxylated alcohol or alkylphenol ethoxylates.

Suitable nonionic surfactants are alkoxylates, N-substituted fatty acid amides, amine oxides, esters, sugar-based surfactants, polymeric surfactants, and mixtures thereof. Examples of alkoxylates are compounds such as alcohols, alkylphenols, amines, amides, arylphenols, fatty acids or fatty acid esters which have been alkoxylated with 1 to 50 equivalents. Ethylene oxide and/or propylene oxide may be employed for the alkoxylation, preferably ethylene oxide. Examples of N-substituted fatty acid amides are fatty acid glucamides or fatty acid alkanolamides. Examples of esters are fatty acid esters, glycerol esters or monoglycerides. Examples of sugar-based surfactants are sorbitans, ethoxylated sorbitans, sucrose and glucose esters or alkylpolyglucosides. Examples of polymeric surfactants are home- or copolymers of vinylpyrrolidone, vinylalcohols, or vinylacetate.

Suitable cationic surfactants are quaternary surfactants, for example quaternary ammonium compounds with one or two hydrophobic groups, or salts of long-chain primary amines. Suitable amphoteric surfactants are alkylbetains and imidazolines. Suitable block polymers are block polymers of the A-B or A-B-A type comprising blocks of polyethylene oxide and polypropylene oxide, or of the A-B—C type comprising alkanol, polyethylene oxide and polypropylene oxide. Suitable polyelectrolytes are polyacids or polybases. Examples of polyacids are alkali salts of polyacrylic acid or polyacid comb polymers. Examples of polybases are polyvinylamines or polyethyleneamines.

Suitable adjuvants are compounds, which have a neglectable or even no pesticidal activity themselves, and which improve the biological performance of the compound I on the target. Examples are surfactants, mineral or vegetable oils, and other auxilaries. Further examples are listed by Knowles, Adjuvants and additives, Agrow Reports DS256, T&F Informa UK, 2006, chapter 5.

Suitable thickeners are polysaccharides (e.g. xanthan gum, carboxymethylcellulose), anorganic clays (organically modified or unmodified), polycarboxylates, and silicates.

Suitable bactericides are bronopol and isothiazolinone derivatives such as alkylisothiazolinones and benzisothiazolinones.

Suitable anti-freezing agents are ethylene glycol, propylene glycol, urea and glycerin.

Suitable anti-foaming agents are silicones, long chain alcohols, and salts of fatty acids.

Suitable colorants (e.g. in red, blue, or green) are pigments of low water solubility and water-soluble dyes. Examples are inorganic colorants (e.g. iron oxide, titan oxide, iron hexacyanoferrate) and organic colorants (e.g. alizarin-, azo- and phthalocyanine colorants).

Suitable tackifiers or binders are polyvinylpyrrolidone, polyvinylacetates, polyvinyl alcohols, polyacrylates, biological or synthetic waxes, and cellulose ethers.

The agrochemical compositions generally comprise between 0.01 and 95%, preferably between 0.1 and 90%, and in particular between 0.5 and 75%, by weight of active substance. The active substances are employed in a purity of from 90% to 100%, preferably from 95% to 100% (according to NMR spectrum).

Solutions for seed treatment (LS), Suspoemulsions (SE), flowable concentrates (FS), powders for dry treatment (DS), water-dispersible powders for slurry treatment (WS), water-soluble powders (SS), emulsions (ES), emulsifiable concentrates (EC) and gels (GF) are usually employed for the purposes of treatment of plant propagation materials, particularly seeds. The compositions in question give, after two-to-tenfold dilution, active substance concentrations of from 0.01 to 60% by weight, preferably from 0.1 to 40% by weight, in the ready-to-use preparations. Application can be carried out before or during sowing. Methods for applying compound I and compositions thereof, respectively, on to plant propagation material, especially seeds include dressing, coating, pelleting, dusting, soaking and infurrow application methods of the propagation material. Preferably, compound I or the compositions thereof, respectively, are applied on to the plant propagation material by a method such that germination is not induced, e. g. by seed dressing, pelleting, coating and dusting.

When employed in plant protection, the amounts of active substances applied are, depending on the kind of effect desired, from 0.001 to 2 kg per ha, preferably from 0.005 to 2 kg per ha, more preferably from 0.05 to 0.9 kg per ha, and in particular from 0.1 to 0.75 kg per ha.

In treatment of plant propagation materials such as seeds, e. g. by dusting, coating or drenching seed, amounts of active substance of from 0.1 to 1000 g, preferably from 1 to 1000 g, more preferably from 1 to 100 g and most preferably from 5 to 100 g, per 100 kilogram of plant propagation material (preferably seeds) are generally required.

When used in the protection of materials or stored products, the amount of active substance applied depends on the kind of application area and on the desired effect. Amounts customarily applied in the protection of materials are 0.001 g to 2 kg, preferably 0.005 g to 1 kg, of active substance per cubic meter of treated material.

Various types of oils, wetters, adjuvants, fertilizer, or micronutrients, and further pesticides (e.g. herbicides, insecticides, fungicides, growth regulators, safeners) may be added to the active substances or the compositions cormprising them as premix or, if appropriate not until immediately prior to use (tank mix). These agents can be admixed with the compositions according to the invention in a weight ratio of 1:100 to 100:1, preferably 1:10 to 10:1.

The user applies the composition according to the invention usually from a predosage device, a knapsack sprayer, a spray tank, a spray plane, or an irrigation system. Usually, the agrochemical composition is made up with water, buffer, and/or further auxiliaries to the desired application concentration and the ready-to-use spray liquor or the agrochemical composition according to the invention is thus obtained. Usually, 20 to 2000 liters, preferably 50 to 400 liters, of the ready-to-use spray liquor are applied per hectare of agricultural useful area.

The present invention relates to the methods by use on natural substrates (soil) or artificial (growth) substrates (e.g. rock wool, glass wool, quartz sand, gravel, expanded clay, vermiculite), in the open or in closed systems (e.g. greenhouses or under film mulch) and in annual crops (such as vegetables, spices, ornamentals) or perennial crops (such as citrus plants, fruits, tropical crops, spices, nuts, grapevines, conifers and ornamentals).

It has now been found that the problems associated with combating pests by other pesticide treatment can be overcome by seed treatment methods using compounds of the present invention.

The animal pest, i.e. the insects, arachnids and nematodes, the plant, the water or the soil in which the plant is growing may be controlled with the present compounds of formula I or composition”) containing them by any application method known in the art. As such, “contacting” includes both direct contact (applying the compounds/compositions directly on the animal pest or plant) and indirect contact (applying the compounds/compositions to the locus of the animal pest or plant). When the plant is contacted, typically the tuber, bulbs or roots of the plant are contacted. The compounds of formula (I) or composition ) containing them are applied to other parts of the plant, such as plant propagation material such as seeds in the case of seed treatment.

The compounds of formula I or the pesticidal compositions comprising them may be used to protect growing plants and crops from attack or infestation by animal pests, especially insects, acaridae or arachnids by contacting the plant/crop with a pesticidally effective amount of compounds of formula I. The term “crop” refers both to growing and harvested crops.

Thus, as with regards to the use and for the purpose of the present invention, vegetables are to be understood as meaning for example fruiting vegetables and inflorescences as vegetables, i.e. bell peppers, chillies, tomatoes, aubergines, cucumbers, pumpkins, courgettes, broad beans, climbing and dwarf beans, peas, artichokes and maize. Further also leafy vegetables like head-forming lettuce, chicory, endives, various types of cress, of rocket, lamb's lettuce, iceberg lettuce, leeks, spinach and chard. Furthermore, tuber vegetables, root vegetables and stem vegetables, like celeriac/celery, beetroot, carrots, radish, horseradish, scorzonera, asparagus, beet for human consumption, palm hearts and bamboo shoots. Further also bulb vegetables like onions, leeks, fennel and garlic. Brassica vegetables such as cauliflower, broccoli, kohlrabi, red cabbage, white cabbage, curly kale, Savoy cabbage, Brussels sprouts and Chinese cabbage are also vegetable in the sense of the present application.

Regarding the use and for the purpose of the present invention, perennial crops are to be understood as meaning citrus, for example, oranges, grapefruits, tangerines, lemons, limes, Seville oranges, cumquats and satsumas. Also pome fruit such as, for example, apples, pears and quinces, and stone fruit such as, for example, peaches, nectarines, cherries, plums, quetsch, apricots. Further grapevines, hops, olives, tea and tropical crops such as, for example, mangoes, papayas, figs, pineapples, dates, bananas, durians, kaki fruit, coconuts, cacao, coffee, avocados lychees, maracujas, and. guavas. Furthermore soft fruit such as, for example, currants, gooseberries, raspberries, blackberries, blueberries, strawberries, cranberries, kiwi fruit and American cranberries. Almonds and nuts such as, for example, hazelnuts, walnuts, pistachios, cashew nuts, para nuts, pecan nuts, butternuts, chestnuts, hickory nuts, macadamia nuts and peanuts are also fruits in the sense of the present invention.

As with regard to the use and for the purpose of the present invention, ornamentals are understood as meaning annual and perennial plants, for example cut flowers such as, for example, roses, carnations, gerbera, lilies, marguerites, chrysanthemums, tulips, narcissus, anemones, poppies, amaryllis, dahlias, azaleas, hibiscus, but also for example border plants, pot plants and perennials such as, for example, roses, Tagetes, violas, geraniums, fuchsias, hibiscus, chrysanthemum, busy lizzie, cyclamen, African violet, sunflowers, begonias.

Furthermore for example also bushes and conifers such as, for example, ficus, rhododendron, firs, spruces, pines, yews, juniper, umbrella pines, oleander.

As regards the use, spices are understood as meaning annual and perennial plants such as, for example, aniseed, chilli pepper, paprika, pepper, vanilla, marjoram, thyme, cloves, juniper berries, cinnamon, tarragon, coriander, saffron, ginger.

Furthermore the compounds of the present invention and the compositions comprising them are particularly important in the control of a multitude of insects on various cultivated plants, such as soybean, corn, canola, cereals, sugarbeet, cotton, peanut, or potato.

The compounds of the invention can also be applied preventively to places at which occurrence of the pests is expected.

“Locus” means a habitat, breeding ground, plant, seed, soil, area, material or environment in which a pest or parasite is growing or may grow.

The term “plant propagation material” is to be understood to denote all the generative parts of the plant such as seeds and vegetative plant material such as cuttings and tubers (e. g. potatoes), which can be used for the multiplication of the plant. This includes seeds, roots, fruits, tubers, bulbs, rhizomes, shoots, sprouts and other parts of plants. Seedlings and young plants, which are to be transplanted after germination or after emergence from soil, may also be included. These plant propagation materials may be treated prophylactically with a plant protection compound either at or before planting or transplanting.

In one preferred embodiment of the invention, the plant propagation material is seed.

The term “cultivated plants” is to be understood as including plants which have been modified by breeding, mutagenesis or genetic engineering. Genetically modified plants are plants, which genetic material has been so modified by the use of recombinant DNA techniques that under natural circumstances cannot readily be obtained by cross breeding, mutations or natural recombination. Typically, one or more genes have been integrated into the genetic material of a genetically modified plant in order to improve certain properties of the plant. Such genetic modifications also include but are not limited to targeted post-transitional modification of protein(s) (oligo- or polypeptides) poly for example by glycosylation or polymer additions such as prenylated, acetylated or farnesylated moieties or PEG moieties (e.g. as disclosed in Biotechnol Prog. 2001 July-August; 17(4):720-8, Protein Eng Des Sel. 2004 January; 17(1):57-66, Nat Protoc. 2007; 2(5):1225-35, Curr Opin Chem Biol. 2006 October; 10(5):487-91. Epub 2006 Aug. 28, Biomaterials. 2001 March; 22(5):405-17, Bioconjug Chem. 2005 January-February; 16(1):113-21).

The term “cultivated plants” is to be understood also including plants that have been rendered tolerant to applications of specific classes of herbicides, such as hydroxy-phenylpyruvate dioxygenase (HPPD) inhibitors; acetolactate synthase (ALS) inhibitors, such as sulfonyl ureas (see e. g. U.S. Pat. No. 6,222,100, WO 01/82685, WO 00/26390, WO 97/41218, WO 98/02526, WO 98/02527, WO 04/106529, WO 05/20673, WO 03/14357, WO 03/13225, WO 03/14356, WO 04/16073) or imidazolinones (see e. g. U.S. Pat. No. 6,222,100, WO 01/82685, WO 00/26390, WO 97/41218, WO 98/02526, WO 98/02527, WO 04/106529, WO 05/20673, WO 03/14357, WO 03/13225, WO 03/14356, WO 04/16073); enolpyruvylshikimate-3-phosphate synthase (EPSPS) inhibitors, such as glyphosate (see e. g. WO 92/00377); glutamine synthetase (GS) inhibitors, such as glufosinate (see e. g. EP-A-0242236, EP-A-242246) or oxynil herbicides (see e. g. U.S. Pat. No. 5,559,024) as a result of conventional methods of breeding or genetic engineering. Several cultivated plants have been rendered tolerant to herbicides by conventional methods of breeding (mutagenesis), for example Clearfield® summer rape (Canola) being tolerant to imidazolinones, e. g. imazamox. Genetic engineering methods have been used to render cultivated plants, such as soybean, cotton, corn, beets and rape, tolerant to herbicides, such as glyphosate and glufosinate, some of which are commercially available under the trade names RoundupReady® (glyphosate) and LibertyLink® (glufosinate).

The term “cultivated plants” is to be understood also including plants that are by the use of recombinant DNA techniques capable to synthesize one or more insecticidal proteins, especially those known from the bacterial genus Bacillus, particularly from Bacillus thuringiensis, such as a-endotoxins, e. g. CryIA(b), CryIA(c), CryIF, CryIF(a2), CryIIA(b), CryIIIA, CryIIIB(bl) or Cry9c; vegetative insecticidal proteins (VIP), e. g. VIP1, VIP2, VIP3 or VIP3A; insecticidal proteins of bacteria colonizing nematodes, for example Photorhabdus spp. or Xenorhabdus spp.; toxins produced by animals, such as scorpion toxins, arachnid toxins, wasp toxins, or other insect-specific neurotoxins; toxins produced by fungi, such Streptomycetes toxins, plant lectins, such as pea or barley lectins; agglutinins; proteinase inhibitors, such as trypsin inhibitors, serine protease inhibitors, patatin, cystatin or papain inhibitors; ribosome-inactivating proteins (RIP), such as ricin, maize-RIP, abrin, luffin, saporin or bryodin; steroid metabolism enzymes, such as 3-hydroxysteroid oxidase, ecdysteroid-IDP-glycosyl-transferase, cholesterol oxidases, ecdysone inhibitors or HMG-CoA-reductase; ion channel blockers, such as blockers of sodium or calcium channels; juvenile hormone esterase; diuretic hormone receptors (helicokinin receptors); stilben synthase, bibenzyl synthase, chitinases or glucanases. In the context of the present invention these insecticidal proteins or toxins are to be understood expressly also as pre-toxins, hybrid proteins, truncated or otherwise modified proteins. Hybrid proteins are characterized by a new combination of protein domains, (see, for example WO 02/015701). Further examples of such toxins or genetically-modified plants capable of synthesizing such toxins are dis-closed, for example, in EP-A 374753, WO 93/007278, WO 95/34656, EP-A 427529, EP-A 451878, WO 03/018810 und WO 03/052073. The methods for producing such genetically modified plants are generally known to the person skilled in the art and are described, for example, in the publications mentioned above. These insecticidal proteins contained in the genetically modified plants impart to the plants producing these proteins protection from harmful pests from certain taxonomic groups of arthropods, particularly to beetles (Coleoptera), flies (Diptera), and butterflies and moths (Lepidoptera) and to plant parasitic nematodes (Nematoda).

The term “cultivated plants” is to be understood also including plants that are by the use of recombinant DNA techniques capable to synthesize one or more proteins to increase the resistance or tolerance of those plants to bacterial, viral or fungal pathogens. Examples of such proteins are the so-called “pathogenesis-related proteins” (PR proteins, see, for example EP-A 0392225), plant disease resistance genes (for example potato cultivars, which express resistance genes acting against Phytophthora infestans derived from the mexican wild potato Solanum bulbocastanum) or T4-lyso-zym (e. g. potato cultivars capable of synthesizing these proteins with increased resistance against bacteria such as Erwinia amylvora). The methods for producing such genetically modified plants are generally known to the person skilled in the art and are described, for example, in the publications mentioned above.

The term “cultivated plants” is to be understood also including plants that are by the use of recombinant DNA techniques capable to synthesize one or more proteins to increase the productivity (e. g. bio mass production, grain yield, starch content, oil content or protein content), tolerance to drought, salinity or other growth-limiting environ-mental factors or tolerance to pests and fungal, bacterial or viral pathogens of those plants.

The term “cultivated plants” is to be understood also including plants that contain by the use of recombinant DNA techniques a modified amount of substances of content or new substances of content, specifically to improve human or animal nutrition, for ex-ample oil crops that produce health-promoting long-chain omega-3 fatty acids or unsaturated omega-9 fatty acids (e. g. Nexera® rape).

The term “cultivated plants” is to be understood also including plants that contain by the use of recombinant DNA techniques a modified amount of substances of content or new substances of content, specifically to improve raw material production, for example potatoes that produce increased amounts of amylopectin (e. g. Amflora® potato).

The preferred plants or seeds of plants (obtained by genetic engineering) which are to be treated according to the invention include all plants which, by virtue of the genetic modification, received genetic material which imparts particularly advantageous, useful traits to these plants.

Examples of such traits are better plant growth, increased tolerance to high or low temperatures, increased tolerance to drought or to water or soil salt content, increased flowering performance, easier harvesting, accelerated maturation, higher harvest yields, higher quality and/or a higher nutritional value of the harvested products, better storage stability and/or processability of the harvested products.

Further and particularly emphasized examples of such traits are a better defense of the plants against animal and microbial pests, such as against insects, mites, phytopathogens, and also increased tolerance of the plants to certain herbicidally active compounds.

Traits that are emphasized in particular are the increased defense of the plants against insects, arachnids, nematodes and slugs and snails by virtue of toxins formed in the plants, in particular those formed in the plants by the genetic material from Bacillus thuringiensis (for example by the genes CryIA(a), CryIA(b), CryIA(c), CryIIA, CryIIIA, CryIIIB2, Cry9c, Cry2Ab, Cry3Bb and CryIF and also combinations thereof) (referred to herein as “Bt plants”). Traits that are also particularly emphasized are the increased defense of the plants against fungi, bacteria and viruses by systemic acquired resistance (SAR), systemin, phytoalexins, elicitors and resistance genes and correspondingly expressed proteins and toxins.

Traits that are furthermore particularly emphasized are the increased tolerance of the plants to certain herbicidally active compounds, for example imidazolinones, sulphonylureas, glyphosate or phosphinotricin (for example the “PAT” gene). The genes which impart the desired traits in question can also be present in combination with one another in the transgenic plants.

Examples of “Bt plants” are soybean varieties which are sold under the trade names YIELD GARD®, and INTACTA®.

Examples of herbicide-tolerant plants which may be mentioned are soya bean varieties which are sold under the trade names Roundup Ready® (tolerance to glyphosate), Liberty Link® (tolerance to phosphinotricin), IMI® (tolerance to imidazolinones) and STS® (tolerance to sulphonylureas). An example of a glyphosate tolerant soybean cultivar is BMX Potência.

Herbicide-resistant plants (plants bred in a conventional manner for herbicide tolerance) which may be mentioned include the varieties sold under the name Clearfield® (for example maize).

In another preferred embodiment, the compounds of the invention are applied to seeds of soybean plants, carrying two or more traits (e.g. Enlist®), glyphosate (e.g. Roundup Ready®, Roundup Ready 2 Yield®), sulfonylurea (e.g. STS®), glufosinate (e.g. Liberty Link®, Ignite®), Dicamba (Monsanto) HPPD tolerance (e.g. isoxaflutole herbicide) (Bayer CropScience, Syngenta). Double or triple stack in soybean plants of any of the traits described here are also of interest, including glyphosate and sulfonyl-urea tolerance (e.g. Optimum GAT®, plants stacked with STS® and Roundup Ready® or Roundup Ready 2 Yield®), dicamba and glyphosate tolerance (Monsanto). Soybean Cyst Nematode resistance soybean (SCN®—Syngenta) and soybean with Aphid resistant trait (AMT®—Syngneta) are also of interest.

These statements also apply to plant cultivars having these genetic traits or genetic traits still to be developed, which plant cultivars will be developed and/or marketed in the future.

The present invention also relates to a method for controlling pests and/or increasing the plant health of a cultivated plant as compared to the respective non-modified control plant, comprising the application of the compound of the formula (I) by seed treatment method, to a plant with at least one modification, parts of such plant, plant propagation material, or at its locus of growth, wherein the cultivated plant is

(i) Gossypium hirsutum L. (cotton) or Zea mays L. (maize) and comprises at least one gene selected from the group consisting of dvsnf7, cry1A, cry1Ab-Ac, cry1C, cry2Ab2, cry2Ae, mocry1F; or

(ii) Glycine max L. (soybean), Triticum aestivum (wheat) or Oryza sativa L. (rice) and comprises at least one gene selected from the group consisting of cry34Ab1, cry35 Ab1, cry3A, cry3Bb1, dvsnf7, mcry3A, cry1A, cry1A.105, cry1Ab, cry1Ab-Ac, cry1Ac, cry1C, cry1F, cry1Fa2, cry2Ab2, cry2Ae, cry9c, mocry1F, pinII, vip3A(a), vip3Aa20.

Preferably, present invention also relates to a method for controlling pests and/or increasing the plant health of a cultivated plant as compared to the respective non-modified control plant, comprising the application of the compound of the formula (I) by seed treatment method, to a plant with at least one modification, parts of such plant, plant propagation material, or at its locus of growth, wherein the cultivated plant is modified by at least one gene according to one row of table D.

TABLE D

| No. | crop | gene |
|---|---|---|
| D-1 | cotton | dvsnf7 |
| D-2 | cotton | cry1A |
| D-3 | cotton | cry1Ab-Ac |
| D-4 | cotton | cry1C |
| D-5 | cotton | cry2Ab2 |
| D-6 | cotton | cry2Ae |
| D-7 | cotton | mocry1F |
| D-8 | maize | dvsnf7 |
| D-9 | maize | cry1A |
| D-10 | maize | cry1Ab-Ac |
| D-11 | maize | cry1C |
| D-12 | maize | cry2Ab2 |
| D-13 | maize | cry2Ae |
| D-14 | maize | mocry1F |
| D-15 | soybean | cry34Ab1 |
| D-16 | soybean | cry35 Ab1 |
| D-17 | soybean | cry3A |
| D-18 | soybean | cry3Bb1 |
| D-19 | soybean | dvsnf7 |
| D-20 | soybean | mcry3A |
| D-21 | soybean | cry1A |
| D-22 | soybean | cry1A.105 |
| D-23 | soybean | cry1Ab |
| D-24 | soybean | cry1Ab-Ac |
| D-25 | soybean | cry1Ac |
| D-26 | soybean | cry1C |
| D-27 | soybean | cry1F |
| D-28 | soybean | cry1Fa2 |
| D-29 | soybean | cry2Ab2 |
| D-30 | soybean | cry2Ae |
| D-31 | soybean | cry9c |
| D-32 | soybean | mocry1F |
| D-33 | soybean | pinII |
| D-34 | soybean | vip3A(a) |
| D-35 | soybean | vip3Aa20 |

In general, “pesticidally effective amount” means the amount of active ingredient needed to achieve an observable effect on growth, including the effects of necrosis, death, retardation, prevention, and removal, destruction, or otherwise diminishing the occurrence and activity of the target organism. The pesticidally effective amount can vary for the various compounds/compositions used in the invention. A pesticidally effective amount of the compositions will also vary according to the prevailing conditions such as desired pesticidal effect and duration, weather, target species, locus, mode of application, and the like.

In the case of soil treatment or of application to the pests dwelling place or nest, the quantity of active ingredient ranges from 0.0001 to 500 g per 100 m2, preferably from 0.001 to 20 g per 100 m2.

As mentioned further above, soil application methods include among other known techniques in-furrow and T-band applications.

The active compound can be applied as granular as T-Band or In-furrow treatments.

Granular or liquid T-Band applications are placed in front of the furrow closure wheels using plastic diffusers. In general, the band coverage pattern is approximately a couple of inches wide over an open furrow.

In furrow treatments are directed into the open furrow using plastic tubing.

Liquid formulations are applied as T-band over an open furrow.

For example, seeds are planted using cone seeders and drop nozzles are positioned over the seed furrow. The boom can be moved up or down to change band width. A flat fan nozzle can also be used: perpendicular to the row for bands and parallel to the row for in-furrow. The boom position is between the furrow opener and the press wheel which directs some (band) or all (infurrow) of the spray into the furrow before furrow closure. When used in in-furrow applications, the active compound(s) can be applied simultaneously with the planting of the seeds, e.g. as granular, liquid or another formulation type. Alternatively, the nozzles can also be positioned behind the press wheel for an entirely surface spray of the liquid formulation comprising the active compound(s).

The compounds of the invention are particularly suitable for use in the treatment of seeds in order to protect the seeds from insect pests, in particular from storage pests, soil-living insect pests, and the resulting seedling's roots and shoots against soil pests and foliar insects. The invention therefore also relates to a method for the protection of seeds from insects, in particular from soil insects, and of the seedling's roots and shoots from insects, in particular from soil and foliar insects, said method comprising treating the seeds before sowing and/or after pregermination with a compound of the invention. The protection of the seedling's roots and shoots is preferred. More preferred is the protection of seedling's shoots from piercing and sucking insects, chewing insects and nematodes.

The compounds of formula I are particularly suitable for the treatment of seeds in order to protect the seed from insect pest, in particular from soil-living insect pests and the resulting plant's roots and shoots against soil pests and foliar insects.

The compounds of formula I are particularly useful for the protection of the seed from soil pests and the resulting plant's roots and shoots against soil pests and foliar insects. The protection of the resulting plant's roots and shoots is preferred. More preferred is the protection of resulting plant's shoots from piercing and sucking insects, wherein the protection from aphids is most preferred.

The present invention therefore comprises a method for the protection of seeds from insects, in particular from soil insects and of the seedling's roots and shoots from insects, in particular from soil and foliar insects, said method comprising contacting the seeds before sowing and/or after pregermination with a compound of the general formula I or a salt thereof. Particularly preferred is a method, wherein the plant's roots and shoots are protected, more preferably a method, wherein the plants shoots are protected form piercing and sucking insects, most preferably a method, wherein the plants shoots are protected from aphids.

The term seed embraces seeds and plant propagules of all kinds including but not limited to true seeds, seed pieces, suckers, corms, bulbs, fruit, tubers, grains, cuttings, cut shoots and the like and means in a preferred embodiment true seeds.

The term seed treatment comprises all suitable seed treatment techniques known in the art, such as seed dressing, seed coating, seed dusting, seed soaking and seed pelleting, and infurrow application methods.

Preferably, the seed treatment application of the active compound is carried out by spraying or by dusting the seeds before sowing of the plants and before emergence of the plants.

Also preferably, the seed treatment application is carried out by seed dressing or seed coating;

Also preferably, the seed treatment application is carried out by seed soaking or seed pelleting;

Also preferably, the seed treatment application is carried out by in-furrow application methods;

The present invention also comprises seeds coated with or containing the active compound.

The term “coated with and/or containing” generally signifies that the active ingredient is for the most part on the surface of the propagation product at the time of application, although a greater or lesser part of the ingredient may penetrate into the propagation product, depending on the method of application. When the said propagation product is (re)planted, it may absorb the active ingredient.

Suitable seed is seed of soybean, corn, canola, cereals, sugarbeet, cotton, peanut, or potato.

In addition, the active compound may also be used for the treatment seeds from plants, which tolerate the action of herbicides or fungicides or insecticides owing to breeding, including genetic engineering methods.

For example, the active compound can be employed in treatment of seeds from plants, which are resistant to herbicides from the group consisting of the sulfonylureas, imidazolinones, glufosinate-ammonium or glyphosate-isopropylammonium and analogous active substances (see for example, EP-A-0242236, EP-A-242246) (WO 92/00377) (EP-A-0257993, U.S. Pat. No. 5,013,659) or in transgenic crop plants, for example cotton, with the capability of producing Bacillus thuringiensis toxins (Bt toxins) which make the plants resistant to certain pests (EP-A0142924, EP-A-0193259),

Furthermore, the active compound can be used also for the treatment of seeds from plants, which have modified characteristics in comparison with existing plants consist, which can be generated for example by traditional breeding methods and/or the generation of mutants, or by recombinant procedures). For example, a number of cases have been described of recombinant modifications of crop plants for the purpose of modifying the starch synthesized in the plants (e.g. WO 92/11376, WO 92/14827, WO 91/19806) or of transgenic crop plants having a modified fatty acid composition (WO 91/13972).

The seed treatment application of the active compound is preferably carried out by spraying or by dusting the seeds before sowing of the plants and before emergence of the plants.

Compositions which are especially useful for seed treatment are e.g.:

A Soluble concentrates (SL, LS)

D Emulsions (EW, EO, ES)

E Suspensions (SC, OD, FS)

F Water-dispersible granules and water-soluble granules (WG, SG)

G Water-dispersible powders and water-soluble powders (WP, SP, WS)

H Gel-Formulations (GF)

I Dustable powders (DP, DS)

Conventional seed treatment formulations include for example flowable concentrates FS, solutions LS, powders for dry treatment DS, water dispersible powders for slurry treatment WS, water-soluble powders SS and emulsion ES and EC and gel formulation GF. These formulations can be applied to the seed diluted or undiluted. Application to the seeds is carried out before sowing, either directly on the seeds or after having pregerminated the latter

The active substance concentrations in ready-to-use formulations, which may be obtained after two-to-tenfold dilution, are preferably from 0.01 to 60% by weight, more preferably from 0.1 to 40% by weight.

In a preferred embodiment a FS formulation is used for seed treatment. Typically, a FS formulation may comprise 1-800 g/l of active ingredient, 1-200 g/I Surfactant, 0 to 200 g/I antifreezing agent, 0 to 400 g/l of binder, 0 to 200 g/l of a pigment and up to 1 liter of a solvent, preferably water.

Especially preferred FS formulations of compounds of formula I for seed treatment usually comprise from 0.1 to 80% by weight (1 to 800 g/l) of the active ingredient, from 0.1 to 20% by weight (1 to 200 g/l) of at least one surfactant, e.g. 0.05 to 5% by weight of a wetter and from 0.5 to 15% by weight of a dispersing agent, up to 20% by weight, e.g. from 5 to 20% of an anti-freeze agent, from 0 to 15% by weight, e.g. 1 to 15% by weight of a pigment and/or a dye, from 0 to 40% by weight, e.g. 1 to 40% by weight of a binder (sticker/adhesion agent), optionally up to 5% by weight, e.g. from 0.1 to 5% by weight of a thickener, optionally from 0.1 to 2% of an anti-foam agent, and optionally a preservative such as a biocide, antioxidant or the like, e.g. in an amount from 0.01 to 1% by weight and a filler/vehicle up to 100% by weight.

Seed Treatment formulations may additionally also comprise binders and optionally colorants. Binders can be added to improve the adhesion of the active materials on the seeds after treatment. Suitable binders are homo- and copolymers from alkylene oxides like ethylene oxide or propylene oxide, polyvinylacetate, polyvinylalcohols, polyvinylpyrrolidones, and copolymers thereof, ethylene-vinyl acetate copolymers, acrylic homo- and copolymers, polyethyleneamines, polyethyleneamides and polyethyleneimines, polysaccharides like celluloses, tylose and starch, polyolefin homo- and copolymers like olefin/maleic anhydride copolymers, polyurethanes, polyesters, polystyrene homo and copolymers

Optionally, also colorants can be included in the formulation. Suitable colorants or dyes for seed treatment formulations are Rhodamin B, C.I. Pigment Red 112, C.I. Solvent Red 1, pigment blue 15:4, pigment blue 15:3, pigment blue 15:2, pigment blue 15:1, pigment blue 80, pigment yellow 1, pigment yellow 13, pigment red 112, pigment red 48:2, pigment red 48:1, pigment red 57:1, pigment red 53:1, pigment orange 43, pigment orange 34, pigment orange 5, pigment green 36, pigment green 7, pigment white 6, pigment brown 25, basic violet 10, basic violet 49, acid red 51, acid red 52, acid red 14, acid blue 9, acid yellow 23, basic red 10, basic red 108.

Examples of a Gelling Agent is Carrageen (Satiagel®)

In the treatment of seed, the application rates of the compounds I are generally from 0.1 g to 10 kg per 100 kg of seed, preferably from 1 g to 5 kg per 100 kg of seed, more preferably from 1 g to 1000 g per 100 kg of seed and in particular from 1 g to 200 g per 100 kg of seed.

The invention therefore also relates to seed comprising a compound of the formula I, or an agriculturally useful salt of 1, as defined herein. The amount of the compound I or the agriculturally useful salt thereof will in general vary from 0.1 g to 10 kg per 100 kg of seed, preferably from 1 g to 5 kg per 100 kg of seed, in particular from 1 g to 1000 g per 100 kg of seed. For specific crops such as lettuce the rate can be higher.

In another embodiment of the present invention, the mixtures comprise the compound of formula (I) and two agriculturally active components (active compound and active compound Ill) selected from the insecticides and fungicides listed above.

In another embodiment of the present invention, the mixtures comprise the compound of formula (I) and one insecticide (active compound II) and one fungicide (active compound Ill) selected from the insecticides and fungicides listed above.

In another embodiment of the present invention, the mixtures comprise the compound of formula (I) and one insecticide (active compound II) and another insecticide (active compound Ill) selected from the insecticides listed above.

In another embodiment of the present invention, the mixtures comprise compound of formula (I) and two fungicides or two insecticides.

### EXAMPLES

The present invention is now illustrated in further details by the following example, without imposing any limitation thereto.

The compound of formula (I) was prepared by method analogical to the method as disclosed in WO2014/167084.

The compound of formula I-R-1 was prepared by method as described herein in the description.

Analytical data of the compound I (racemic) and I-R-1 are provided in the table below.

| compond | structure | | ¹H NMR conditions | ¹H NMR data |
|---|---|---|---|---|
| Compond (I) | 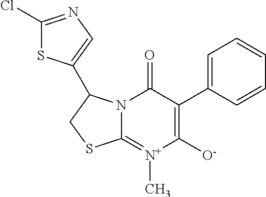 [SMILES: C[n+]1c([O-])c(-c2ccccc2)c(=O)n2c1SCC2c1cnc(Cl)s1] | (I) | ¹H- NMR(CDCL3/ppm/ 400 MHz) | 7.72(s, 1H), 7.65(d, 2H), 7.32(t, 2H), 7.16(t, 1H), 6.47(d, 1H), 4.1(dd, 1H), 3.58(d, 1H), 3.52(s, 3H) |
| Compond (I-R-1) | 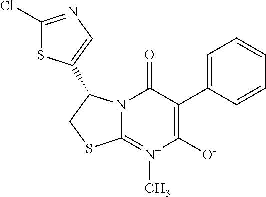 [SMILES: C[n+]1c([O-])c(-c2ccccc2)c(=O)n2c1SC[C@@H]2c1cnc(Cl)s1] | (I-R-1) | ¹H NMR (300 MHz, DMSO-d6) | 3.42(s, 3H), 3.94(d, J = 12 Hz, 1H), 4.25-4.32(m, 1H), 6.48 (d, J = 8.1 Hz, 1H), 7.06-7.11(m, 1H), 7.21-7.26(m, 2H), 7.6(d, J = 7.5 Hz, 1H), 7.96(s, 1H). |

Test compound I-R-1 used in below biological examples is in 95% enantiomeric excess unless otherwise specified.

1. Canola-Striped Flea Beetle (Phyllotreta striolata)

Canola seed treatment: Formulation was diluted in water to make appropriate concentration according to needs. Canola seeds with pre-coating inert ingredients were treated with diluted solution by vortex methods. Treated seeds were dried in ventilating chemical hood. After dry, three seeds were planted per pot (2×2 inch) at a depth of 1 cm, which were filled with Patio sand and watered prior to treatment and planting. The pots were arranged in a completely randomized design, kept in the greenhouse, and automatically top-watered and fertilized daily (NPK 16-4-20-3(Ca)-1(Mg)). At the cotyledon stage [˜7 days after treatment (DAT)], plants were thinned to 1 plant per pot. One set of plants was infested at the cotyledon stage and another set at the first true-leaf stage. Both cotyledons of a single plant were excised, and true leaves were sampled using a ⅝″ (1.59-cm) diameter leaf disc. Leaf samples were placed on a piece of 47-mm filter paper moistened with 0.225 mL distilled water in a 50-mm Petri dish. Five flea beetles were then infested into the petri dish. The dishes were held in an incubator at 27° C., 60% RH, and a 16L:8D light cycle. Five days after infestation (DAI), the numbers of live, moribund, and dead flea beetles were recorded, as well as % feeding damage (via visual estimate). Moribund was classified as the insect unable to right itself within 5 minutes of being placed on its backside. Percent mortality was calculated for each treatment, with moribund insects classified as alive. Student-Newman-Keuls (α=0.05) was used for statistical analysis, and treatments with the same letter in the table were not significantly different.

TABLE 1
Potency of Compound I-R-1 against flea beetle, Phyllotreta
striolata, at cotyledon stage through canola seed treatment method

| | | Mean % feed- | Mean % Feeding |
|---|---|---|---|
| | | ing damage | Damage Reduction |
| Compound | Rate | (5DAI, 13DAP) | Relative to SB |
| Solvent blank | — | 45^{a} | — |
| Compound I-R-1 | 400 | 19^{b} | 58 |
| (300 g ai/L) | | | |

Summary: Experimental data (Table 1) suggests that there was significant difference between treatment and solvent control.

2. Cereals—Barley-Bird Cherry Oat Aphid (Rhopalosiphum padi)

Barley seed treatment: Technical material was dissolved in DMSO. Twenty barely seeds were treated with a vortex method and planted in a pot (2×2 inch) filled with Rediearth soil. One seed was planted per pot and the pots were arranged in a completely randomized design, held in the greenhouse, and top-watered and fertilized daily. Four seedlings were taken from each cotyledon & true leaf treatment samples. DMSO solvent blank were used as positive and negative treatments, respectively. The true leaf stage was infested 14 days after planting (DAP). Ten bird cherry-oat aphids of mixed stages were transferred individually to each plant with a paint brush. Six replicates were set up for each treatment. After infestation, plants were kept on a light cart at room temperature and bottom watered until evaluated. The number of live aphids at 4 days after infestation (4DAI) was recorded, and means were calculated for each treatment. Percent control was calculated as the percent reduction in live aphids relative to the solvent blank.

TABLE 2
Efficacy of Compound I-R-1 against bird cherry
oat aphid, Rhopalosiphum padi, at the
first true leaf stage through barley seed treatment

| | Rate (g ai/ | Mean % Population |
|---|---|---|
| Compound | 100 kg seed) | Reduction (18 DAP, 4DAI) |
| Compound | 100 | ≥90 |
| I-R-1 | | |

Summary: Experimental data (Table 2) suggests that there was a good dose-response relationship when the application rate of Compound I-R-1 was 100 g ai/100 kg seeds.

3. Sugarbeet-Green Peach Aphid (Myzus persicae (Sulzer))

Sugarbeet seed treatment: Seeds were treated in according to desired rates. Seeds were planted (one per pot) at a depth of 1.5 cm in 3×3 in (58.0644 cm2) pots that were filled with RediEarth soil and moistened prior to planting. Pots were held in a completely randomized design in the greenhouse and automatically top watered and fertilized [NPK 16-4-20-3(Ca)-1(Mg)] daily (4 min, 4× a day) until infestation. A set of plants was infested 7, 14, 21 and 28 days after treatment (DAT). Thirty aphids were transferred individually to each plant with a paint brush. After infestation, plants were kept on a light cart at room temperature with continuous light and bottom watered until evaluation. Six days after infestation (DAI), the number of live aphids was recorded, and means were calculated for each treatment. Percent control was calculated as the percent reduction in live aphids relative to the solvent blank.

TABLE 3
Potency of Compound I-R-1 against green peach aphid,
Myzus persicae, through sugar beet seed treatment

| | | 7 DAP | 14 DAP | 21 DAP | 28 DAP |
|---|---|---|---|---|---|
| | | Mean % | Mean % | Mean % | Mean % |
| | | Population | Population | Population | Population |
| | Rate | Reduction | Reduction | Reduction | Reduction |
| | (g ai/ | Relative to | Relative to | Relative to | Relative to |
| Com- | 1 kg | SB @ | SB @ | SB @ | SB @ |
| pound | seed) | 6DAI | 6DAI | 6DAI | 6DAI |
| Com- | 80 | 100 | ≥90 | ≥90 | ≥90 |
| pound | | | | | |
| I-R-1 | | | | | |

Summary: Experimental data (Table 3) suggests that Compound I-R-1 displayed excellent activity against green peach aphid by sugarbeet seed treatment. As far as 4 weeks after plant, the compound I-R-1 still could provide excellent activity.

4. Soybean—Lesser Corn Stalkborer (Elasmopalpus sp.)

Soybean seed treatment: Soybean seeds were treated with Compound I-R-1. The treated seeds were sown inside an enclosed cage, in two lines at 29 seeds/cage. Thirty-five 3^{rd} instar larvae of Elasmopalpus sp were introduced into each cage at six days after sowing. The number of dead and live plants were counted periodically. Values followed by the same letter within each assessment date are not significantly different (α=0.05) using LSD.

TABLE 4
Efficacy of Compound I-R-1 against lesser corn stalkborer,
Elasmopalpus sp, through soybean seed treatment

| | | Number of dead plants/plot | | | |
|---|---|---|---|---|---|
| | Rate | A03 | A07 | A14 | A21 |
| CHECK | — | 4.25 a | 9.50 a | 12.25 a | 12.75a |
| Compound | 50 g | 1.50 a | 4.50 ab | 5.25 b | 6.75 b |
| I-R-1 | ai/ha | | | | |

Summary: The trial data (Table 4) indicates that Compound I-R-1 showed good efficacy against the Elasmopalpus sp. in terms of plant protection.

5. Corn—Green Belly Stink Bug (Dichelops meiacanthus)

Corn seed treatment: Corn seeds were treated with Compound I-R-1. The treated seeds were sown inside an enclosed cage, at 16 seeds/cage. Twenty-four stinkbugs, were introduced into each cage. The number of dead and live stinkbugs were counted periodically. Values followed by the same letter within each assessment date are not significantly different (α=0.05) using LSD.

TABLE 5
Efficacy of Compound l-R-1 against green belly stink bug,
Dichelops melacanthus, through corn seed treatment

| | Rate | Percentage mortality (%) | | | | |
|---|---|---|---|---|---|---|
| | g ai/ha | A01 | A03 | A07 | A14 | A21 |
| Compound l-R-1 | 30.0 | 5.4 a | 24.6 c | 13 b | 35.3 ab | 61.5 a |

Summary: Compound I-R-1 showed good efficacy against green belly stink bug as a corn seed treatment (Table 5).

6. Cotton—Tobacco Thrips (Frankliniella fusca)

Cotton seed treatment: Field studies were carried out against tobacco thrips using cotton seeds treated with 0.375 mg ai/seed of Compound I-R-1. Treated Seeds were sown in 30 sq m plots. There were 4 replications for each treatment. Feeding damage was assessed at 5 and 7 days after planting (DAP). Values followed by the same letter within each assessment date are not significantly different (α=0.05) using LSD.

TABLE 6
Efficacy of Compound I-R-1 against tobacco thrips,
Frankliniella fusca, through cotton seed treatment

| | | Feeding damage (%) | |
|---|---|---|---|
| | Rate | 5 DAP | 7 DAP |
| Check | — | 12.0 a | 50.0 a |
| Compound | 0.375 mg | 6.0 b | 12.5 c |
| I-R-1 | ai/seed | | |

Summary: Compound I-R-1 showed excellent efficacy against F. fusca as a seed treatment in terms of reduction in feeding damage (Table 6).

7. Peanut—Tobacco Thrips (Frankliniella fusca)

Peanut seed treatment: Field trials were laid out. Treated peanut seeds were sown in 8 sq m plots using 4 replications. Feeding damage was assessed at 28 and 35 days after treatment. Values followed by the same letter within each assessment date are not significantly different (α=0.05) using LSD.

TABLE 7
Efficacy of Compound I-R-1 against tobacco thrips,
Frankliniella fusca, through peanut seed treatment

| | | Feeding damage (%) | |
|---|---|---|---|
| | Rate | A28 | A35 |
| Check | — | 23.3 a | 20.0 a |
| Compound I-R-1 | 0.68 mg ai/seed | 13.0 b | 13.5 b |

Summary: Compound I-R-1 showed good efficacy against F. fusca as a peanut seed treatment in terms of reduction in feeding damage (Table 7).

8. Potato—Colorado Potato Beetle (Leptinotarsa decimlineata) Potato seed piece treatment: Seed potatoes were treated by spraying. After application, potatoes were allowed to dry prior to planting. The plots were laid out in 6-meter rows with 4 replications. Feeding damage assessments were taken at 42 and 50 days after planting. Values followed by the same letter within each assessment date are not significantly different (α=0.05) using LSD.

TABLE 8
Efficacy of Compound I-R-1 against Colorado Potato beetle,
Leptinotarsa decimlineata, as a potato seed piece treatment

| | | Feeding damage | |
|---|---|---|---|
| | Rate | A42 | A50 |
| Check | — | 6.5 a | 32.5 a |
| Compound I-R-1 | 400 g ai/ha | 3.0 b | 11.3 bc |

Summary: Compound I-R-1 showed good efficacy against L. decimlineata as a seed piece treatment regarding to reduction in feeding damage.

The present invention is now illustrated in further details by the following example of mixture of I-R-1 and other mixing partners, without imposing any limitation thereto.

### REFERENCE

Colby Equation:

The presence of a synergistic effect in terms of percent control, between two mixing partners (X and Y) can be calculated using the Colby equation (Colby, S. R., 1967, Calculation Synergistic and Antagonistic Responses in Herbicide Combinations, Weeds, 15, 20-22):

E=X+Y−XY/100

When the observed combined control effect is greater than the expected combined control effect (E), then the combined effect is synergistic.

### Methods:

9. Barley Seed Treatment Against Rhopalosiphum padi (RHOPPA):

Sub-lethal rates were predetermined by rate rundown. Formulations were combined and diluted in water and applied to barley seeds which were allowed to dry. Seeds were then planted and grown in a greenhouse. At the cotyledon stage, bird cherry-oat aphids (Rhopalosiphum padi) of mixed stages were infested onto each plant and held under laboratory conditions. Replication was 6×. Four days after infestation, the number of live aphids on each plant was recorded, and means were calculated for each treatment. Percent control was calculated as the percent reduction in live aphids relative to the solvent blank (Sun-Shepard method). Synergistic effects were calculated based on aphid population reduction using the Colby Equation 1.

Results:

TABLE 1
Synergistic interaction of compound I-R-1 with 1-(1,2-dimethylpropyl)-
N-ethyl-5-methyl-N-pyridazin-4-yl-pyrazole-4-carboxamide (Dimpro-
pyridaz) on population reduction of Rhopalosiphum padi (RHOPPA)

| | | | | | Combination | | |
|---|---|---|---|---|---|---|---|
| | Solo application | | | | compound | | |
| | compound | | | | I-R-1 + | | |
| | I-R-1 | | Dimpropyridaz | | Dimpyropyridaz | | |
| | Use | | Use | | Use | | |
| | rate | | rate (g | | rate | | COLBY |
| | (g ai/ | % | ai/100 | % | (g ai/ | % | Expected |
| | 100 kg | act- | kg | act- | 100 kg | ac- | % |
| Pest | seeds) | ivity | seeds) | ivity | seeds) | tivity | activity |
| ROPPA | 14 | 59 | 46 | 11 | 14 +46 | 72 | 63 |
| ROPPA | 5 | 46 | 18 | 5 | 5+ 18 | 54 | 49 |

Data (Table 1) suggested that a combination of compound I-R-1 and dimpropyridaz at a rate of 14+46 or 5+5 (g ai/100 kg seeds) could show a synergistic effect on reduction of ROPPA population on barley through seed treatment.

TABLE 2
Synergistic interaction of compound l-R-1 with Flupyradifurone
on population reduction of Rhopalosiphum padi (RHOPPA)

| | | | | | Combination | | |
|---|---|---|---|---|---|---|---|
| | Solo application | | | | compound | | |
| | compound | | | | I-R-1 + | | |
| | I-R-1 | | Flupyradifurone | | Flupyradifurone | | |
| | Use | | Use | | Use | | |
| | rate | | rate (g | | rate | | COLBY |
| | (g ai/ | % | ai/100 | % | (g ai/ | % | Expected |
| | 100 kg | act- | kg | act- | 100 kg | ac- | % |
| Pest | seeds) | ivity | seeds) | ivity | seeds) | tivity | activity |
| ROPPA | 5 | 46 | 21 | 36 | 5 +21 | 80 | 66 |

Data (Table 2) suggested that a combinations of compound I-R-1 and flupyradifurone at a rate of 5+21 (g ai/100 kg seeds) could show a synergistic effect on reduction of ROPPA population on barley through seed treatment.

10. Cotton Seed Treatment Against Frankliniella Occidentalis (FRANOC):

Sub-lethal rates were predetermined by rate rundown. Formulations were combined and diluted in water and applied to cotton seeds which were allowed to dry. Seeds were then planted and grown in a greenhouse. At the cotyledon stage, western flower thrips (Frankliniella occidentalis) adults were infested onto each plant and held under laboratory conditions. Replication was 5×. Seven and 14 days after infestation, percent damage was visually assessed, and means were calculated for each treatment. Percent control was calculated as the percent reduction in live aphids relative to the solvent blank (Sun-Shepard method). Synergistic effects were calculated based on aphid population reduction using the Colby Equation 1.

TABLE 3
Synergistic interaction of compound I-R-1 with thiamethoxam on
feeding damage reduction of Frankliniella occidentalis
(FRANOC) at 7DAI.

| | | | | | Combination | | |
|---|---|---|---|---|---|---|---|
| | Solo application | | | | compound | | |
| | compound | | | | I-R-1 + | | |
| | I-R-1 | | thiamethoxam | | thiamethoxam | | |
| | Use | | Use | | Use | | |
| | rate | | rate (g | | rate | | COLBY |
| | (g ai/ | % | ai/100 | % | (g ai/ | % | Expected |
| | 100 kg | act- | kg | act- | 100 kg | ac- | % |
| Pest | seeds) | ivity | seeds) | ivity | seeds) | tivity | activity |
| FRA- | 0.375 | 19 | 0.300 | 37 | 0.375 | 56 | 49 |
| NOC | | | | | +0.300 | | |

Data (Table 3) showed that a combination of compound I-R-1 with thiamethoxam at a rate of 0.375+0.300 mg ai/seed could display a synergistic effect on feeding damage reduction of FRANOC through cotton seed treatment.

1. (canceled)

2. The method according to claim 8, wherein the compound of formula I is non-racemic.

3. The method according to claim 8, wherein the compound of formula I is with enantiomeric excess of compound I-R-1.

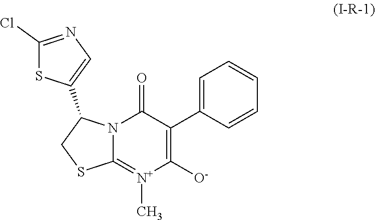 [SMILES: C[n+]1c([O-])c(-c2ccccc2)c(=O)n2c1SC[C@@H]2c1cnc(Cl)s1]

4. The method according to claim 3, wherein the compound of formula I is with at least 90% enantiomeric excess of the compound I-R-1.

5. The method according to claim 3, wherein the compound of formula I is the compound I-R-1.

6. The method according to claim 8, wherein in the compound of formula I is combined and/or applied together with at least one other pesticidally active compound selected from the groups consisting of:
M.1 Acetylcholine esterase (AChE) inhibitors: M.1A carbamates, e.g. aldicarb, alanycarb, bendiocarb, benfuracarb, butocarboxim, butoxycarboxim, carbaryl, carbofuran, carbosulfan, ethiofencarb, fenobucarb, formetanate, furathiocarb, isoprocarb, methiocarb, methomyl, metolcarb, oxamyl, pirimicarb, propoxur, thiodicarb, thiofanox, trimethacarb, XMC, xylylcarb and triazamate; or M.1B organophosphates, e.g. acephate, azamethiphos, azinphos-ethyl, azinphosmethyl, cadusafos, chlorethoxyfos, chlorfenvinphos, chlormephos, chlorpyrifos, chlorpyrifos-methyl, coumaphos, cyanophos, demeton-S-methyl, diazinon, dichlorvos/DDVP, dicrotophos, dimethoate, dimethylvinphos, disulfoton, EPN, ethion, ethoprophos, famphur, fenamiphos, fenitrothion, fenthion, fosthiazate, heptenophos, imicyafos, isofenphos, isopropyl O-(methoxyaminothio-phosphoryl) salicylate, isoxathion, malathion, mecarbam, methamidophos, methidathion, mevinphos, monocrotophos, naled, omethoate, oxydemeton-methyl, parathion, parathion-methyl, phenthoate, phorate, phosalone, phosmet, phosphamidon, phoxim, pirimiphos-methyl, profenofos, propetamphos, prothiofos, pyraclofos, pyridaphenthion, quinalphos, sulfotep, tebupirimfos, temephos, terbufos, tetrachlorvinphos, thiometon, triazophos, trichlorfon, and vamidothion;
M.2. GABA-gated chloride channel antagonists: M.2A cyclodiene organochlorine compounds, e.g. endosulfan or chlordane; or M.2B fiproles (phenyl-pyrazoles), e.g. ethiprole, fipronil, flufiprole, pyrafluprole, and pyriprole;
M.3 Sodium channel modulators from the class of M.3A pyrethroids, e.g. acrinathrin, allethrin, d-cis-trans allethrin, d-trans allethrin, bifenthrin (in particular kappa-bifenthrin), bioallethrin, bioallethrin S-cylclopentenyl, bioresmethrin, cycloprothrin, cyfluthrin, beta-cyfluthrin, cyhalothrin, lambda-cyhalothrin, gamma-cyhalothrin, cypermethrin, alpha-cypermethrin, beta-cypermethrin, theta-cypermethrin, zeta-cypermethrin, cyphenothrin, deltamethrin, empenthrin, esfenvalerate, etofenprox, fenpropathrin, fenvalerate, flucythrinate, flumethrin, tau-fluvalinate, halfenprox, heptafluthrin, imiprothrin, meperfluthrin, metofluthrin, momfluorothrin (in particular epsilon-momfluorothrin), permethrin, phenothrin, prallethrin, profluthrin, pyrethrin (pyrethrum), resmethrin, silafluofen, tefluthrin (in particular kappa-tefluthrin), tetramethylfluthrin, tetramethrin, tralomethrin, and transfluthrin; or M.3B sodium channel modulators such as DDT or methoxychlor;
M.4 Nicotinic acetylcholine receptor agonists (nAChR): M.4A neonicotinoids, e.g. acetamiprid, clothianidin, cycloxaprid, dinotefuran, imidacloprid, nitenpyram, thiacloprid and thiamethoxam; or the compounds M.4A.14,5-Dihydro-N-nitro-1-(2-oxiranylmethyl)-1H-imidazol-2-amine, M.4A.2: (2E-)-1-[(6-Chloropyridin-3-yl)methyl]-N′-nitro-2-pentylidenehydrazinecarboximidamide; or M4.A.3: 1-[(6-Chloropyridin-3-yl)methyl]-7-methyl-8-nitro-5-propoxy-1,2,3,5,6,7-hexahydroimidazo[1,2-a]pyridine; or M.4B nicotine; M.4C sulfoxaflor; M.4D flupyradifurone; M.4E triflumezopyrim;
M.5 Nicotinic acetylcholine receptor allosteric activators: spinosyns, e.g. spinosad or spinetoram;
M.6 Chloride channel activators from the class of avermectins and milbemycins, e.g. abamectin, emamectin benzoate, ivermectin, lepimectin, or milbemectin;
M.7 Juvenile hormone mimics, such as M.7A juvenile hormone analogues hydroprene, kinoprene, and methoprene; or M.7B fenoxycarb, or M.7C pyriproxyfen;
M.8 miscellaneous non-specific (multi-site) inhibitors, e.g. M.8A alkyl halides as methyl bromide and other alkyl halides, M.8B chloropicrin, M.8C sulfuryl fluoride, M.8D borax, or M.8E tartar emetic;
M.9 Chordotonal organ TRPV channel modulators, e.g. M.9B pymetrozine; pyrifluquinazon;
M.10 Mite growth inhibitors, e.g. M.10A clofentezine, hexythiazox, and diflovidazin, or M.10B etoxazole;
M.12 Inhibitors of mitochondrial ATP synthase, e.g. M.12A diafenthiuron, or M.12B organotin miticides such as azocyclotin, cyhexatin, or fenbutatin oxide, M.12C propargite, or M.12D tetradifon;
M.13 Uncouplers of oxidative phosphorylation via disruption of the proton gradient, e.g. chlorfenapyr, DNOC, or sulfluramid;
M.14 Nicotinic acetylcholine receptor (nAChR) channel blockers, e.g. nereistoxin analogues bensultap, cartap hydrochloride, thiocyclam, or thiosultap sodium;
M.15 Inhibitors of the chitin biosynthesis type 0, such as benzoylureas e.g. bistrifluron, chlorfluazuron, diflubenzuron, flucycloxuron, flufenoxuron, hexaflumuron, lufenuron, novaluron, noviflumuron, teflubenzuron, or triflumuron;
M.16 Inhibitors of the chitin biosynthesis type 1, e.g. buprofezin;
M.17 Moulting disruptors, Dipteran, e.g. cyromazine;
M.18 Ecdyson receptor agonists such as diacylhydrazines, e.g. methoxyfenozide, tebufenozide, halofenozide, fufenozide, or chromafenozide;
M.19 Octopamin receptor agonists, e.g. amitraz;
M.20 Mitochondrial complex Ill electron transport inhibitors, e.g. M.20A hydramethylnon, M.20B acequinocyl, M.20C fluacrypyrim; or M.20D bifenazate;
M.21 Mitochondrial complex I electron transport inhibitors, e.g. M.21A METI acaricides and insecticides such as fenazaquin, fenpyroximate, pyrimidifen, pyridaben, tebufenpyrad or tolfenpyrad, or M.21B rotenone;
M.22 Voltage-dependent sodium channel blockers, e.g. M.22A indoxacarb, M.22B metaflumizone, or M.22B.1: 2-[2-(4-Cyanophenyl)-1-[3-(trifluoromethyl)phenyl]ethylidene]-N-[4-(difluoromethoxy)phenyl]-hydrazinecarboxamide or M.22B.2: N-(3-Chloro-2-methylphenyl)-2-[(4-chlorophenyl)[4-[methyl(methylsulfonyl)amino]phenyl]methylene]-hydrazinecarboxamide;
M.23 Inhibitors of the of acetyl CoA carboxylase, such as Tetronic and Tetramic acid derivatives, e.g. spirodiclofen, spiromesifen, or spirotetramat; M.23.1 spiropidion
M.24 Mitochondrial complex IV electron transport inhibitors, e.g. M.24A phosphine such as aluminium phosphide, calcium phosphide, phosphine or zinc phosphide, or M.24B cyanide;
M.25 Mitochondrial complex II electron transport inhibitors, such as beta-ketonitrile derivatives, e.g. cyenopyrafen or cyflumetofen;
M.28 Ryanodine receptor-modulators from the class of diamides, e.g. flubendiamide, chlorantraniliprole, cyantraniliprole, tetraniliprole, M.28.1: (R)-3-Chlor-N1-{2-methyl-4-[1,2,2,2-tetrafluoro-1-(trifluoromethyl)ethyl]phenyl}-N2-(1-methyl-2-methylsulfonylethyl)phthalamid, M.28.2: (S)-3-Chloro-N1-{2-methyl-4-[1,2,2,2-tetrafluoro-1-(trifluoromethyl)ethyl]phenyl}-N2-(1-methyl-2-methylsulfonylethyl)phthalamid, M.28.3: cyclaniliprole, or M.28.4: 1 methyl-2-[3,5-dibromo-2-({[3-bromo-1-(3-chlorpyridin-2-yl)-1H-pyrazol-5-yl]carbonyl}amino)benzoyl]-1,2-dimethylhydrazinecarboxylate; or M.28.5a) N-[4,6-dichloro-2-[(diethyl-lambda-4-sulfanylidene)carbamoyl]-phenyl]-2-(3-chloro-2-pyridyl)-5-(trifluoromethyl)pyrazole-3-carboxamide; M.28.5b) N-[4-chloro-2-[(diethyl-lambda-4-sulfanylidene)carbamoyl]-6-methyl-phenyl]-2-(3-chloro-2-pyridyl)-5-(trifluoromethyl)pyrazole-3-carboxamide; M.28.5c) N-[4-chloro-2-[(di-2-propyl-lambda-4-sulfanylidene)carbamoyl]-6-methyl-phenyl]-2-(3-chloro-2-pyridyl)-5-(trifluoromethyl)pyrazole-3-carboxamide; M.28.5d) N-[4,6-dichloro-2-[(di-2-propyl-lambda-4-sulfanylidene)carbamoyl]-phenyl]-2-(3-chloro-2-pyridyl)-5-(trifluoromethyl)pyrazole-3-carboxamide; M.28.5h) N-[4,6-dibromo-2-[(diethyl-lambda-4-sulfanylidene)carbamoyl]-phenyl]-2-(3-chloro-2-pyridyl)-5-(trifluoromethyl)pyrazole-3-carboxamide; M.28.5i) N-[2-(5-Amino-1,3,4-thiadiazol-2-yl)-4-chloro-6-methylphenyl]-3-bromo-1-(3-chloro-2-pyridinyl)-1H-pyrazole-5-carboxamide; M.28.5j) 3-Chloro-1-(3-chloro-2-pyridinyl)-N-[2,4-dichloro-6-[[(1-cyano-1-methylethyl)amino]carbonyl]phenyl]-1H-pyrazole-5-carboxamide; M.28.5k) 3-Bromo-N-[2,4-dichloro-6-(methylcarbamoyl)phenyl]-1-(3,5-dichloro-2-pyridyl)-1H-pyrazole-5-carboxamide; M.28.5l) N-[4-Chloro-2-[[(1,1-dimethylethyl)amino]carbonyl]-6-methylphenyl]-1-(3-chloro-2-pyridinyl)-3-(fluoromethoxy)-1H-pyrazole-5-carboxamide; or
M.28.6: cyhalodiamide; or
M.29: Chordotonal organ Modulators—undefined target site, e.g. flonicamid;
M.UN. insecticidal active compounds of unknown or uncertain mode of action, e.g. afidopyropen, afoxolaner, azadirachtin, amidoflumet, benzoximate, broflanilide, bromopropylate, chinomethionat, cryolite, dicloromezotiaz, dicofol, flufenerim, flometoquin, fluensulfone, fluhexafon, fluopyram, fluralaner, metoxadiazone, piperonyl butoxide, pyflubumide, pyridalyl, tioxazafen, M.UN.3: 11-(4-chloro-2,6-dimethylphenyl)-12-hydroxy-1,4-dioxa-9-azadispiro[4.2.4.2]-tetradec-11-en-10-one,
M.UN.4: 3-(4′-fluoro-2,4-dimethylbiphenyl-3-yl)-4-hydroxy-8-oxa-1-azaspiro[4.5]dec-3-en-2-one,
M.UN.5: 1-[2-fluoro-4-methyl-5-[(2,2,2-trifluoroethyl)sulfinyl]phenyl]-3-(trifluoromethyl)-1H-1,2,4-triazole-5-amine, or actives on basis of Bacillus firmus (Votivo, 1-1582);
M.UN.6: flupyrimin;
M.UN.8: fluazaindolizine; M.UN.9.a): 4-[5-(3,5-dichlorophenyl)-5-(trifluoromethyl)-4H-isoxazol-3-yl]-2-methyl-N-(1-oxothietan-3-yl)benzamide; M.UN.9.b): fluxametamide; M.UN.10: 5-[3-[2,6-dichloro-4-(3,3-dichloroallyloxy)phenoxy]propoxy]-1H-pyrazole;
M.UN.11.b) 3-(benzoylmethylamino)-N-[2-bromo-4-[1,2,2,3,3,3-hexafluoro-1-(trifluoromethyl)propyl]-6-(trifluoromethyl)phenyl]-2-fluoro-benzamide; M.UN.11.c) 3-(benzoylmethylamino)-2-fluoro-N-[2-iodo-4-[1,2,2,2-tetrafluoro-1-(trifluoromethyl)ethyl]-6-(trifluoromethyl)phenyl]-benzamide; M.UN.11.d) N-[3-[[[2-iodo-4-[1,2,2,2-tetrafluoro-1-(trifluoromethyl)ethyl]-6-(trifluoromethyl)phenyl]amino]carbonyl]phenyl]-N-methyl-benzamide; M.UN.11.e) N-[3-[[[2-bromo-4-[1,2,2,2-tetrafluoro-1-(trifluoromethyl)ethyl]-6-(trifluoromethyl)phenyl]amino]carbonyl]-2-fluoro-phenyl]-4-fluoro-N-methyl-benzamide; M.UN.11.f) 4-fluoro-N-[2-fluoro-3-[[[2-iodo-4-[1,2,2,2-tetrafluoro-1-(trifluoromethyl)ethyl]-6-(trifluoromethyl)phenyl]amino]carbonyl]phenyl]-N-methyl-benzamide; M.UN.11.g) 3-fluoro-N-[2-fluoro-3-[[[2-iodo-4-[1,2,2,2-tetrafluoro-1-(trifluoromethyl)ethyl]-6-(trifluoromethyl)phenyl]amino]carbonyl]phenyl]-N-methyl-benzamide; M.UN.11.h) 2-chloro-N-[3-[[[2-iodo-4-[1,2,2,2-tetrafluoro-1-(trifluoromethyl)ethyl]-6-(trifluoromethyl)phenyl]amino]carbonyl]phenyl]-3-pyridinecarboxamide; M.UN.11.i) 4-cyano-N-[2-cyano-5-[[2,6-dibromo-4-[1,2,2,3,3,3-hexafluoro-1-(trifluoromethyl)propyl]phenyl]carbamoyl]phenyl]-2-methyl-benzamide; M.UN.11.j) 4-cyano-3-[(4-cyano-2-methyl-benzoyl)amino]-N-[2,6-dichloro-4-[1,2,2,3,3,3-hexafluoro-1-(trifluoromethyl)propyl]phenyl]-2-fluoro-benzamide; M.UN.11.k) N-[5-[[2-chloro-6-cyano-4-[1,2,2,3,3,3-hexafluoro-1-(trifluoromethyl)propyl]phenyl]carbamoyl]-2-cyano-phenyl]-4-cyano-2-methyl-benzamide; M.UN.11.1) N-[5-[[2-bromo-6-chloro-4-[2,2,2-trifluoro-1-hydroxy-1-(trifluoromethyl)ethyl]phenyl]carbamoyl]-2-cyano-phenyl]-4-cyano-2-methyl-benzamide; M.UN.11.m) N-[5-[[2-bromo-6-chloro-4-[1,2,2,3,3,3-hexafluoro-1-(trifluoromethyl)propyl]phenyl]carbamoyl]-2-cyano-phenyl]-4-cyano-2-methyl-benzamide; M.UN.11.n) 4-cyano-N-[2-cyano-5-[[2,6-dichloro-4-[1,2,2,3,3,3-hexafluoro-1-(trifluoromethyl)propyl]phenyl]carbamoyl]phenyl]-2-methyl-benzamide; M.UN.11.o) 4-cyano-N-[2-cyano-5-[[2,6-dichloro-4-[1,2,2,2-tetrafluoro-1-(trifluoromethyl)ethyl]phenyl]carbamoyl]phenyl]-2-methyl-benzamide; M.UN.11.p) N-[5-[[2-bromo-6-chloro-4-[1,2,2,2-tetrafluoro-1-(trifluoromethyl)ethyl]phenyl]carbamoyl]-2-cyano-phenyl]-4-cyano-2-methyl-benzamide; or
M.UN.12.a) 2-(1,3-Dioxan-2-yl)-6-[2-(3-pyridinyl)-5-thiazolyl]-pyridine; M.UN.12.b) 2-[6-[2-(5-Fluoro-3-pyridinyl)-5-thiazolyl]-2-pyridinyl]-pyrimidine; M.UN.12.c) 2-[6-[2-(3-Pyridinyl)-5-thiazolyl]-2-pyridinyl]-pyrimidine; M.UN.12.d) N-Methylsulfonyl-6-[2-(3-pyridyl)thiazol-5-yl]pyridine-2-carboxamide; M.UN.12.e) N-Methylsulfonyl-6-[2-(3-pyridyl)thiazol-5-yl]pyridine-2-carboxamide; M.UN.12.f) N-Ethyl-N-[4-methyl-2-(3-pyridyl)thiazol-5-yl]-3-methylthio-propanamide; M.UN.12.g) N-Methyl-N-[4-methyl-2-(3-pyridyl)thiazol-5-yl]-3-methylthio-propanamide; M.UN.12.h) N,2-Dimethyl-N-[4-methyl-2-(3-pyridyl)thiazol-5-yl]-3-methylthio-propanamide; M.UN.12.i) N-Ethyl-2-methyl-N-[4-methyl-2-(3-pyridyl)thiazol-5-yl]-3-methylthio-propanamide; M.UN.12.j) N-[4-Chloro-2-(3-pyridyl)thiazol-5-yl]-N-ethyl-2-methyl-3-methylthio-propanamide; M.UN.12.k) N-[4-Chloro-2-(3-pyridyl)thiazol-5-yl]-N,2-dimethyl-3-methylthio-propanamide; M.UN.12.1) N-[4-Chloro-2-(3-pyridyl)thiazol-5-yl]-N-methyl-3-methylthio-propanamide; M.UN.12.m) N-[4-Chloro-2-(3-pyridyl)thiazol-5-yl]-N-ethyl-3-methylthio-propanamide;
M.UN.14a) 1-[(6-Chloro-3-pyridinyl)methyl]-1,2,3,5,6,7-hexahydro-5-methoxy-7-methyl-8-nitro-imidazo[1,2-a]pyridine; or M.UN.14b) 1-[(6-Chloropyridin-3-yl)methyl]-7-methyl-8-nitro-1,2,3,5,6,7-hexahydroimidazo[1,2-a]pyridin-5-ol;
M.UN.16a) 1-isopropyl-N,5-dimethyl-N-pyridazin-4-yl-pyrazole-4-carboxamide; or M.UN.16b) 1-(1,2-dimethylpropyl)-N-ethyl-5-methyl-N-pyridazin-4-yl-pyrazole-4-carboxamide; M.UN.16c) N,5-dimethyl-N-pyridazin-4-yl-1-(2,2,2-trifluoro-1-methyl-ethyl)pyrazole-4-carboxamide; M.UN.16d) 1-[1-(1-cyanocyclopropyl)ethyl]-N-ethyl-5-methyl-N-pyridazin-4-yl-pyrazole-4-carboxamide; M.UN.16e) N-ethyl-1-(2-fluoro-1-methyl-propyl)-5-methyl-N-pyridazin-4-yl-pyrazole-4-carboxamide; M.UN.16f) 1-(1,2-dimethylpropyl)-N,5-dimethyl-N-pyridazin-4-yl-pyrazole-4-carboxamide; M.UN.16g) 1-[1-(1-cyanocyclopropyl)ethyl]-N,5-dimethyl-N-pyridazin-4-yl-pyrazole-4-carboxamide; M.UN.16h) N-methyl-1-(2-fluoro-1-methyl-propyl]-5-methyl-N-pyridazin-4-yl-pyrazole-4-carboxamide; M.UN.16i) 1-(4,4-difluorocyclohexyl)-N-ethyl-5-methyl-N-pyridazin-4-yl-pyrazole-4-carboxamide; or M.UN.16j) 1-(4,4-difluorocyclohexyl)-N,5-dimethyl-N-pyridazin-4-yl-pyrazole-4-carboxamide,
M.UN.17a) N-(1-methylethyl)-2-(3-pyridinyl)-2H-indazole-4-carboxamide; M.UN.17b) N-cyclopropyl-2-(3-pyridinyl)-2H-indazole-4-carboxamide; M.UN.17c) N-cyclohexyl-2-(3-pyridinyl)-2H-indazole-4-carboxamide; M.UN.17d) 2-(3-pyridinyl)-N-(2,2,2-trifluoroethyl)-2H-indazole-4-carboxamide; M.UN.17e) 2-(3-pyridinyl)-N-[(tetrahydro-2-furanyl)methyl]-2H-indazole-5-carboxamide; M.UN.17f) methyl 2-[[2-(3-pyridinyl)-2H-indazol-5-yl]carbonyl]hydrazinecarboxylate; M.UN.17g) N-[(2,2-difluorocyclopropyl)methyl]-2-(3-pyridinyl)-2H-indazole-5-carboxamide; M.UN.17h) N-(2,2-difluoropropyl)-2-(3-pyridinyl)-2H-indazole-5-carboxamide; M.UN.17i) 2-(3-pyridinyl)-N(2-pyrimidinylmethyl)-2H-indazole-5-carboxamide; M.UN.17j) N-[(5-methyl-2-pyrazinyl)methyl]-2-(3-pyridinyl)-2H-indazole-5-carboxamide,
M.UN.18a) N-[3-chloro-1-(3-pyridyl)pyrazol-4-yl]-N-ethyl-3-(3,3,3-trifluoropropylsulfanyl)propanamide; M.UN.18b) N-[3-chloro-1-(3-pyridyl)pyrazol-4-yl]-N-ethyl-3-(3,3,3-trifluoropropylsulfinyl)propanamide; M.UN.18c) N-[3-chloro-1-(3-pyridyl)pyrazol-4-yl]-3-[(2,2-difluorocyclopropyl)methylsulfanyl]-N-ethyl-propanamide; M.UN.18d) N-[3-chloro-1-(3-pyridyl)pyrazol-4-yl]-3-[(2,2-difluorocyclopropyl)methylsulfinyl]-N-ethyl-propanamide;
M.UN.19 sarolaner, M.UN.20 lotilaner;
M.UN.21 N-[4-Chloro-3-[[(phenylmethyl)amino]carbonyl]phenyl]-1-methyl-3-(1,1,2,2,2-pentafluoroethyl)-4-(trifluoromethyl)-1H-pyrazole-5-carboxamide; M.UN.22a 2-(3-ethylsulfonyl-2-pyridyl)-3-methyl-6-(trifluoromethyl)imidazo[4,5-b]pyridine, or M.UN.22b 2-[3-ethylsulfonyl-5-(trifluoromethyl)-2-pyridyl]-3-methyl-6-(trifluoromethyl)imidazo[4,5-b]pyridine;
M.UN.23a 4-[5-(3,5-dichlorophenyl)-5-(trifluoromethyl)-4H-isoxazol-3-yl]-N-[(4R)-2-ethyl-3-oxo-isoxazolidin-4-yl]-2-methyl-benzamide, or M.UN.23b 4-[5-(3,5-dichloro-4-fluoro-phenyl)-5-(trifluoromethyl)-4H-isoxazol-3-yl]-N-[(4R)-2-ethyl-3-oxo-isoxazolidin-4-yl]-2-methyl-benzamide;
M.UN.24a) N-[4-chloro-3-(cyclopropylcarbamoyl)phenyl]-2-methyl-5-(1,1,2,2,2-pentafluoroethyl)-4-(trifluoromethyl)pyrazole-3-carboxamide or M.UN.24b) N-[4-chloro-3-[(1-cyanocyclopropyl)carbamoyl]phenyl]-2-methyl-5-(1,1,2,2,2-pentafluoroethyl)-4-(trifluoromethyl)pyrazole-3-carboxamide;
M.UN.25 acynonapyr; M.UN.26 benzpyrimoxan; M.UN.272-chloro-N-(1-cyanocyclopropyl)-5-[1-[2-methyl-5-(1,1,2,2,2-pentafluoroethyl)-4-(trifluoromethyl)pyrazol-3-yl]pyrazol-4-yl]benzamide; M.UN.28 oxazosulfyl; M.UN.29 Tetrachlorantraniliprole; M.UN.30 Tyclopyrazoflor;
A) Respiration inhibitors
Inhibitors of complex III at Qo site: azoxystrobin (A.1.1), coumethoxystrobin (A.1.2), coumoxystrobin (A.1.3), dimoxystrobin (A.1.4), enestroburin (A.1.5), fenaminstrobin (A.1.6), fenoxystrobin/flufenoxystrobin (A.1.7), fluoxastrobin (A.1.8), kresoxim-methyl (A.1.9), mandestrobin (A.1.10), metominostrobin (A.1.11), orysastrobin (A.1.12), picoxystrobin (A.1.13), pyraclostrobin (A.1.14), pyrametostrobin (A.1.15), pyraoxystrobin (A.1.16), trifloxystrobin (A.1.17), 2 (2-(3-(2,6-dichlorophenyl)-1-methyl-allylideneaminooxymethyl)-phenyl)-2 methoxyimino-N methyl-acetamide (A.1.18), pyribencarb (A.1.19), triclopyricarb/chlorodincarb (A.1.20), famoxadone (A.1.21), fenamidone (A.1.21), methyl-N-[2-[(1,4-dimethyl-5 phenyl-pyrazol-3-yl)oxylmethyl]phenyl]-N-methoxy-carbamate (A.1.22), 1-[3-chloro-2 [[1 (4-chlorophenyl)-1H-pyrazol-3-yl]oxymethyl]phenyl]-4-methyl-tetrazol-5-one (A.1.23), 1-[3-bromo-2-[[1-(4-chlorophenyl)pyrazol-3-yl]oxymethyl]phenyl]-4-methyl-tetrazol-5-one (A.1.24), 1-[2-[[1-(4-chlorophenyl)pyrazol-3-yl]oxymethyl]-3-methyl-phenyl]-4-methyl-tetrazol-5-one (A.1.25), 1-[2-[[1-(4-chlorophenyl)pyrazol-3-yl]oxymethyl]-3-fluoro-phenyl]-4-methyl-tetrazol-5-one (A.1.26), 1-[2-[[1-(2,4-dichlorophenyl)pyrazol-3-yl]oxymethyl]-3-fluoro-phenyl]-4-methyltetrazol-5-one (A.1.27), 1-[3-cyclopropyl-2-[[2-methyl-4 (1 methylpyrazol-3-yl)phenoxy]methyl]phenyl]-4 methyl-tetrazol-5-one (A.1.30), 1 [3 (difluoromethoxy)-2-[[2-methyl-4-(1 methylpyrazol-3 yl)phenoxy]methyl]phenyl]-4 methyl-tetrazol-5-one (A.1.31), 1-methyl-4-[3-methyl-2 [[2 methyl-4-(1-methylpyrazol-3 yl)phenoxy]methyl]phenyl]tetrazol-5-one (A.1.32), (Z,2E)-5-[1-(2,4-dichlorophenyl)pyrazol-3-yl]-oxy-2-methoxyimino-N,3-dimethyl-pent-3-enamide (A.1.34), (Z,2E) 5 [1 (4-chlorophenyl)pyrazol-3-yl]oxy-2-methoxyimino-N,3-dimethylpent-3-enamide (A.1.35), pyriminostrobin (A.1.36), bifujunzhi (A.1.37), 2-(ortho-((2,5-dimethylphenyl-oxy-methylen)phenyl)-3-methoxy-acrylic acid methylester (A.1.38);
inhibitors of complex III at Qi site: cyazofamid (A.2.1), amisulbrom (A.2.2), [(6S,7R,8R) 8 benzyl-3-[(3-hydroxy-4-methoxy-pyridine-2-carbonyl)amino]-6-methyl-4,9-dioxo-1,5-dioxonan-7-yl] 2-methylpropanoate (A.2.3), fenpicoxamid (A.2.4);
inhibitors of complex II: benodanil (A.3.1), benzovindiflupyr (A.3.2), bixafen (A.3.3), boscalid (A.3.4), carboxin (A.3.5), fenfuram (A.3.6), fluopyram (A.3.7), flutolanil (A.3.8), fluxapyroxad (A.3.9), furametpyr (A.3.10), isofetamid (A.3.11), isopyrazam (A.3.12), mepronil (A.3.13), oxycarboxin (A.3.14), penflufen (A.3.15), penthiopyrad (A.3.16), pydiflumetofen (A.3.17), pyraziflumid (A.3.18), sedaxane (A.3.19), tecloftalam (A.3.20), thifluzamide (A.3.21), 3 (difluoromethyl)-1-methyl-N-(1,1,3-trimethylindan-4-yl)pyrazole-4 carboxamide (A.3.22), 3 (trifluoromethyl)-1-methyl-N-(1,1,3-trimethylindan-4-yl)pyrazole-4 carboxamide (A.3.23), 1,3-dimethyl-N-(1,1,3-trimethylindan-4-yl)pyrazole-4-carboxamide (A.3.24), 3-(trifluoromethyl)-1,5 dimethyl-N-(1,1,3-trimethylindan-4-yl)pyrazole-4-carboxamide (A.3.25), 1,3,5-trimethyl-N-(1,1,3-trimethylindan-4-yl)pyrazole-4-carboxamide (A.3.26), 3-(difluoromethyl)-1,5 dimethyl-N-(1,1,3-trimethylindan-4-yl)pyrazole-4-carboxamide (A.3.27), 3-(difluoromethyl)-N-(7 fluoro-1,1,3-trimethyl-indan-4-yl)-1-methyl-pyrazole-4-carboxamide (A.3.28), N-[(5-chloro-2-isopropylphenyl)methyl]-N-cyclopropyl-5-fluoro-1,3-dimethyl-pyrazole-4-carboxamide (A.3.29), methyl (E)-2-[2-[(5-cyano-2-methylphenoxy)methyl]phenyl]-3-methoxy-prop-2 enoate (A.3.30), N-[(5-chloro-2-isopropyl-phenyl)methyl]-N-cyclopropyl-3-(difluoromethyl)-5 fluoro-1-methyl-pyrazole-4-carboxamide (A.3.31), 2-(difluoromethyl)-N-(1,1,3-trimethyl-indan-4-yl)pyridine-3-carboxamide (A.3.32), 2-(difluoromethyl)-N-[(3R)-1,1,3-trimethylindan-4-yl]pyridine-3-carboxamide (A.3.33), 2-(difluoromethyl)-N-(3-ethyl-1,1-dimethyl-indan-4-yl)pyridine-3-carboxamide (A.3.34), 2-(difluoromethyl)-N-[(3R)-3-ethyl-1,1-dimethyl-indan-4-yl]pyridine-3-carboxamide (A.3.35), 2-(difluoromethyl)-N-(1,1-dimethyl-3-propyl-indan-4-yl)pyridine-3-carboxamide (A.3.36), 2-(difluoromethyl)-N-[(3R)-1,1-dimethyl-3-propyl-indan-4-yl]pyridine-3-carboxamide (A.3.37), 2-(difluoromethyl)-N-(3-isobutyl-1,1-dimethyl-indan-4-yl)pyridine-3-carboxamide (A.3.38), 2-(difluoromethyl)-N-[(3R)-3-isobutyl-1,1-dimethyl-indan-4 yl]pyridine-3-carboxamide (A.3.39);
other respiration inhibitors: diflumetorim (A.4.1); nitrophenyl derivates: binapacryl (A.4.2), dinobuton (A.4.3), dinocap (A.4.4), fluazinam (A.4.5), meptyldinocap (A.4.6), ferimzone (A.4.7); organometal compounds: fentin salts, e. g. fentin-acetate (A.4.8), fentin chloride (A.4.9) or fentin hydroxide (A.4.10); ametoctradin (A.4.11); silthiofam (A.4.12);
B) Sterol biosynthesis inhibitors (SBI fungicides)
C14 demethylase inhibitors: triazoles: azaconazole (B.1.1), bitertanol (B.1.2), bromu-conazole (B.1.3), cyproconazole (B.1.4), difenoconazole (B.1.5), diniconazole (B.1.6), diniconazole-M (B.1.7), epoxiconazole (B.1.8), fenbuconazole (B.1.9), fluquinconazole (B.1.10), flusilazole (B.1.11), flutriafol (B.1.12), hexaconazole (B.1.13), imibenconazole (B.1.14), ipconazole (B.1.15), metconazole (B.1.17), myclobutanil (B.1.18), oxpoconazole (B.1.19), paclobutrazole (B.1.20), penconazole (B.1.21), propiconazole (B.1.22), prothioconazole (B.1.23), simeconazole (B.1.24), tebuconazole (B.1.25), tetraconazole (B.1.26), triadimefon (B.1.27), triadimenol (B.1.28), triticonazole (B.1.29), uniconazole (B.1.30), ipfentrifluconazole, (B.1.37), mefentrifluconazole (B.1.38), 2-(chloromethyl)-2-methyl-5-(p-tolylmethyl)-1 (1,2,4-triazol-1-ylmethyl)cyclopentanol (B.1.43); imidazoles: imazalil (B.1.44), pefurazoate (B.1.45), prochloraz (B.1.46), triflumizol (B.1.47); pyrimidines, pyridines and piperazines: fenarimol (B.1.49), pyrifenox (B.1.50), triforine (B.1.51), [3-(4-chloro-2-fluoro-phenyl)-5-(2,4-difluorophenyl)isoxazol-4-yl]-(3-pyridyl)methanol (B.1.52);
Delta14-reductase inhibitors: aldimorph (B.2.1), dodemorph (B.2.2), dodemorph-acetate (B.2.3), fenpropimorph (B.2.4), tridemorph (B.2.5), fenpropidin (B.2.6), piperalin (B.2.7), spiroxamine (B.2.8);
Inhibitors of 3-keto reductase: fenhexamid (B.3.1);
Other Sterol biosynthesis inhibitors: chlorphenomizole (B.4.1);
C) Nucleic acid synthesis inhibitors
phenylamides or acyl amino acid fungicides: benalaxyl (C.1.1), benalaxyl-M (C.1.2), kiralaxyl (C.1.3), metalaxyl (C.1.4), metalaxyl-M (C.1.5), ofurace (C.1.6), oxadixyl (C.1.7);
other nucleic acid synthesis inhibitors: hymexazole (C.2.1), octhilinone (C.2.2), oxolinic acid (C.2.3), bupirimate (C.2.4), 5-fluorocytosine (C.2.5), 5-fluoro-2-(p-tolylmethoxy)pyrimidin-4 amine (C.2.6), 5-fluoro-2-(4-fluorophenylmethoxy)pyrimidin-4 amine (C.2.7), 5-fluoro-2 (4 chlorophenylmethoxy)pyrimidin-4 amine (C.2.8);
D) Inhibitors of cell division and cytoskeleton
tubulin inhibitors: benomyl (D.1.1), carbendazim (D.1.2), fuberidazole (D1.3), thiabendazole (D.1.4), thiophanate-methyl (D.1.5), 3-chloro-4-(2,6-difluorophenyl)-6-methyl-5-phenyl-pyridazine (D.1.6), 3-chloro-6-methyl-5-phenyl-4-(2,4,6-trifluorophenyl)pyridazine (D.1.7), N ethyl-2-[(3-ethynyl-8-methyl-6-quinolyl)oxy]butanamide (D.1.8), N-ethyl-2-[(3-ethynyl-8 methyl-6 quinolyl)oxy]-2-methylsulfanyl-acetamide (D.1.9), 2-[(3-ethynyl-8-methyl-6-quinol-yl)oxy]-N (2-fluoroethyl)butanamide (D.1.10), 2-[(3-ethynyl-8-methyl-6-quinolyl)oxy]-N-(2-flu-oroethyl)-2-methoxy-acetamide (D.1.11), 2-[(3-ethynyl-8-methyl-6-quinolyl)oxy]-N-propyl-butanamide (D.1.12), 2-[(3-ethynyl-8-methyl-6-quinolyl)oxy]-2-methoxy-N-propyl-acetamide (D.1.13), 2-[(3-ethynyl-8-methyl-6-quinolyl)oxy]-2-methylsulfanyl-N-propyl-acetamide (D.1.14), 2 [(3 ethynyl-8-methyl-6-quinolyl)oxy]-N-(2-fluoroethyl)-2-methylsulfanyl-acetamide (D.1.15), 4-(2-bromo-4-fluoro-phenyl)-N-(2-chloro-6-fluoro-phenyl)-2,5-dimethyl-pyrazol-3 amine (D.1.16);
other cell division inhibitors: diethofencarb (D.2.1), ethaboxam (D.2.2), pencycuron (D.2.3), fluopicolide (D.2.4), zoxamide (D.2.5), metrafenone (D.2.6), pyriofenone (D.2.7);
E) Inhibitors of amino acid and protein synthesis
methionine synthesis inhibitors: cyprodinil (E.1.1), mepanipyrim (E.1.2), pyrimethanil (E.1.3);
protein synthesis inhibitors: blasticidin-S (E.2.1), kasugamycin (E.2.2), kasugamycin hydrochloride-hydrate (E.2.3), mildiomycin (E.2.4), streptomycin (E.2.5), oxytetracyclin (E.2.6);
F) Signal transduction inhibitors
MAP/histidine kinase inhibitors: fluoroimid (F.1.1), iprodione (F.1.2), procymidone (F.1.3), vinclozolin (F.1.4), fludioxonil (F.1.5);
G protein inhibitors: quinoxyfen (F.2.1);
G) Lipid and membrane synthesis inhibitors
Phospholipid biosynthesis inhibitors: edifenphos (G.1.1), iprobenfos (G.1.2), pyrazophos (G.1.3), isoprothiolane (G.1.4);
lipid peroxidation: dicloran (G.2.1), quintozene (G.2.2), tecnazene (G.2.3), tolclofos-methyl (G.2.4), biphenyl (G.2.5), chloroneb (G.2.6), etridiazole (G.2.7);
phospholipid biosynthesis and cell wall deposition: dimethomorph (G.3.1), flumorph (G.3.2), mandipropamid (G.3.3), pyrimorph (G.3.4), benthiavalicarb (G.3.5), iprovalicarb (G.3.6), valifenalate (G.3.7);
compounds affecting cell membrane permeability and fatty acides: propamocarb (G.4.1);
inhibitors of oxysterol binding protein: oxathiapiprolin (G.5.1), 2-{3-[2-(1-{[3,5-bis(difluoro-methyl-1H-pyrazol-1-yl]acetyl}piperidin-4-yl)-1,3-thiazol-4-yl]-4,5-dihydro-1,2 oxazol-5-yl}phenyl methanesulfonate (G.5.2), 2-{3-[2-(1-{[3,5-bis(difluoromethyl)-1H-pyrazol-1-yl]acetyl}piperidin-4-yl) 1,3-thiazol-4-yl]-4,5-dihydro-1,2-oxazol-5 yl}-3-chlorophenyl methanesulfonate (G.5.3), 4-[1-[2-[3-(difluoromethyl)-5-methyl-pyrazol-1-yl]acetyl]-4-piperidyl]-N-tetralin-1-yl-pyridine-2-carboxamide (G.5.4), 4-[1-[2-[3,5-bis(difluoromethyl)pyrazol-1-yl]acetyl]-4-piperidyl]-N-tetralin-1-ylpyridine-2-carboxamide (G.5.5), 4-[1-[2-[3-(difluoromethyl)-5-(trifluoromethyl)pyrazol-1-yl]acetyl]-4-piperidyl]-N-tetralin-1-ylpyridine-2-carboxamide (G.5.6), 4-[1-[2-[5-cyclopropyl-3-(difluoromethyl)pyrazol-1-yl]acetyl]-4-piperidyl]-N-tetralin-1-ylpyridine-2-carboxamide (G.5.7), 4-[1-[2-[5-methyl-3-(trifluoromethyl)pyrazol-1-yl]acetyl]-4-piperidyl]-N-tetralin-1-ylpyridine-2-carboxamide (G.5.8), 4-[1-[2-[5-(difluoromethyl)-3-(trifluoromethyl)pyrazol-1-yl]acetyl]-4-piperidyl]-N-tetralin-1-ylpyridine-2-carboxamide (G.5.9), 4 [1 [2-[3,5-bis(trifluoromethyl)pyrazol-1-yl]acetyl]-4-piperidyl]-N-tetralin-1-ylpyridine-2-carboxamide (G.5.10), (4-[1-[2-[5-cyclopropyl-3-(trifluoromethyl)pyrazol-1-yl]acetyl]-4-piperidyl]-N-tetralin-1-ylpyridine-2-carboxamide (G.5.11);
H) Inhibitors with Multi Site Action
inorganic active substances: Bordeaux mixture (H.1.1), copper (H.1.2), copper acetate (H.1.3), copper hydroxide (H.1.4), copper oxychloride (H.1.5), basic copper sulfate (H.1.6), sulfur (H.1.7);
thio- and dithiocarbamates: ferbam (H.2.1), mancozeb (H.2.2), maneb (H.2.3), metam (H.2.4), metiram (H.2.5), propineb (H.2.6), thiram (H.2.7), zineb (H.2.8), ziram (H.2.9);
organochlorine compounds: anilazine (H.3.1), chlorothalonil (H.3.2), captafol (H.3.3), captan (H.3.4), folpet (H.3.5), dichlofluanid (H.3.6), dichlorophen (H.3.7), hexachlorobenzene (H.3.8), pentachlorphenole (H.3.9) and its salts, phthalide (H.3.10), tolylfluanid (H.3.11);
guanidines and others: guanidine (H.4.1), dodine (H.4.2), dodine free base (H.4.3), guazatine (H.4.4), guazatine-acetate (H.4.5), iminoctadine (H.4.6), iminoctadine-triacetate (H.4.7), iminoctadine-tris(albesilate) (H.4.8), dithianon (H.4.9), 2,6-dimethyl-1H,5H-[1,4]dithiino[2,3-c:5,6-c′]dipyrrole-1,3,5,7(2H,6H)tetraone (H.4.10);
I) Cell wall synthesis inhibitors
inhibitors of glucan synthesis: validamycin (1.1.1), polyoxin B (1.1.2);
melanin synthesis inhibitors: pyroquilon (1.2.1), tricyclazole (1.2.2), carpropamid (1.2.3), dicyclomet (1.2.4), fenoxanil (1.2.5);
J) Plant defense inducers
acibenzolar-S-methyl (J.1.1), probenazole (J.1.2), isotianil (J.1.3), tiadinil (J.1.4), prohexadione-calcium (J.1.5); phosphonates: fosetyl (J.1.6), fosetyl-aluminum (J.1.7), phosphorous acid and its salts (J.1.8), calcium phosphonate (J.1.11), potassium phosphonate (J.1.12), potassium or sodium bicarbonate (J.1.9), 4 cyclopropyl-N-(2,4-dimethoxyphenyl)thiadiazole-5-carboxamide (J.1.10);
K) Unknown mode of action
bronopol (K.1.1), chinomethionat (K.1.2), cyflufenamid (K.1.3), cymoxanil (K.1.4), dazomet (K.1.5), debacarb (K.1.6), diclocymet (K.1.7), diclomezine (K.1.8), difenzoquat (K.1.9), difenzoquat-methylsulfate (K.1.10), diphenylamin (K.1.11), fenitropan (K.1.12), fenpyrazamine (K.1.13), flumetover (K.1.14), flusulfamide (K.1.15), flutianil (K.1.16), harpin (K.1.17), metha-sulfocarb (K.1.18), nitrapyrin (K.1.19), nitrothal-isopropyl (K.1.20), tolprocarb (K.1.21), oxin-copper (K.1.22), proquinazid (K.1.23), tebufloquin (K.1.24), tecloftalam (K.1.25), triazoxide (K.1.26), N′-(4-(4-chloro-3-trifluoromethyl-phenoxy)-2,5-dimethylphenyl)-N-ethyl-N methyl formamidine (K.1.27), N′ (4-(4-fluoro-3-trifluoromethyl-phenoxy)-2,5-dimethyl-phenyl)-N-ethyl-N-methyl formamidine (K.1.28), N′-[4-[[3-[(4-chlorophenyl)methyl]-1,2,4-thiadiazol-5-yl]oxy]-2,5-dimethyl-phenyl]-N-ethyl-N-methyl-formamidine (K.1.29), N′-(5-bromo-6-indan-2-yloxy-2-methyl-3-pyridyl)-N-ethyl-N-methyl-formamidine (K.1.30), N′-[5-bromo-6-[1-(3,5-difluorophenyl)ethoxy]-2-methyl-3-pyridyl]-N-ethyl-N-methyl-formamidine (K.1.31), N′-[5-bromo-6-(4-isopropylcyclohexoxy)-2-methyl-3-pyridyl]-N-ethyl-N-methyl-formamidine (K.1.32), N′ [5 bromo-2-methyl-6-(1-phenylethoxy)-3-pyridyl]-N-ethyl-N-methyl-formamidine (K.1.33), N′-(2-methyl-5-trifluoromethyl-4-(3-trimethylsilanyl-propoxy)-phenyl)-N-ethyl-N-methyl formamidine (K.1.34), N′-(5-difluoromethyl-2 methyl-4-(3-trimethylsilanyl-propoxy)-phenyl)-N-ethyl-N-methyl formamidine (K.1.35), 2-(4-chloro-phenyl)-N-[4-(3,4-dimethoxy-phenyl)-isoxazol-5 yl]-2-prop-2-ynyloxy-acetamide (K.1.36), 3 [5-(4-chloro-phenyl)-2,3-dimethyl-isoxazolidin-3-yl]-pyridine (pyrisoxazole) (K.1.37), 3-[5-(4-methylphenyl)-2,3-dimethyl-isoxazolidin-3 yl]-pyridine (K.1.38), 5-chloro-1 (4,6-dimethoxy-pyrimidin-2-yl)-2-methyl-1H-benzoimidazole (K.1.39), ethyl (Z) 3 amino-2-cyano-3-phenylprop-2-enoate (K.1.40), picarbutrazox (K.1.41), pentyl N-[6-[[(Z)[(1-methyltetrazol-5-yl)-phenyl-methylene]amino]oxymethyl]-2-pyridyl]carbamate (K.1.42), but-3-ynyl N-[6-[[(Z)-[(1-methyltetrazol-5-yl)-phenyl-methylene]amino]oxymethyl]-2-pyridyl]carbamate (K.1.43), 2-[2-[(7,8-difluoro-2-methyl-3-quinolyl)oxy]-6-fluoro-phenyl]propan-2-ol (K.1.44), 2-[2-fluoro-6-[(8-fluoro-2-methyl-3-quinolyl)oxy]phen-yl]propan-2-ol (K.1.45), quinofumelin (K.1.47), 9-fluoro-2,2-dimethyl-5-(3-quinolyl)-3H 1,4 benzoxazepine (K.1.49), 2-(6-benzyl-2-pyridyl)quinazoline (K.1.50), 2-[6-(3-fluoro-4 methoxy-phenyl)-5-methyl-2-pyridyl]quinazoline (K.1.51), dichlobentiazox (K.1.52), N′-(2,5-dimethyl-4-phenoxy-phenyl)-N-ethyl-N-methyl-formamidine (K.1.53); dipymetitrone, isoflucypram; fluindapyr, inpyrfluxam, pyrifenamine;
in weight ratios from 10000:1 to 1:10000.

7. The method according to claim 8, wherein the plant propagation material to be protected is seeds.

8. A method for protecting a plant or plant propagation material of soybean, corn, canola, cereals, sugarbeet, cotton, peanut, and potato, from attack or infestation by insects, comprising contacting the seed of the plant, with the compound of formula I: 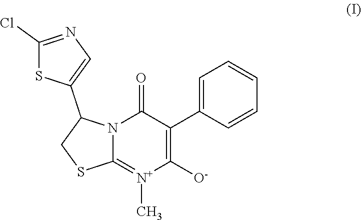 [SMILES: C[n+]1c([O-])c(-c2ccccc2)c(=O)n2c1SCC2c1cnc(Cl)s1]
or the tautomers, enantiomer, diastereomers or salts thereof.

9. A method for controlling or combating soybean, corn, canola, cereals, sugarbeet, cotton, peanut, or potato pest invertebrates, infestation, or infection by pest invertebrates, comprising applying said pest or its food supply, habitat or breeding grounds with a pesticidally effective amount of the compound of formula I: 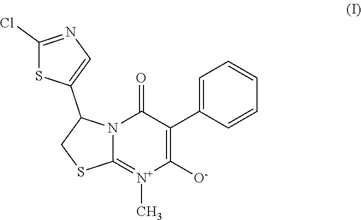 [SMILES: C[n+]1c([O-])c(-c2ccccc2)c(=O)n2c1SCC2c1cnc(Cl)s1]
or the tautomers, enantiomer, diastereomers or salts thereof, by a seed treatment method.

10. A method for treating seeds of soybean, corn, canola, cereals, sugarbeet, cotton, peanut, or potato plants, to protect them from pests, comprising applying seeds a pesticidally effective amount of the compound of formula I: 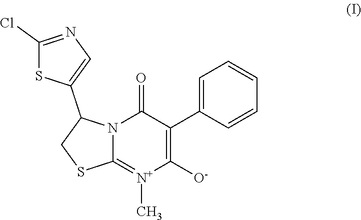 [SMILES: C[n+]1c([O-])c(-c2ccccc2)c(=O)n2c1SCC2c1cnc(Cl)s1]
or the tautomers, enantiomer, diastereomers or salts thereof.

11. The method according to claim 8, wherein the compound of formula I is applied in an amount of from 0.1 g to 100 kg per 100 kg of seeds.

12. The method according to claim 8, wherein plant roots and shoots resulting from the treated seeds are protected from attack by pests.

13. The method according to claim 8, wherein the pests to be controlled or to be combated are selected from Athalia rosae, Autographia californica, Brevicoryne brassicae, Ceutorhynchus sp., Contarinia nasturtii, Dasineura brassicae, Delia brassicae, Dicestra trifoli, Entomoscelis americana, Lygus spp., Lygus hesperus, Lygus lineolaris, Mamestra sp., Meligethes sp., Phyllotreta spp., Phytomyza rufipes, Pieris sp., Plutella xylostella, Psylliodes sp., Agromyza parvicornis, Agrotis sp., Agrius convolvuli, Anaphothrips obscrurus, Anuraphis maidiradicis, Athetis spp., Blissus leucopterus, Carposina niponensis, Carposina sasakii, Chaetocnema pulicaria, Chilo suppressalis, Conoderus, Aeolus spp., Contarinia sorghicola, Coleophora spp, Cyclocephala borealis, Cyclocephala immaculata, Diabrotica sp., Diatraea grandiosella, Diatraea saccharalis, Elasmopalpus sp., Feltia subterranea, Helicoverpa sp., Hylemya platura, Melanoplus femurrubrum, Melanoplus sanguinipes, Melanotus spp., Mythimna separata, Ostrinia sp., Oulema sp., Pectinophora spp, Phyllophaga crinita, Eleodes, Popillia japonica, Porthesia scintillans, Rhopalosiphum sp., Pseudaletia spp, Pseudaletia unipuncta, Sesamia nonagrioides, Sipha flava, Solenopsis milesta, Chilo partellus, Sphenophorus maidis, Spodoptera sp., Tetranychus sp., Tryporyza incertulas, Aceria tulipae, Acrosternum hilare, Anchastus spp., Bothyrus gibbosus, Cephus cinctus, Cylindrocupturus adspersus, Diuraphis sp, Diuraphis noxia, Euschistus servus, Euschistus spp., Frankliniella sp., Heterodera avenae, Homoeosoma electellum, Hylemya coarctata, Hypera punctata, Irbisia spp., Jylemya platura, Limonius sp, Macrosiphum sp., Mayetiola sp., Melanoplus differentialis, Melanoplus feurrubrum, Melanoplus spp., Meromyza americana, Metopolophium dirhodum, Mythimna unipuncta, Neolasioptera murtfeldtiana, Oligonychus pratensis, Penthaleus major, Petrobia latens, Schizaphis sp, Schizaphis graminum, Sitobion avenae, Sitodiplosis mosellana, Smicronyx fulus, Smicronyx sordidus, Suleima helianthana, Tipula spp., Zygogramma exclamationis, Adelphocoris lineolatus, Adelphocoris suturalis, Alabama argilacea, Alcidodes affaber, Amrasca sp such as Amrasca biguttula, Amrasca devastans, Anomis flava, Anthonomus sp such as Anthonomus grandis; Aphis sp., Apolygus lucorum, Atactogaster finitimus, Autographa californica, Blapstinus spp., Bucculatrix loxoptera, Bucculatrix thurberiella, Caliothrips fasciatus, Chlorochroa sayi, Chrysodeixis sp., Compylomma livida, Creontiades spp., Delia platura, Dysdercus spp.; Earias sp., Empoasca spp, Empoasca fabae, Empoasca solana, Empoasca devastans, Estigmene acrea, Euschistus conspersus, Euschistus impictiventris, Franklinkiella fusca, Franklinkiella occidentalis, Gryllus spp., Heliothis virescens, Hoplolaimus columbus, Liriomyza spp., Meloidogyne spp., Microtermes obesi, Nysius raphanus, Odontotermes obesus, Onycarenus laetus, Pectinophora gossypiella, Pempherulus affinis, Peridroma saucia, Phenacoccus solenopsis, Platynota stultana, Pseudatomoscelis seriatus, Rotylenchulus reniformis, Scirtothrips dorsalis, Spilosoma obliqua, Sylepta derogata, Tarache otabilis, Thrips sp, Thrips tabaci, Trachea notabilis, Trialeurodes abutilonea, Trichoplusia ni, Udea profundalis, Anticarsia sp., Aristotelia reseosuffusella, Calomycterus setarius, Cerotoma trifurcate, Colaspis brunnea, Colaspis crinnicornis, Colaspis flavida, Colias eurytheme, Cyclocephala lurida, Dectes texanus, Diabratica balteata, Diabratica undecimpunctata howardi, Diabratica undecimpunctata, Epargyreus clarus, Epicauta funebris, Epicauta pennsylvanica, Epicauta vittata, Epilachna varivestis, Euschistus heros, Halticus bractatus, Halyomorpha sp., Helocoverpa zea, Heterodera glycines, Heterodera spp., Hypena scabra, Myzus sp., Naupactus (=Graphognathus) spp, Odontota horni, Papaipema nebris, Phyllophaga rugosa, Piezodorus sp., Plathypena scabra, Podisus maculoventris, Pseudoplusia includens, Rivellia quadrifasciata, Sericothrips variabilis, Spilosoma virginica, Spissistilus festinus, Spp of Alydidae, Strigoderma arboricola, Thyanta custator, Vanessa cardui, ORT: Gryllidae, ORT: Acrididae, ORT: Gryllotalpidae, Austroasca alfalfa, Austroasca viridigrisea, Bemisia sp., Conoderus scissus, Etiella behrii, Heteronyx piceus, Lepidiota spp, Leucania stenographia, Mythimna spp., Meloidogyne arenaria, Naupactus leucoloma, Pangaeus bilineatus (Say), Paraplonobia spp., COL: Tenebrionidae, COL: Elateridae, COL: Scarabeidae, HET: Myridae, Acizzia solanicola, Agriotes spp., Agriotes lineatus, Agriotes obscurus, Amphimallon solstitialis, Aulacorthum circumflexum, Aulacorthum solani, Bactericera sp., Circulifer tennelus, Epitrix sp such as Epitrix hirtipennis, Epitrix fuscula; Nezara sp, Diaphorina citrii, Liriomyza sp., Heliothis zea, Henosepilachna vigintioctomaculata, Holotrichia. sp., Leptinotarsa sp., Ctenicera pruinina, Macrosteles fascifrons, Meloidogyne hapla, Meloidogyne chitwoodi, Meloidogyne incognita, Monomorium pharaonic, Pemphigus sp., Phthorimaea spp, Phthorimaea operculella, Pratylenchus penetrans, Pratylenchus neglectus, Paratrichodorus sp., Rhopalosiphoninus latysiphon, Russelliana solanicola Tuthill, Smynthurodes betae, Trialeurodes vaporariorum, Achyra rantalis, Atomaria linearis, Autographa gamma, Blaniulus guttulatus, Cassida nebulosa L., Cassida nobilis (L.) (Col., Chrysomelidae), Chaetocnema tibialis, Circulifer tenellus, Disonycha triangularis, Epitrix cucumeris, Epitrix tuberis, Euxoa auxiliaris, Euxoa nigricans, Heterodera schachtii, Loxostege cereralis, Loxostege sticticalis, Meloidogyne javanica, Meloidogyne arenaria, Meloidogyne hapla, Meloidogyne chitwoodi, Onychiurus spp, Pegomyia betae, Pemphigus populivenae (betae), Piesma quadratum, Aproaerema modicella, Dalbulus sp, Dichelops sp. Systena blanda, COL: Bruchidae, COL: Dermestidae, Acanthoscelides obtectus, Acarus siro, Bruchidius atrolineatus, Bruchus atomarius, Bruchus dentipes, Bruchus lentis Frol, Bruchus pisorum, Bruchus rufipes, Callosobruchus chinensis, Callosobruchus maculatus (Fabricius), Callosobruchus subinnotatus, Callosobruchus theobromae, Cryptolestes ferrugineus, Ephestia elutella, Ephestia kuehniella, Oryzaephilus Mercator, Oryzaephilus surinamensis, Palorus depressus, Plodia interpunctella, Prostephanus truncatus (Horn), Rhizopertha dominica, Sitophilus granarius (L.), Sitophilus oryzae (L.) (=Calandra oryzae L.), Sitophilus spp., Sitophilus zeamais Motsch. (=Calandra zeamais Motsch.), Sitotroga cerealella, Tribolium destructor, Tribolium madens, Tenebrio molitor L, and Tribolium confusum.

14. The method according to claim 8, wherein the cereal is wheat or barley.

15. The method according to claim 8, wherein
(1) the plant is corn, the invertebrate pests are selected from Agromyza parvicornis, Agrotis ipsilon, Agrius convolvuli, Anaphothrips obscrurus, Anuraphis maidiradicis, Athetis spp., Blissus leucopterus, Carposina niponensis, Carposina sasakii, Chaetocnema pulicaria, Chilo suppressalis, Conoderus, Aeolus spp., Contarinia sorghicola, Coleophora spp, Cyclocephala borealis, Cyclocephala immaculata, Dalbulus sp, Diabrotica longicornis barberi, Diabrotica undecimpunctata howardi, Diabrotica virgifera, Diatraea grandiosella, Diatraea saccharalis, Dichelops melacanthus, Elasmopalpus lignosellus, Feltia subterranea, Helicoverpa armigera, Helicoverpa zea, Hylemya platura, Melanoplus femurrubrum, Melanoplus sanguinipes, Melanotus spp., Mythimna separata, Ostrinia furnacalis, Ostrinia nubilalis, Oulema melanopus, Pectinophora spp, Phyllophaga crinita, Eleodes, Popillia japonica, Porthesia scintillans, Rhopalosiphum maidis, Rhopalosiphum maidis, Pseudaletia unipuncta, Sesamia nonagrioides, Sipha flava, Solenopsis milesta, Chilo partellus, Sphenophorus maidis, Spodoptera frugiperda, Spodoptera exigua, Spodoptera litura, Tetranychus cinnabarinus, Tetranychus urticae, and Tryporyza incertulas;
(2) the plant is wheat, the invertebrate pests are selected from Aceria tulipae, Acrosternum hilare, Aeolus sp., Agrotis ipsilon, Agrotis orthogonia, Anchastus spp., Blissus leucopterus, Bothyrus gibbosus, Cephus cinctus, Cylindrocupturus adspersus, Diabrotica undecimpunctata howardi, Diuraphis noxia, Elasmopalpus lignosellus, Euschistus servus, Euschistus spp., Frankliniella fusca, Heterodera avenae, Homoeosoma electellum, Hylemya coarctata, Hypera punctata, Irbisia spp., Jylemya platura, Limonius spp., Macrosiphum avenae, Mayetiola destructor, Melanoplus differentialis, Melanoplus feurrubrum, Melanoplus sanguinipes, Melanoplus spp., Melanotus spp., Meromyza americana, Metopolophium dirhodum, Mythimna unipuncta, Neolasioptera murtfeldtiana, Oligonychus pratensis, Ostrinia nubilalis, Oulema melanopus, Penthaleus major, Petrobia latens, Pseudaletia spp, Pseudaletia unipunctata, Rhopalosiphum maidis, Rhopalosiphum rufabdominale, Schizaphis graminum, Sitobion avenae, Sitodiplosis mosellana, Smicronyx fulus, Smicronyx sordidus, Spodoptera frugiperda, Spodoptera praefica, Suleima helianthana, Tipula spp., and Zygogramma exclamationis;
(3) the plant is barely, the invertebrate pests are selected from Acrosternum hilare, Aeolus sp., Agrotis ipsilon, Anchastus spp., Blissus leucopterus leucopterus, Diuraphis noxia, Euschistus servus, Euschistus spp., Heterodera avenae, Irbisia spp., Jylemya platura, Limonius spp., Mayetiola destructor, Melanoplus spp., Melanotus spp., Meromyza Americana, Metopolophium dirhodum, Mythimna unipuncta, Oligonychus pratensis, Ostrinia nubilalis, Penthaleus major, Petrobia latens, Pseudaletia spp, Rhopalosiphum maidis, Rhopalosiphum rufabdominale, Rhopalosiphum padi, Schizaphis graminum, Sitobion avenae, Spodoptera praefica, and Tipula spp.;
(4) the plant is canola, the invertebrate pests are selected from Agrotis ipsilon, Athalia rosae, Autographia californica, Brevicoryne brassicae, Ceutorhynchus assimilis, Ceutorhynchus napi, Ceutorhynchus obstrictus, Ceutorhynchus pallidactylus, Ceutorhynchus picitarsis, Ceutorhynchus quadridens, Contarinia nasturtii, Dasineura brassicae, Delia brassicae, Dicestra trifoli, Entomoscelis americana, Lygus spp., Mamestra configurata, Meligethes aeneus, Meligethes viridescens, Myzus persicae, Phyllotreta cruciferae, Phyllotreta memorum, Phyllotreta undulata, Phyllotreta diademata, Phyllotreta spp, Phyllotreta striolata, Phytomyza rufipes, Pieris sp., Plutella xylostella, Psylliodes chrysocephala, Psylliodes punctulata, and Vanessa cardui;
(5) the plant is cotton, the invertebrate pests are selected from Adelphocoris lineolatus, Adelphocoris suturalis, Agrotis ipsilon, Agrotis segetum, Alabama argilacea, Alcidodes affaber, Amrasca biguttula, Anomis flava, Anthonomus grandis, Aphis gossypii, Apolygus lucorum, Atactogaster finitimus; Autographa californica, Blapstinus spp., Bucculatrix loxoptera, Bucculatrix thurberiella, Caliothrips fasciatus, Chlorochroa sayi, Chrysodeixis includens, Compylomma livida Creontiades spp., Delia platura, Dysdercus koenigii, Dysdercus spp., Earias insulana, Elasmopalpus lignosellus, Empoasca fabae, Empoasca solana, Estigmene acrea, Euschistus conspersus, Euschistus impictiventris, Euschistus servus, Feltia subterranean, Franklinkiella fusca, Franklinkiella occidentalis, Gryllus spp., Helicoverpa armigera, Helicoverpa zea, Heliothis virescens, Hoplolaimus columbus, Limonius spp., Liriomyza spp., Lygus hesperus, Lygus lineolaris, Melanoplus differentialis, Melanoplus femurrubrum, Meloidogyne spp., Microtermes obesi, Nysius raphanus, Odontotermes obesus, Onycarenus laetus, Pectinophora gossypiella, Pempherulus affinis, Peridroma saucia, Phenacoccus solenopsis, Platynota stultana, Pseudatomoscelis seriatus, Rotylenchulus reniformis, Scirtothrips dorsalis; Spilosoma obliqua, Spodoptera exigua, Spodoptera frugiperda, Spodoptera litura, Spodoptera praefica, Sylepta derogata, Tarache otabilis, Tetranychus cinnabarinus, Tetranychus turkestani, Tetranychus pacificus, Tetranychus urticae, Thrips tabaci, Trachea notabilis, Trialeurodes abutilonea, Trichoplusia ni, and Udea profundalis;
(6) the plant is soybean, the invertebrate pests are selected from Acrosternum hilare, Agrotis ipsilon, Anticarsia gemmatalis, Aphis glycines, Aristotelia reseosuffusella, Calomycterus setarius, Cerotoma trifurcate, Colaspis brunnea, Chrysodeixis includens, Chrysodeixis eriosoma Colaspis crinnicornis, Colaspis flavida, Colias eurytheme, Cyclocephala lurida, Dichelops melacanthus, Dichelops furcatus Dectes texanus texanus, Diabratica balteata, Diabratica undecimpunctata howardi, Diabratica undecimpunctata, Elasmopalpus lignosellus, Empoasca fabae, Epargyreus clarus, Epicauta funebris, Epicauta pennsylvanica, Epicauta vittata, Epilachna varivestis, Estigmene acrea, Euschistus heros, Euschistus servus, Halticus bractatus, Halyomorpha halys, Helicoverpa zea, Heliothis virescens, Helocoverpa zea, Heterodera glycines, Heterodera spp., Hylemya platura, Hypena scabra, Melanoplus differentialis, Melanoplus femurrubrum, Myzus persicae, Naupactus (=Graphognathus) spp, Odontota horni, Ostrinia nubilalis, Papaipema nebris, Peridroma saucia, Phyllophaga rugosa, Piezodorus guildinii, Plathypena scabra, Podisus maculoventris, Popillia japonica, Pseudoplusia includens, Rivellia quadrifasciata, Sericothrips variabilis, Spilosoma virginica, Spissistilus festinus, Spodoptera exigua, Spodoptera frugiperda, Spodoptera ornithogalli, Spodoptera ornithogalli, Spp of Alydidae, Strigoderma arboricola, Tetranychus turkestani, Tetranychus urticae, Thrips tabaci, Thyanta custator, Trialeurodes abutilonea, Vanessa cardui, ORT: Gryllidae, ORT: Acrididae, or ORT: Gryllotalpidae;
(7) the plant is peanut, the invertebrate pests are selected from Agrotis munda, Agrotis ipsilon, Anticarsia gemmatalis, Austroasca alfalfa, Austroasca viridigrisea, Aphis craccivora, Aproaerema modicella, Bemisia tabaci, Chrysodeixis includens, Conoderus scissus, Creontiades spp., Diabrotica undecimpunctata, Elasmopalpus lignosellus, Empoasca spp, Empoasca fabae, Etiella behrii, Feltia subterranean, Frankliniella occidentalis, Frankliniella bispinosa, Frankliniella fusca, Helicoverpa armigera, Helicoverpa punctigera, Heteronyx piceus, Holotrichia consanguinea, Lepidiota spp, Leucania stenographia, Liriomyza sp., Mythimna spp., Meloidogyne arenaria, Meloidogyne spp., Naupactus leucoloma, Pangaeus bilineatus (Say), Paraplonobia spp, Spissistilus festinus, Spodoptera exigua, Spodoptera frugiperda, Spodoptera litura, Spodoptera ornithogalli, Tetranychus urticae, COL: Tenebrionidae, COL: Elateridae, COL: Scarabeidae, ORT: Gryllotalpidae, or HET: Myridae;
(8) the plant is potato, the invertebrate pests are selected from COL: Elateridae, Amrasca biguttula biguttula, Acizzia solanicola, Agriotes lineatus, Agriotes obscurus, Agrotis ipsilon, Amphimallon solstitialis, Amrasca devastans, Aphis fabae, Aphis frangulae, Aphis gossypii, Aphis nasturtii, Aphis spiraecola, Aulacorthum circumflexum, Aulacorthum solani, Autographa californica, Bactericera nigricornis, Bactericera cockerelli, Bemisia argentifolii, Circulifer tennelus, Diabrotica speciosa, Empoasca devastans, Empoasca fabae, Epitrix spp., Heliothis zea, Henosepilachna vigintioctomaculata, Heterodera spp., Holotrichia oblita, Leptinotarsa decemlineata, Limonius canus, Limonius californicus, Ctenicera pruinina, Liriomyza spp, Macrosiphum euphorbiae, Macrosteles fascifrons, Meloidogyne hapla, Meloidogyne chitwoodi, M. incognita, Monomorium pharaonic, Myzus ascalonicus, Myzus ornatus, Myzus persicae, Pemphigus sp., Peridroma saucia, Phthorimaea operculella, Phthorimaea spp, Pratylenchus penetrans, P. neglectus, Paratrichodorus sp., Pseudoplusia includens, Rhopalosiphoninus latysiphon, Rhopalosiphum rufiabdominalis, Russelliana solanicola Tuthill, Smynthurodes betae, Spodoptera eridania, Spodoptera frugiperda, Spodoptera litura, and Trialeurodes vaporariorum;
(9) the plant is sugarbeet, the invertebrate pests are selected from Achyra rantalis, Agriotes spp., Limonius spp., Agrotis ipsilon, Agrotis ipsilon, Agrotis orthogonia, Agrotis segetum, Agrotis subterranean, Aphis craccivora, Aphis fabae, Aphis gossypii, Atomaria linearis, Autographa gamma, Bemisia argentifolii, Bemisia tabaci, Blaniulus guttulatus, Cassida nebulosa L., Cassida nobilis (L.) (Col., Chrysomelidae), Chaetocnema tibialis, Circulifer tenellus, Delia platura, Disonycha triangularis, Empoasca fabae, Empoasca Solana, Epitrix cucumeris, Epitrix tuberis, Estigmene acrea, Euxoa auxiliaris, Euxoa nigricans, Heterodera schachtii, Liriomyza spp., Loxostege cereralis, Loxostege sticticalis, Macrosiphum euphorbiae, Mamestra oleracea, Melanoplus spp., Meloidogyne incognita, M. javanica, M. arenaria M. hapla, and M. chitwoodi, Myzus persicae, Onychiurus spp, Pegomyia betae, Pemphigus populivenae (betae), Peridroma saucia, Piesma quadratum, Spodoptera exigua, Spodoptera praefica, Systena blanda, Tetranychus cinnabarinus, and Tetranychus urticae.

16. The method according to claim 10, wherein the seeds are protected from storage pests selected from COL: Bruchidae, COL: Dermestidae, Acanthoscelides obtectus, Acarus siro, Bruchidius atrolineatus, Bruchus atomarius, Bruchus dentipes, Bruchus lentis Frol, Bruchus pisorum, Bruchus rufipes, Callosobruchus chinensis, Callosobruchus maculatus (Fabricius), Callosobruchus subinnotatus, Callosobruchus theobromae, Cryptolestes ferrugineus, Ephestia elutella, Ephestia kuehniella, Oryzaephilus Mercator, Oryzaephilus surinamensis, Palorus depressus, Phthorimaea operculella, Plodia interpunctella, Prostephanus truncatus (Horn), Rhizopertha dominica, Sitophilus granarius (L.), Sitophilus oryzae (L.) (=Calandra oryzae L.), Sitophilus spp., Sitophilus zeamais Motsch. (=Calandra zeamais Motsch.), Sitotroga cerealella, Tribolium destructor, Tribolium madens, Tenebrio molitor L, and Tribolium confusum.

17. Seed, comprising the compound of formula I as defined in claim 8 in an amount of from 0.1 g to 10 kg per 100 kg of the seed.

18. The seed according to claim 17, wherein the seed is of a genetically modified plant.
